(19) United States
(12) Patent Application Publication
(10) Pub. No.: US 2006/0253905 A1
(43) Pub. Date: Nov. 9, 2006

(54) System and method for surveilling a computer network

(75) Inventor: Rick Mansel, Sugar Land, TX (US)

Correspondence Address: KNOBBE MARTENS OLSON & BEAR LLP, 2040 MAIN STREET, FOURTEENTH FLOOR, IRVINE, CA, 92614, US

(73) Assignee: FutureSoft, Inc., Houston, TX (US)

(21) Appl. No.: 10/535,929

(22) PCT Filed: Jul. 14, 2004
(86) PCT No.: PCT/US04/22647

§ 371 Date: Apr. 27, 2006

Related U.S. Application Data
(60) Provisional application No. 60/487,085, filed on Jul. 14, 2003.

(51) Int. Cl. G06F 12/14

(52) U.S. Cl. 726/23

(57) ABSTRACT

A system for surveilling a computer network comprises a surveillance management system coupled to one or more monitored systems.

### CROSS REFERENCE TO RELATED APPLICATIONS

The present application is the National Stage patent application for PCT patent application Ser. No. PCT/US2004/022647, attorney docket number 25343.18.02, filed on Jul. 14, 2004, which claims the benefit of the filing date of U.S. provisional patent application Ser. No. 60/487,085, attorney docket number 25343.18, filed on Jul. 14, 2003, the disclosures of which are incorporated herein by reference.

### BACKGROUND

The disclosures herein relate generally to computer networks and more particularly to a system and method for surveilling a computer network.

Electronic files and registries stored on unsurveilled or inadequately surveilled computer systems and servers in a computer network can subject an organization to a number of risks, including intellectual property theft, hostile workplace claims, and copyright infringement.

Accordingly, it would be desirable to provide a surveillance system for a computer network absent the disadvantages found in the prior methods discussed above.

### SUMMARY

According to one aspect of the present invention, a computer implemented surveillance system is provided that comprises one or more monitored systems operably coupled to a network, and a surveillance management system operably coupled to the network, the surveillance management system operable to identify and manage files on the one or more monitored systems and to control the access to files on the one or more monitored systems.

According to another aspect of the present invention, a computer implemented surveillance management system is provided that comprises a surveillance engine, the surveillance engine adapted to identify and manage files and control access to files, a user interface operably coupled to the surveillance engine to allow configuration of the surveillance engine, a network interface operably coupled to the surveillance engine to allow the surveillance engine to access a network, and one or more databases operably coupled to the surveillance engine.

According to another aspect of the present invention, a computer implemented monitored system is provided that comprises a real time monitor engine adapted to manage and control access to files, a network interface operably coupled to the real time monitor engine to allow the real time monitor engine to access a network, and one or more databases coupled to the real time monitor engine.

According to another aspect of the present invention, a computer implemented surveillance engine is provided that comprises one or more of the following: a file scan engine, a file type engine, a real time monitor engine, a category engine, a scheduling engine, a report engine, a client management engine, a time interval engine, a rule set engine, and an update engine.

According to another aspect of the present invention, a computer implemented method for file scanning is provided that comprises defining a scan, wherein the defining comprises identifying one or more files to scan for, running the scan, and stopping a scan.

According to another aspect of the present invention, a computer implemented method of real time monitoring is provided that comprises one or more of the following: creating a monitored systems group, adding one or more monitored systems to the monitored systems group, and managing a real time monitor.

According to another aspect of the present invention, a computer implemented method for managing keywords is provided that comprises one or more of the following: defining a keyword, modifying existing keywords, removing existing keywords, assigning a weighting to a keyword, defining a threshold level for a category, using a logic expression with a keyword, and saving a keyword to a database.

According to another aspect of the present invention, a computer implemented method for managing file signatures is provided that comprises one or more of the following: defining a file signature for a file, modifying a file signature, importing one or more file signatures from a scan, removing a file signature, and saving a file signature to a database.

According to another aspect of the present invention, a computer implemented method for client management for a surveillance system is provided that comprises one or more of the following: adding a monitored system, removing a monitored system, retrieving a file version detail, uninstalling software from a monitored system, installing software on a monitored system, upgrading software on a monitored system, monitoring a monitored system, stopping monitoring of a monitored system, and rebooting a monitored system.

According to another aspect of the present invention, a computer implemented method for managing rule sets for a surveillance engine is provided that comprises one or more of the following: adding a rule set, editing a rule set, and removing a rule set.

According to another aspect of the present invention, a method for real time monitoring is provided that comprises initiating a real time monitor session, creating a real time monitor database, monitoring file access to a system, detecting access corresponding to a real time monitor configuration, and performing an action.

According to another aspect of the present invention, a monitored system file scan run time configuration database is provided that comprises a file scan name, one or more files to inspect, one or more file inspection parameters corresponding to a matching file, and one or more actions to perform on the matching file.

### BRIEF DESCRIPTION OF THE DRAWINGS

FIG. 1a is a schematic view illustrating an embodiment of a surveillance system.

FIG. 1b is a schematic view illustrating an embodiment of a surveillance system.

FIG. 1c is a schematic view illustrating an embodiment of a surveillance system.

FIG. 2 is a schematic view illustrating an embodiment of a surveillance management system used with the surveillance systems of FIGS. 1a, 1b, and 1c.

FIG. 3 is a schematic view illustrating an embodiment of a surveillance engine used with the surveillance management system of FIG. 2.

FIG. 4a is a schematic view illustrating an embodiment of a plurality of file scans databases used with the surveillance management system of FIG. 2.

FIG. 4b is a schematic view illustrating an embodiment of a file scans database located in the plurality of file scans databases of FIG. 4a.

FIG. 4c is a schematic view illustrating an embodiment of a file scan configuration located in the file scans database of FIG. 4b.

FIG. 4d is a schematic view illustrating an embodiment of file inspection parameters located in the file scan configuration of FIG. 4c.

FIG. 4e is a schematic view illustrating an embodiment of actions to perform on matching files located in the file scan configuration of FIG. 4c.

FIG. 4f is a schematic view illustrating an embodiment of file scan results located in the file scans database of FIG. 4b.

FIG. 4g is a schematic view illustrating an embodiment of matching file information located in the file scan results of FIG. 4f.

FIG. 4h is a schematic view illustrating an embodiment of matching file information located in the file scan results of FIG. 4f.

FIG. 5a is a schematic view illustrating an embodiment of a scans database used in the surveillance management system of FIG. 2.

FIG. 5b is a schematic view illustrating an embodiment of executed file scan information located in the scans database of FIG. 5a.

FIG. 5c is a schematic view illustrating an embodiment of executed file scan information for file scan database 206a located in the executed file scan information of FIG. 5b.

FIG. 5d is a schematic view illustrating an embodiment of executed real time monitor information located in the scans database of FIG. 5a.

FIG. 5e is a schematic view illustrating an embodiment of executed real time monitor information for monitored system 108a located in the executed real time monitor information of FIG. 5d.

FIG. 6a is a schematic view illustrating an embodiment of a plurality of real time monitor databases used in the surveillance management system of FIG. 2.

FIG. 6b is a schematic view illustrating an embodiment of a real time monitor database located in the plurality of real time monitor databases of FIG. 6a.

FIG. 6c is a schematic view illustrating an embodiment of access type located in the real time monitor database of FIG. 6b.

FIG. 6d is a schematic view illustrating an embodiment of action taken located in the real time monitor database of FIG. 6b.

FIG. 7a is a schematic view illustrating an embodiment of an administrator database used in the surveillance management system of FIG. 2.

FIG. 7b is a schematic view illustrating an embodiment of a client management configuration located in the administrator database of FIG. 7a.

FIG. 7c is a schematic view illustrating an embodiment of a reporting configuration located in the administrator database of FIG. 7a.

FIG. 7d is a schematic view illustrating an embodiment of current file scan configurations located in the administrator database of FIG. 7a.

FIG. 7e is a schematic view illustrating an embodiment of a current file scan configuration located in the plurality of current file scan configurations of FIG. 7d.

FIG. 7f is a schematic view illustrating an embodiment of file inspection parameters located in the current file scan configuration of FIG. 7e.

FIG. 7g is a schematic view illustrating an embodiment of actions to perform on matching files located in the current file scan configuration of FIG. 7e.

FIG. 7h is a schematic view illustrating an embodiment of a plurality of current real time monitor groups located in the administrator database of FIG. 7a.

FIG. 7i is a schematic view illustrating an embodiment of a current real time monitor group located in the plurality of current real time monitor groups of FIG. 7h.

FIG. 7j is a schematic view illustrating an embodiment of a plurality of real time monitor rule sets located in the administrator database of FIG. 7a.

FIG. 7k is a schematic view illustrating an embodiment of a rule set located in the plurality of real time monitor rule sets of FIG. 7j.

FIG. 7l is a schematic view illustrating an embodiment of rule conditions located in the rule set of FIG. 7k.

FIG. 7m is a schematic view illustrating an embodiment of rule actions located in the rule set of FIG. 7k.

FIG. 7n is a schematic view illustrating an embodiment of a scheduling information set located in the administrator database of FIG. 7a.

FIG. 8 is a schematic view illustrating an embodiment of a monitored system used with the surveillance systems of FIGS. 1a, 1b, and 1c.

FIG. 9 is a schematic view illustrating an embodiment of a plurality of monitored system databases used with the monitored system of FIG. 8.

FIG. 10a is a schematic view illustrating an embodiment of a file scan run time configuration database located in the plurality of monitored system databases of FIG. 9.

FIG. 10b is a schematic view illustrating an embodiment of file inspection parameters located in the file scan run time configuration database of FIG. 10a.

FIG. 10c is a schematic view illustrating an embodiment of actions to perform on matching files located in the file scan run time configuration database of FIG. 10a.

FIG. 11a is a schematic view illustrating an embodiment of a real time monitor run time configuration database located in the plurality of monitored system databases of FIG. 9.

FIG. 11b a schematic view illustrating an embodiment of a real time monitor run time configuration located in the real time monitor run time configuration database of FIG. 11a.

FIG. 12a is a schematic view illustrating an embodiment of a file scan log files database located in the plurality of monitored system databases of FIG. 9.

FIG. 12b is a schematic view illustrating an embodiment of matching file level information located in the file scan log files database of FIG. 12a.

FIG. 12c is a schematic view illustrating an embodiment of matching file level information located in the file scan log files database of FIG. 12a.

FIG. 13a is a schematic view illustrating an embodiment of a real time monitor log files database located in the plurality of monitored system databases of FIG. 9.

FIG. 13b is a schematic view illustrating an embodiment of access types located in the real time monitor log files database of FIG. 13a.

FIG. 13c is a schematic view illustrating an embodiment of action taken located in the real time monitor log files database of FIG. 13a.

FIG. 14 is a flow chart illustrating an embodiment of a method of surveilling a computer network using the surveillance engine of FIG. 3.

FIG. 15a is a flow chart illustrating an embodiment of running a file scan engine in the method of surveilling a computer network of FIG. 14.

FIG. 15b is a flow chart illustrating an embodiment of defining a scan in the running a file scan engine of FIG. 15a.

FIG. 15c is a flow chart illustrating an embodiment of creating a new scan in the defining a scan of FIG. 15b.

FIG. 15d is a flow chart illustrating an embodiment of files to scan for in the creating a new scan of FIG. 15c.

FIG. 15e is a flow chart illustrating an embodiment of actions for perform in the creating a new scan of FIG. 15c.

FIG. 15f is a flow chart illustrating an embodiment of viewing scan results in the defining a scan of FIG. 15b.

FIG. 15g is a flow chart illustrating an embodiment of running a scan in the running a file scan engine of FIG. 15a.

FIG. 15h is a flow chart illustrating an embodiment of running a scan in the running a file scan engine of FIG. 15a.

FIG. 15i is a flow chart illustrating an embodiment of running a scan in the running a file scan engine of FIG. 15a.

FIG. 15j is a flow chart illustrating an embodiment of running a scan in the running a file scan engine of FIG. 15a.

FIG. 15k is a flow chart illustrating an embodiment of running a scan in the running a file scan engine of FIG. 15a.

FIG. 16 is a flow chart illustrating an embodiment of running a file type engine in the method of surveilling a computer network of FIG. 14.

FIG. 17a is a flow chart illustrating an embodiment of running a real time monitor engine in the method of surveilling a computer network of FIG. 14.

FIG. 17b is a flow chart illustrating an embodiment of adding monitored systems in the running a real time monitor engine of FIG. 17a.

FIG. 17c is a flow chart illustrating an embodiment of managing real time monitors in the running a real time monitor engine of FIG. 17a.

FIG. 18a is a flow chart illustrating an embodiment of running a category engine in the method of surveilling a computer network of FIG. 14.

FIG. 18b is a flow chart illustrating an embodiment of a keyword tool in the running a category engine of FIG. 18a.

FIG. 18c is a flow chart illustrating an embodiment of file signature tool in the running a category engine of FIG. 18a.

FIG. 19a is a flow chart illustrating an embodiment of running a scheduling engine in the method of surveilling a computer network of FIG. 14.

FIG. 19b is a flow chart illustrating an embodiment of adding a scheduled job in the running a scheduling engine of FIG. 19a.

FIG. 19c is a flow chart illustrating an embodiment of editing a scheduled job in the running a scheduling engine of FIG. 19a.

FIG. 20a is a flow chart illustrating an embodiment of running a report engine in the method of surveilling a computer network of FIG. 14.

FIG. 20b is a flow chart illustrating an embodiment of file scan reports in the running a report engine of FIG. 20a.

FIG. 20c is a flow chart illustrating an embodiment of set report parameters in the select reports of the file scan reports of FIG. 20b.

FIG. 20d is a flow chart illustrating an embodiment of set report parameters in add new report of the file scan reports of FIG. 20b.

FIG. 20e is a flow chart illustrating an embodiment of real time monitor reports in the running a report engine of FIG. 20a.

FIG. 20f is a flow chart illustrating an embodiment of select reports in the real time monitor reports of FIG. 20e.

FIG. 20g is a flow chart illustrating an embodiment of set report parameters in the select reports of FIG. 20f.

FIG. 20h is a flow chart illustrating an embodiment of set report parameters in the select reports of FIG. 20f.

FIG. 20i is a flow chart illustrating an embodiment of add new reports in the real time monitor reports of FIG. 20c.

FIG. 20j is a flow chart illustrating an embodiment of select report parameters in the add new reports of FIG. 20i.

FIG. 20k is a flow chart illustrating an embodiment of set report parameters in the add new reports of FIG. 20i.

FIG. 21 is a flow chart illustrating an embodiment of running a client management engine in the method of surveilling a computer network of FIG. 14.

FIG. 22 is a flow chart illustrating an embodiment of running a time interval engine in the method of surveilling a computer network of FIG. 14.

FIG. 23a is a flow chart illustrating an embodiment of running a rule set engine in the method of surveilling a computer network of FIG. 14.

FIG. 23b is a flow chart illustrating an embodiment of adding a rule in the running a rule set engine of FIG. 23a.

FIG. 23c is a flow chart illustrating an embodiment of set media type in the adding a rule of FIG. 23a.

FIG. 23d is a flow chart illustrating an embodiment of editing a rule in the running a rule set engine of FIG. 23a.

FIG. 24 is a flow chart illustrating an embodiment of running an update engine in the method of surveilling a computer network of FIG. 14.

FIG. 25a is a flow chart illustrating an embodiment of running a real time monitor session using the real time monitor engine of FIG. 8.

FIG. 25b is a flow chart illustrating an embodiment of running a real time monitor session using the real time monitor engine of FIG. 8.

FIG. 25c is a flow chart illustrating an embodiment of running a real time monitor session using the real time monitor engine of FIG. 8.

### DETAILED DESCRIPTION

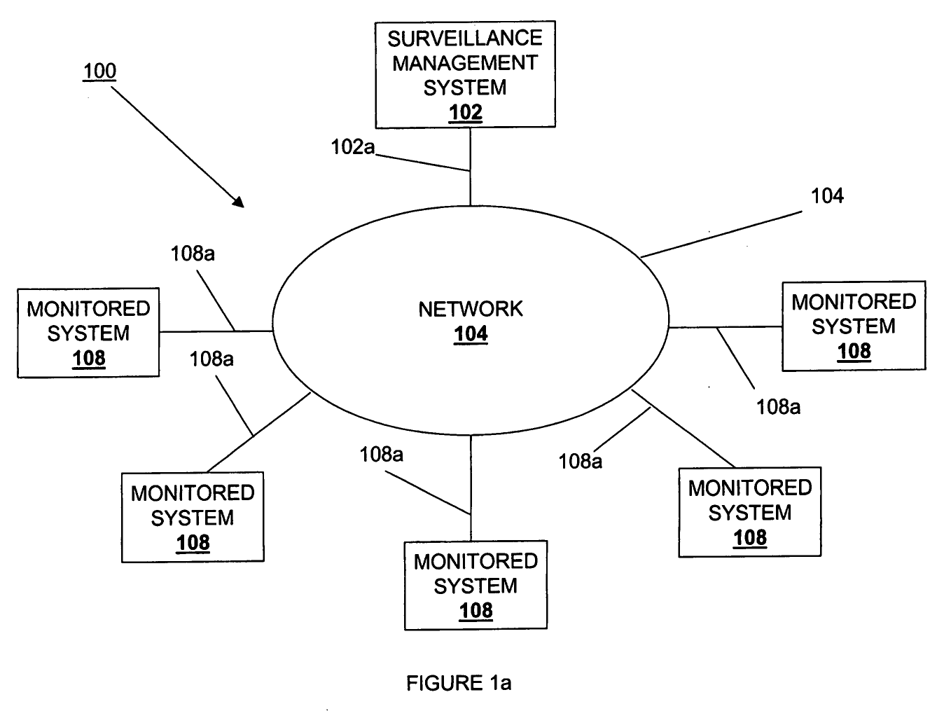

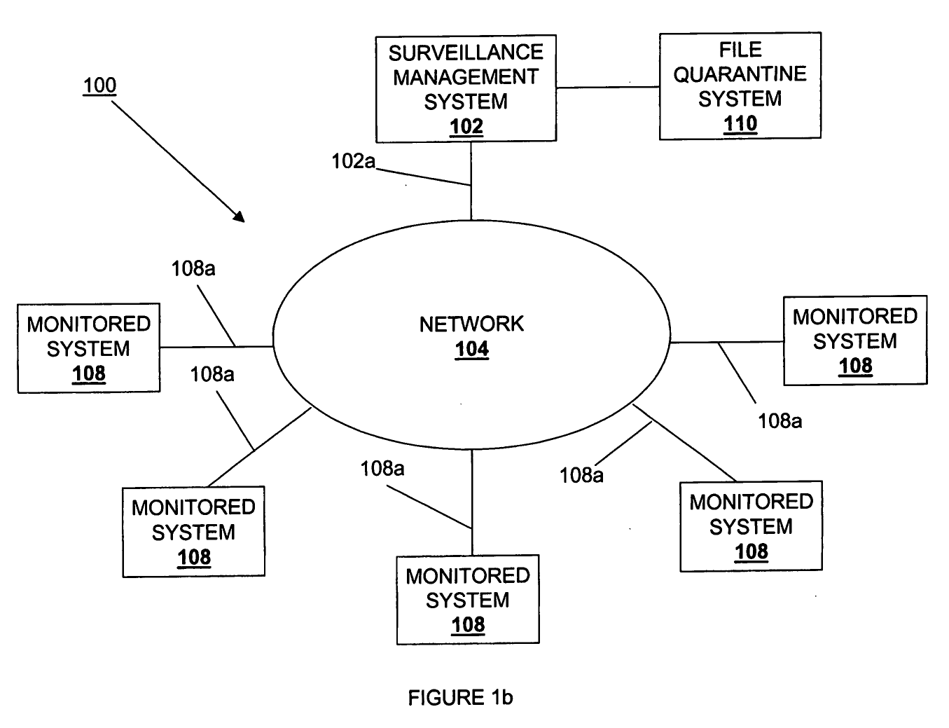

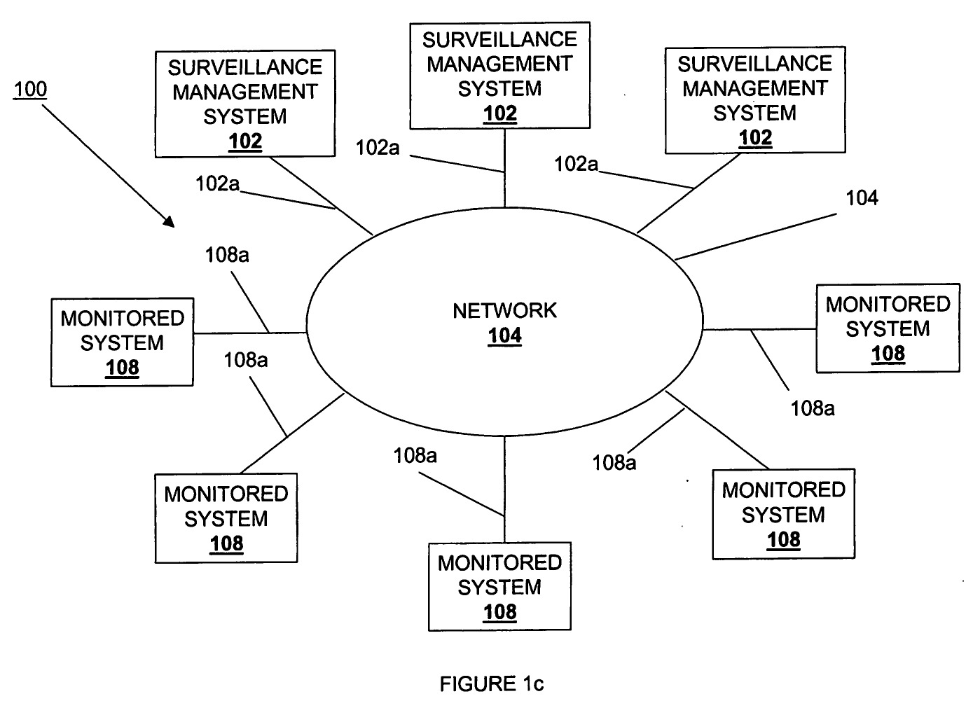

Referring to FIGS. 1a, 1b, and 1c of the drawings, an exemplary embodiment of a surveillance system 100 for surveilling a computer network includes a surveillance management system 102 that is operably coupled to a network 104 by a communications link 102a. A plurality of monitored systems 108 are operably coupled to the network 104 by respective communications links 108a. The communications links 102a and 108a may be, for example, any conventional communications links. The surveillance management system 102 and the plurality of monitored systems 108 may include, for example, programmable general purpose computers. In several alternative embodiments, a local area network, a wide area network, and/or a wireless network may be substituted for, or used in combination with, the network 104. In an exemplary embodiment, as illustrated in FIG. 1b, a file quarantine system 110 is coupled to the surveillance management system 102 and operable to store, segregate, and secure files moved from other systems, such as the plurality of systems 108, such that the files cannot infect other areas of the system 100. In an exemplary embodiment, as illustrated in FIG. 1c, a plurality of surveillance management systems 102 are coupled to the network 104 by a plurality of communications links 102a.

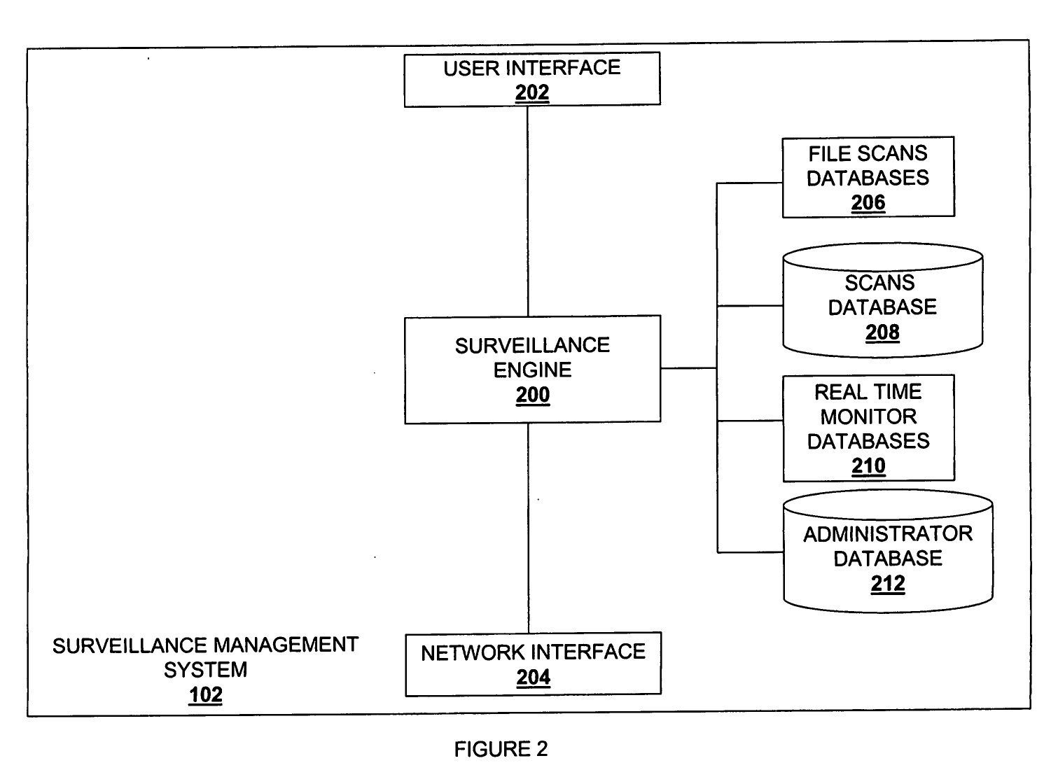

Referring now to FIG. 2, an exemplary embodiment of the surveillance management system 102 includes a surveillance engine 200 which is operably coupled to a user interface 202 and a network interface 204. In several exemplary embodiments, the surveillance engine 200 is adapted to identify and manage files on the plurality of monitored systems 108 and to control access to files on the plurality of monitored systems 108. The user interface 202 may be any conventional user interface and is used to configure and run the surveillance engine 200. The network interface 204 may be any conventional network interface and allows the surveillance engine to access the plurality of monitored systems 108 connected to the network 104, as illustrated in FIGS. 1a, 1b, and 1c. A plurality of databases are coupled to the surveillance engine 200, including a plurality of file scans databases 206, a scans database 208, a plurality of real time monitor databases 210, and an administrator database 212. In several exemplary embodiments, the plurality of file scans databases 206 contain data from file scans that have run on the system 100. In several exemplary embodiments, the scans database 208 collects configuration data for all file scan and real time monitor configurations. In several exemplary embodiments, the plurality of real time monitor databases 210 collect real time monitor session data from real time monitor sessions run on the plurality of monitored systems 108. In several exemplary embodiments, the administrator database 212 holds current configuration data for all file scan and real time monitor configurations.

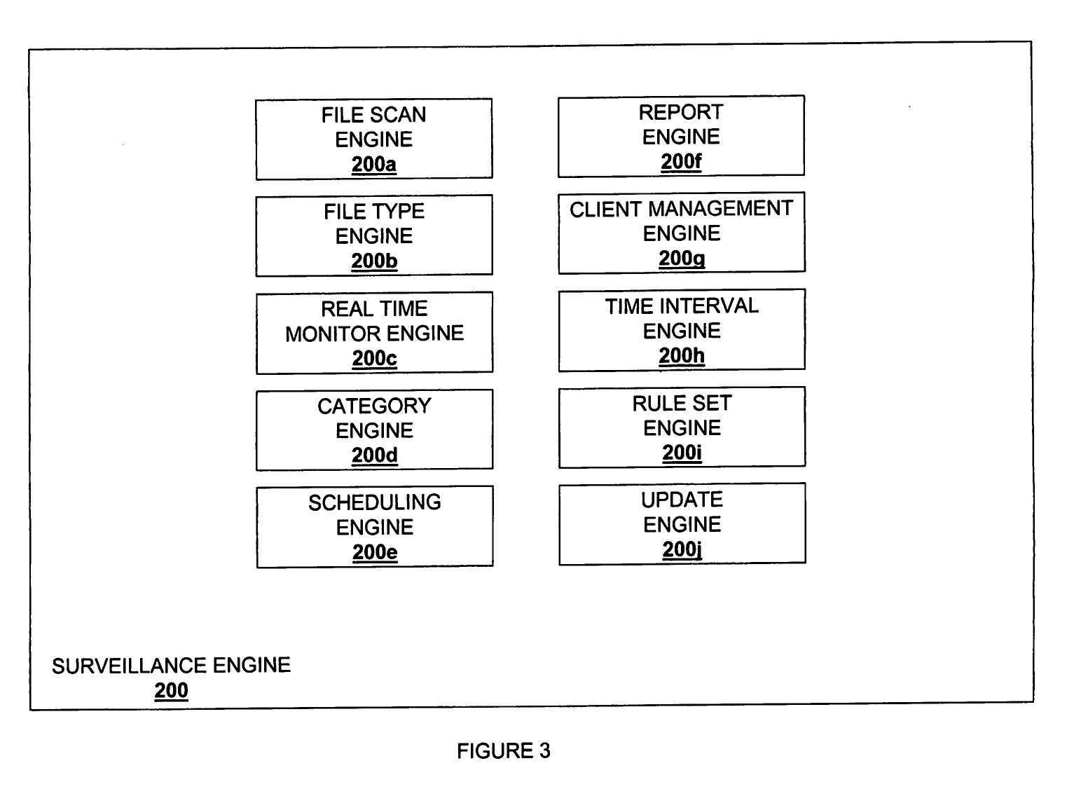

Referring now to FIG. 3, an exemplary embodiment of the surveillance engine 200 includes a file scan engine 200a, a file type engine 200b, a real time monitor engine 200c, a category engine 200d, a scheduling engine 200e, a report engine 200f, a client management engine 200g, a time interval engine 200h, a rule set engine 200i, and an update engine 200j. In several exemplary embodiments, the file scan engine 200a is adapted to create file scan configurations and run file scans across the system 100 in order to identify, manage, and control access to files on the system 100. In several exemplary embodiments, the file type engine 200b is adapted to manage a plurality of file type groups, which may include file type extensions with associated file formats, internal file structures, and a variety of other file identifiers known in the art, for use by the file scan engine 200b in searching the system 100 for particular files. In several exemplary embodiments, the real time monitor engine 200c is adapted to install, configure, and run real time monitors on the monitored systems 108, and create groups of monitored systems 108 to monitor for particular types of access. In several exemplary embodiments, the category engine 200d is adapted to create and manage keywords and file signatures used by the file scan engine 200a either alone or in combination in order to search for files on the system 100. In several exemplary embodiments, the scheduling engine 200e is adapted to automate any combination of the file scan engine 200a, file type engine 200b, real time monitor engine 200c, category engine 200d, report engine 200f, client management engine 200g, time interval engine 200h, rule set engine 200i, and update engine 200j in order to allow updating, operation, and management of the surveillance system 100. In several exemplary embodiments, the report engine 200f is adapted to compile and produce reports related to activities on the system 100 including file access and movement, user access on monitored systems, and files entering and exiting the system. In several exemplary embodiments, the client management engine 200g is adapted to manage monitored systems 108 on the system 100 and monitor their service status which may include running, stopped, installed, and uninstalled. In several exemplary embodiments, the time interval engine 200h is adapted to manage the time intervals used by the rule set engine 200i in order to determine which rules will be operable at which times for real time monitoring sessions. In several exemplary embodiments, the rule set engine 200i is adapted to configure and manage groups of one or more rules used during real time monitor sessions to define the available access on the monitored systems 108. In several exemplary embodiments, the update engine 200j is adapted to update the system 100 with current configurations, either manually or with the help of the scheduling engine 200e. In several exemplary embodiments, engines such as the surveillance engine 200, file scan engine 200a, file type engine 200b, real time monitor engine 200c, category engine 200d, scheduling engine 200e, report engine 200f, client management engine 200g, time interval engine 200h, rule set engine 200i, and update engine 200j may be implemented using hardware, software, firmware, or a variety of equivalent implementing devices known in the art, and distributed throughout the system 100.

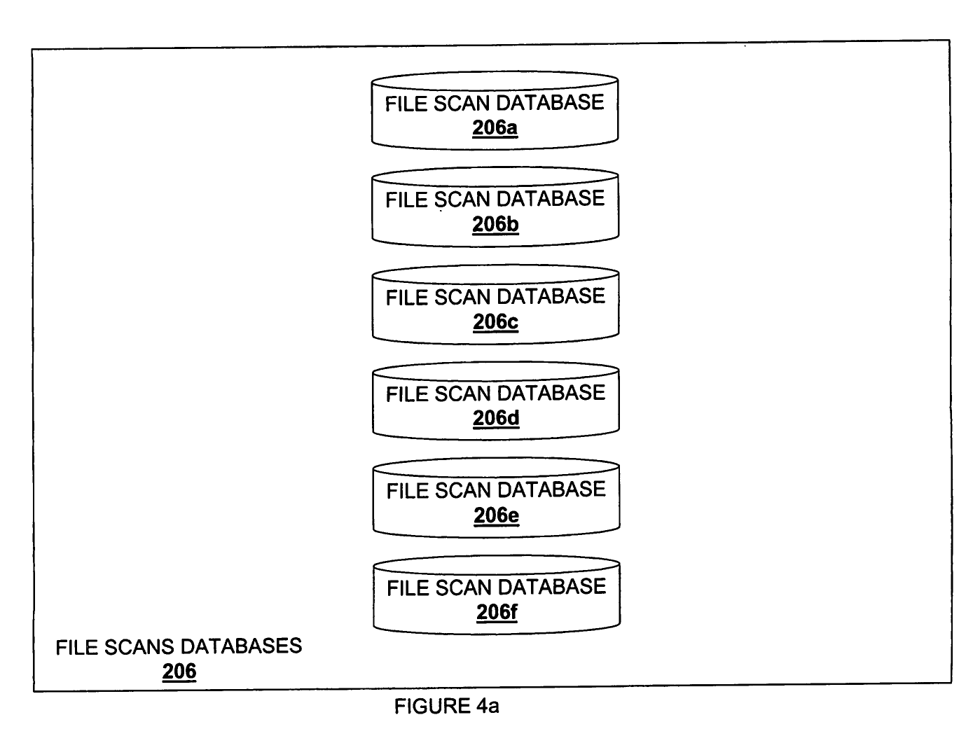

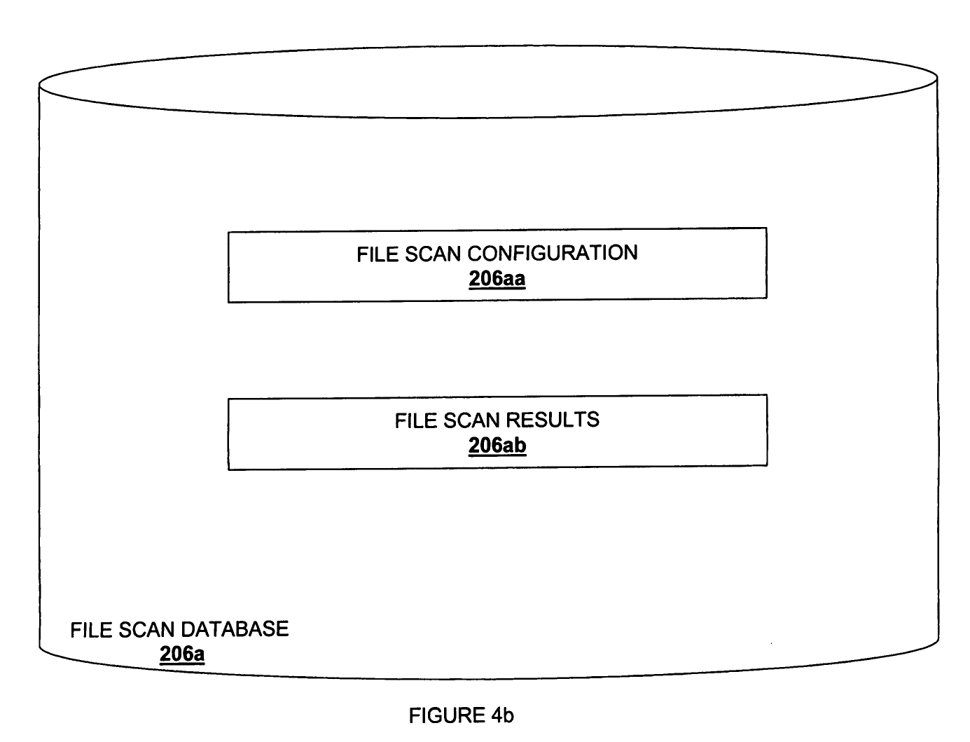

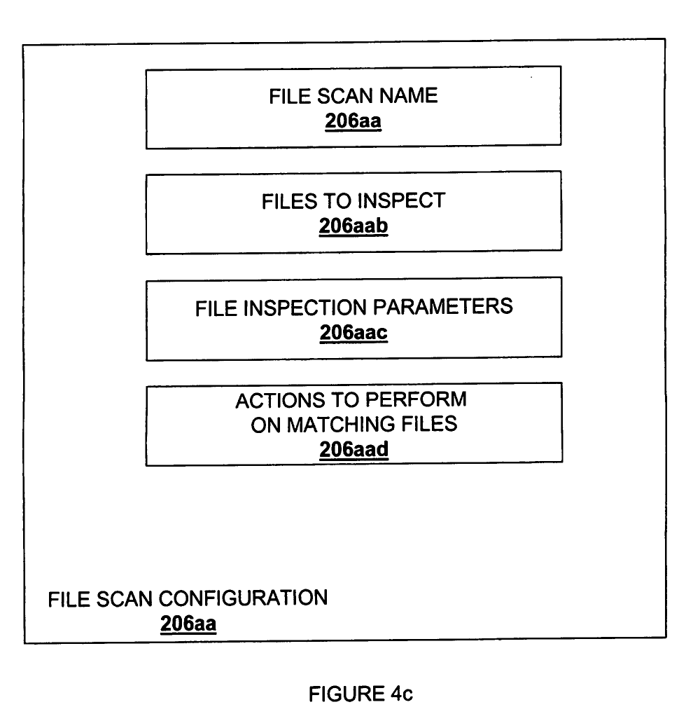

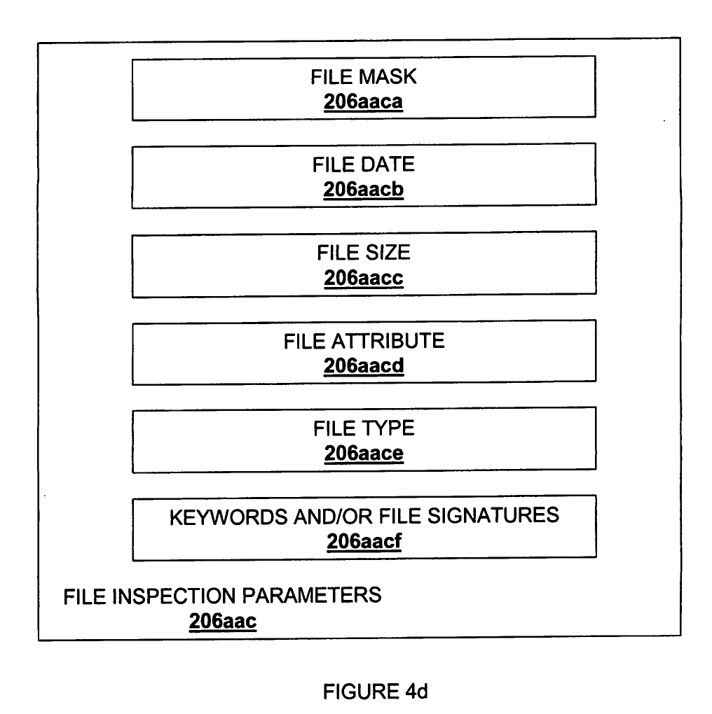

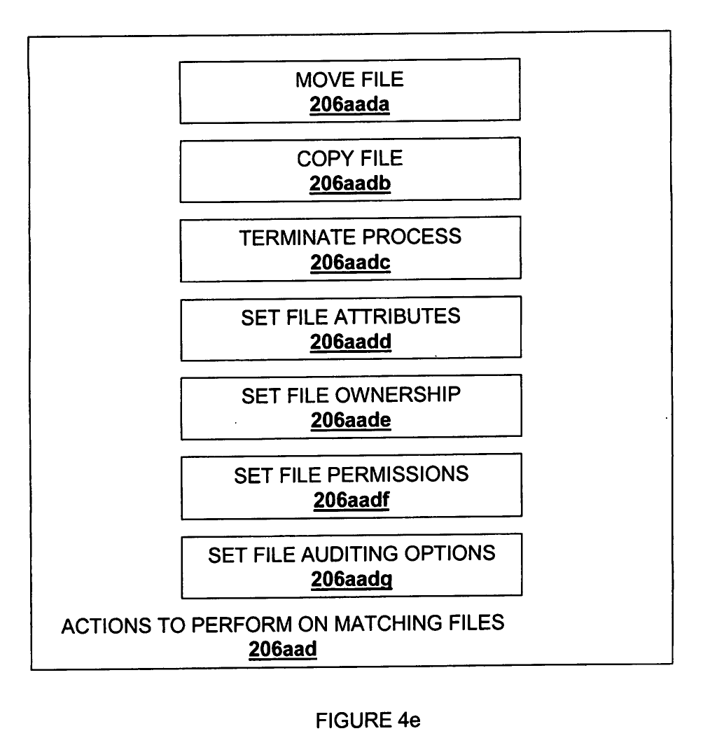

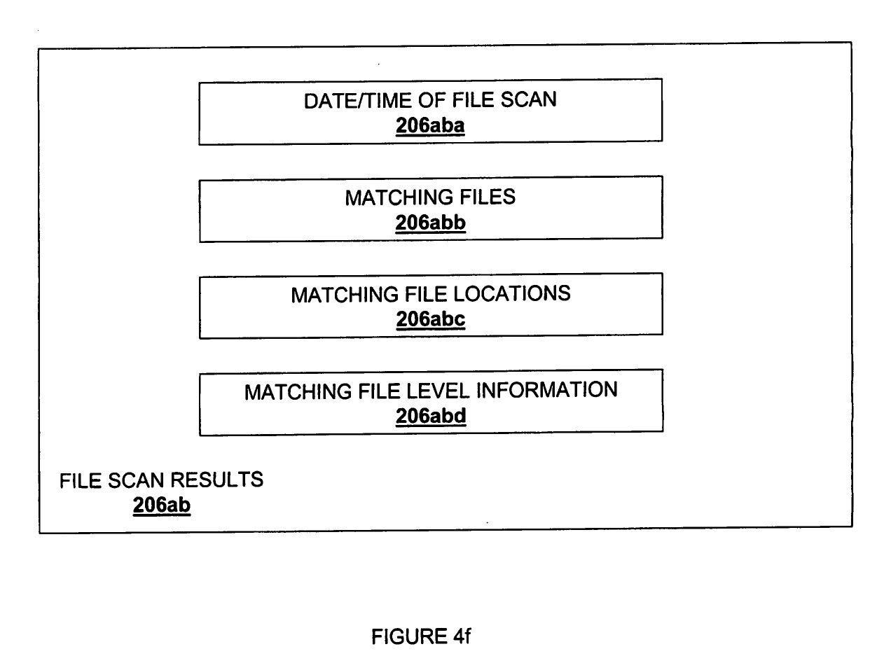

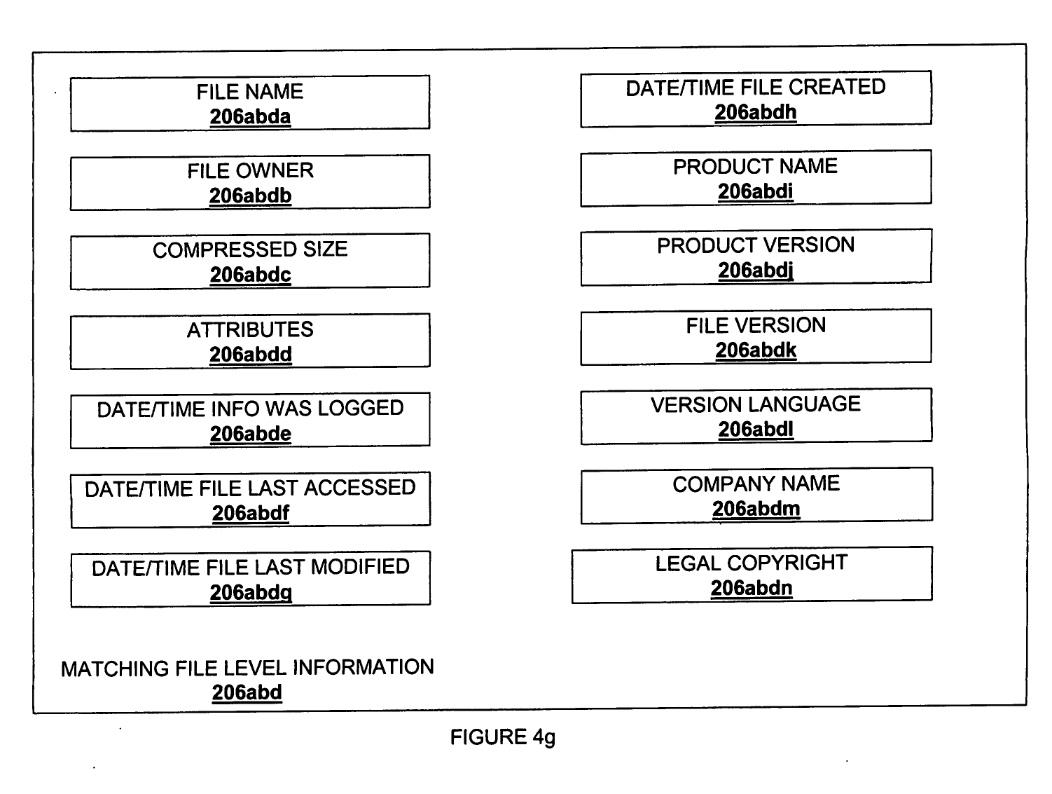

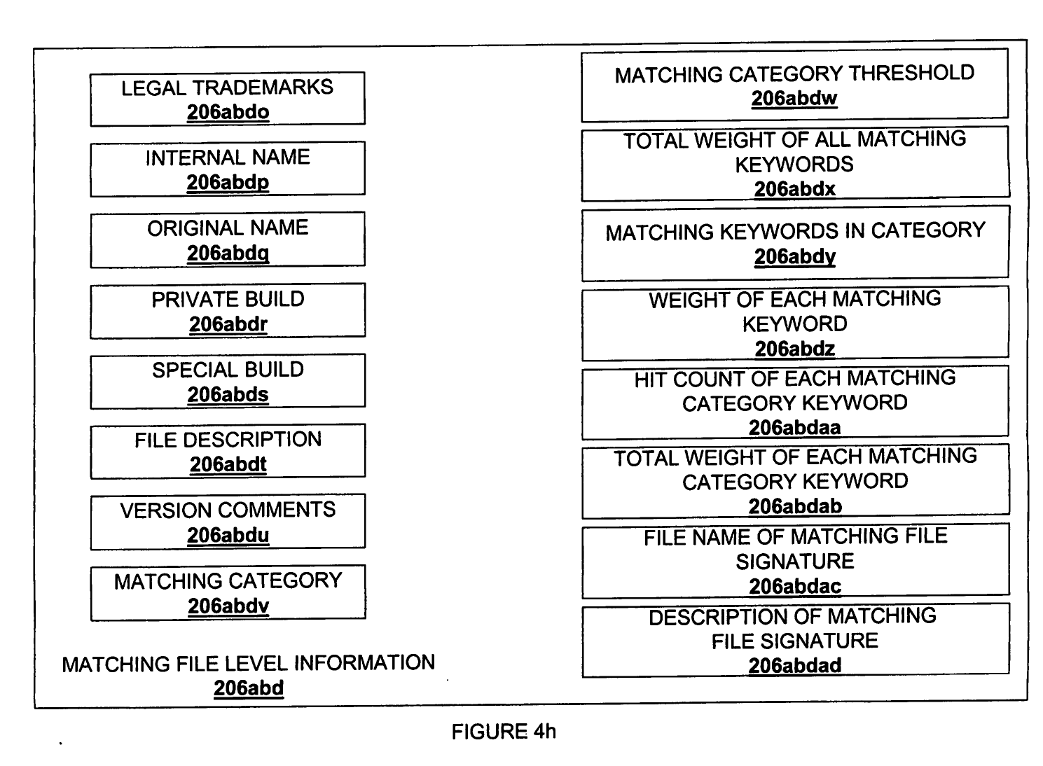

Referring now to FIGS. 4a, 4b, 4c, 4d, 4e, 4f, 4g, and 4h, an exemplary embodiment of the plurality of file scans databases 206 includes a file scan database 206a, 206b, 206c, 206d, 206e, and 206f. In several exemplary embodiments, file scans databases 206a, 206b, 206c, 206d, 206e, and 206f are substantially similar and each hold data related to a particular file scan that includes the parameters defining the files to search for and the results of a search using those parameters. In an exemplary embodiment, as illustrated in FIG. 4b, the file scan database 206a includes a file scan configuration 206aa and a file scan results 206ab.

In an exemplary embodiment, as illustrated in FIG. 4c, the file scan configuration 206aa includes a file scan name 206aaa, one or more files to inspect 206aab, one or more file inspection parameters 206aac, and one or more actions to perform on matching files 206aad. In an exemplary embodiment, as illustrated in FIG. 4d, one or more file inspection parameters 206aac includes a file mask 206aaca, a file date 206aacb, a file size 206aacc, a file attribute 206aacd, a file type 206aace, and a keyword and/or file signature 206aacf. In several exemplary embodiments, the file mask 206aaca is all or part of a file name or folder name used in a particular file scan. In several exemplary embodiments, the file attribute 206aacd is a system property of a file used in a particular file scan including archive, read-only, hidden, system, temporary, compressed, encrypted, and off-line. In several exemplary embodiments, the file type 206aace is a file extension and/or known file format used in a particular file scan. In several exemplary embodiments, a keyword is a word or phrase used in a particular file scan to search for files. In several exemplary embodiments, a file signature is a digital signature that was created for any file, such as a file that contains sensitive or proprietary data, and used in a particular file scan. In an exemplary embodiment, as illustrated in FIG. 4e, one or more actions to perform on matching files 206aad includes a move file action 206aada, a copy file action 206aadb, a terminate process action 206aadc, a set file attribute action 206aadd, a set file ownership action 206aade, a set file permissions action 206aadf, and a set file auditing options action 206aadg. In several exemplary embodiments, the set file attribute action 206aadd is the setting of archive, read-only, hidden, or system on a file in a particular file scan. In several exemplary embodiments, the set file ownership action 206aade is the setting of a user owner or a group owner on a file in a particular file scan. In several exemplary embodiments, the set file permissions action 206aadf is the setting of which users and groups can execute, read data, read attributes, read extended attributes, write data, append data, write attributes, write extended attributes, delete, read permissions, change permissions, or take ownership on the file performed on a file in a particular file scan. In several exemplary embodiments, the set file auditing options action 206aadg is a recording of whether the set file permission action 206aadf succeeded or failed for a particular file scan.

In an exemplary embodiment, as illustrated in FIG. 4f, the file scan results 206ab includes a date/time of file scan 206aba, one or more matching files 206abb from the particular scan, a matching file location 206abc for each corresponding matching file 206abb, and a matching file level information 206abd. In an exemplary embodiment, as illustrated in FIGS. 4g and 4h, the matching file level information 206abd includes a file name 206abda, a file owner 206abdb, a compressed size 206abdc, an attribute 206abdd, a date/time information was logged 206abde, a date/time a file was last accessed 206abdf, a date/time a file was last modified 206abdg, a date/time a file was created 206abdh, a product name 206abdi, a product version 206abdj, a file version 206abdk, a version language 206abdl, a company name 206abdm, a legal copyright 206abdn, a legal trademark 206abdo, an internal name 206abdp, an original name 206abdq, a private build 206abdr, a special build 206abds, a file description 206abdt, one or more version comments 206abdu, a matching category 206abdv, a matching category threshold 206abdw, a total weight of all matching keywords 206abdx, a matching keywords in category 206abdy, a weight of each matching category keyword 206abdz, a hit count of each matching category keyword 206abdaa, a total weight of each matching category keyword 206abdab, a file name of matching file signature 206abdac, and a description of matching file signature 206abdad. In several exemplary embodiments, the attribute 206abdd is a system property of a file including archive, read-only, hidden, system, temporary, compressed, encrypted, and off-line. In several exemplary embodiments, the private build 206abdr is a private version numbering of a file for developer use. In several exemplary embodiments, the special build 206abds is a special version numbering of a file for developer use. In several exemplary embodiments, the matching category 206abdv is a category that a file matched. In several exemplary embodiments, the matching category threshold 206abdw is a criteria value which keywords weights must equal or exceed to trigger a match. In several exemplary embodiments, the total weight of all matching keywords 206abdx is a total of the user defined weights assigned to the keywords that triggered a match for a particular file. In several exemplary embodiments, the matching keywords in category 206abdy is one or more keywords that triggered a match. In several exemplary embodiments, the weight of each matching category keyword 206abdz is a value assigned to the keyword that was run in the file scan. In several exemplary embodiments, the hit count of each matching category keyword 206abdaa is the number of times each keywords appeared in the matching file. In several exemplary embodiments, the total weight of each matching category keyword 206abdab is a product of the hit count of each matching category keyword 206abdaa times the weight of each corresponding matching category keyword 206abdz.

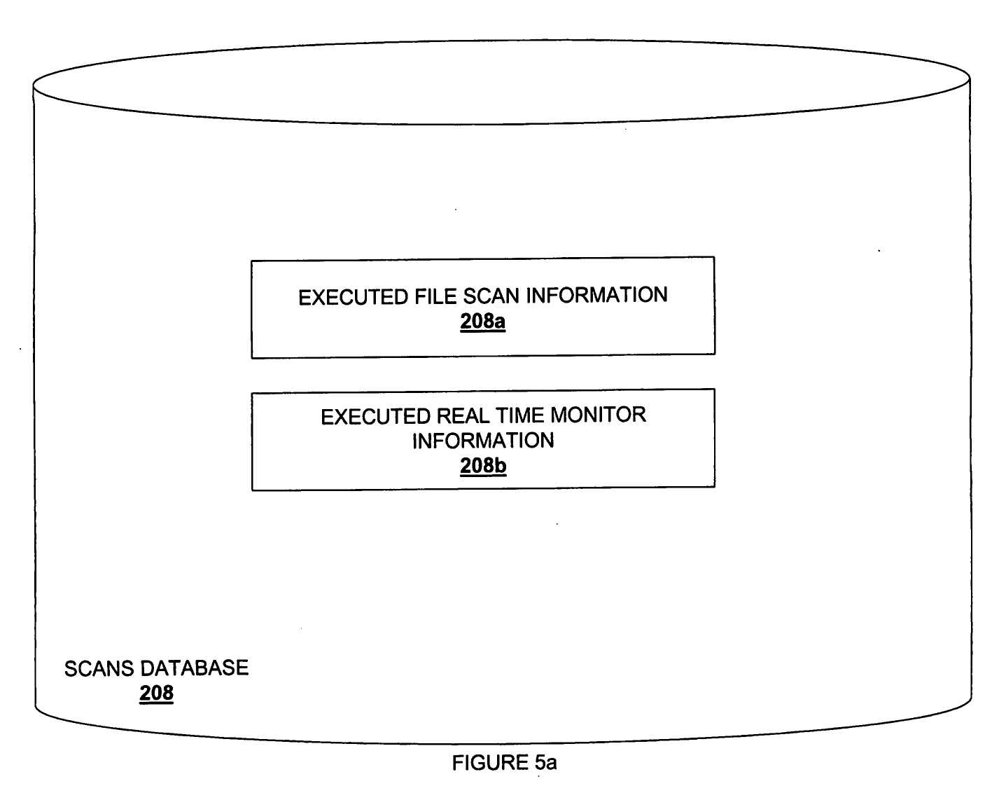

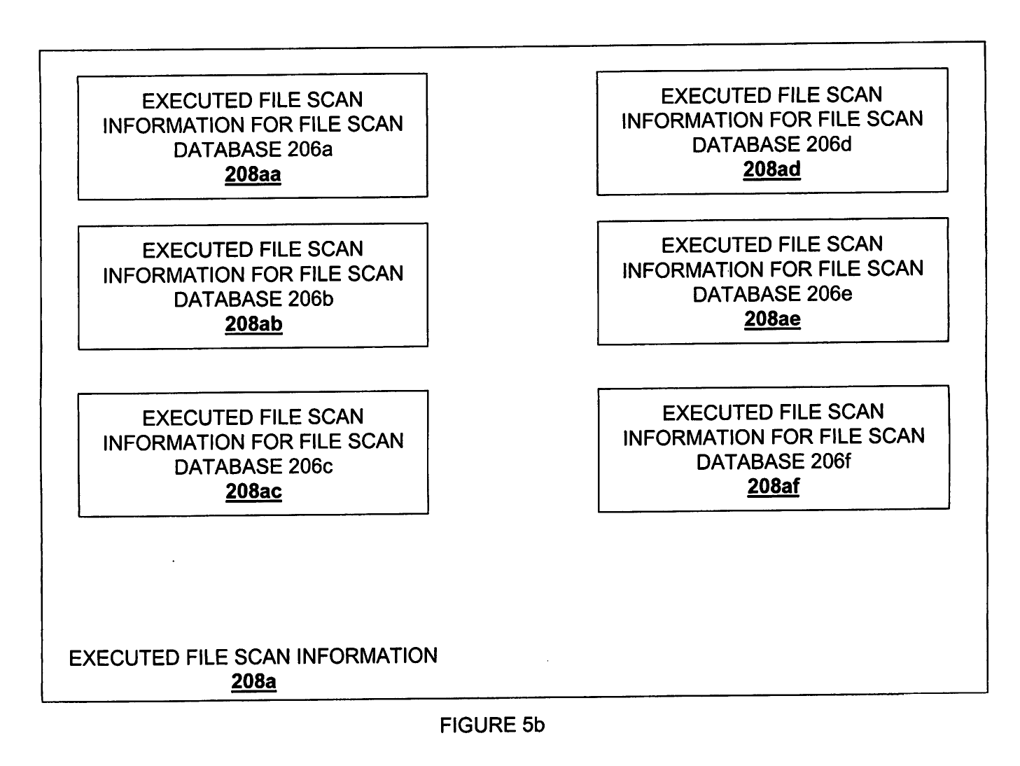

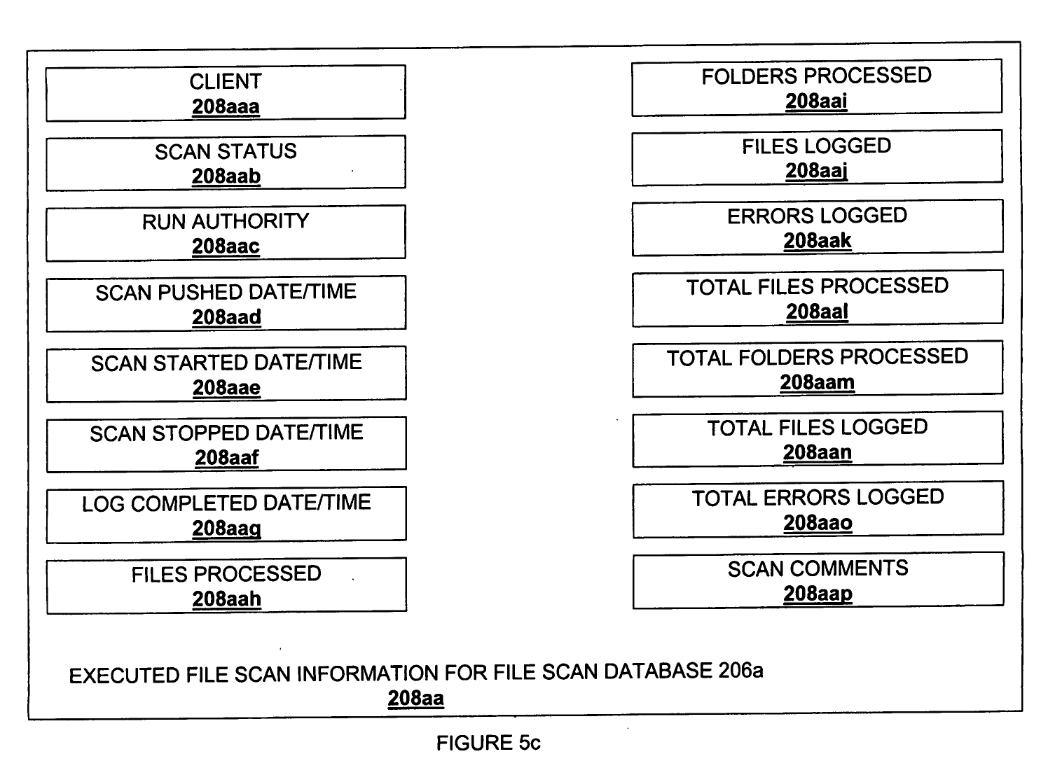

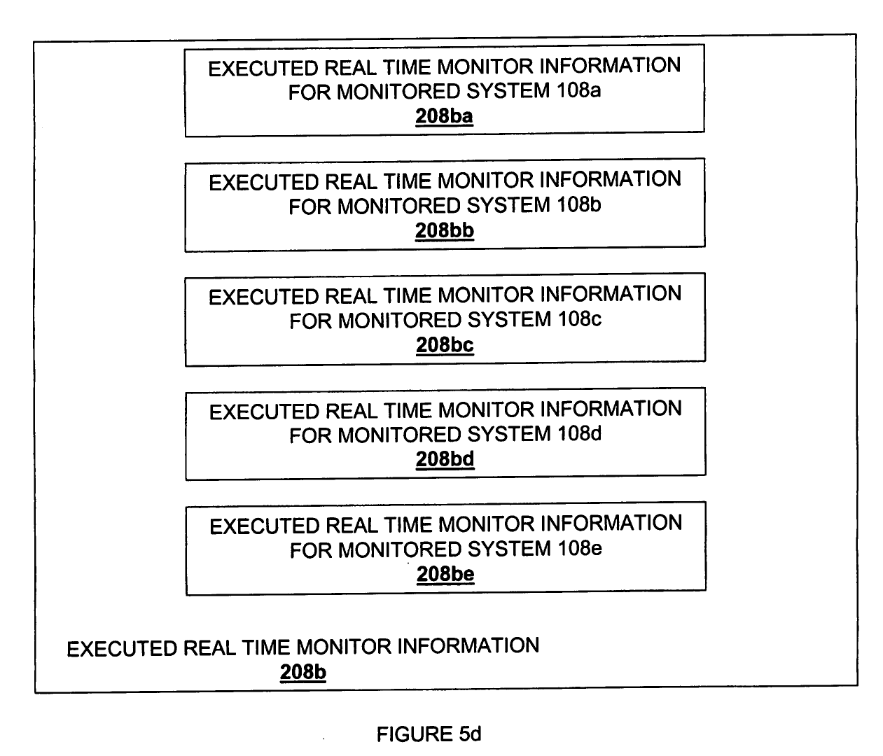

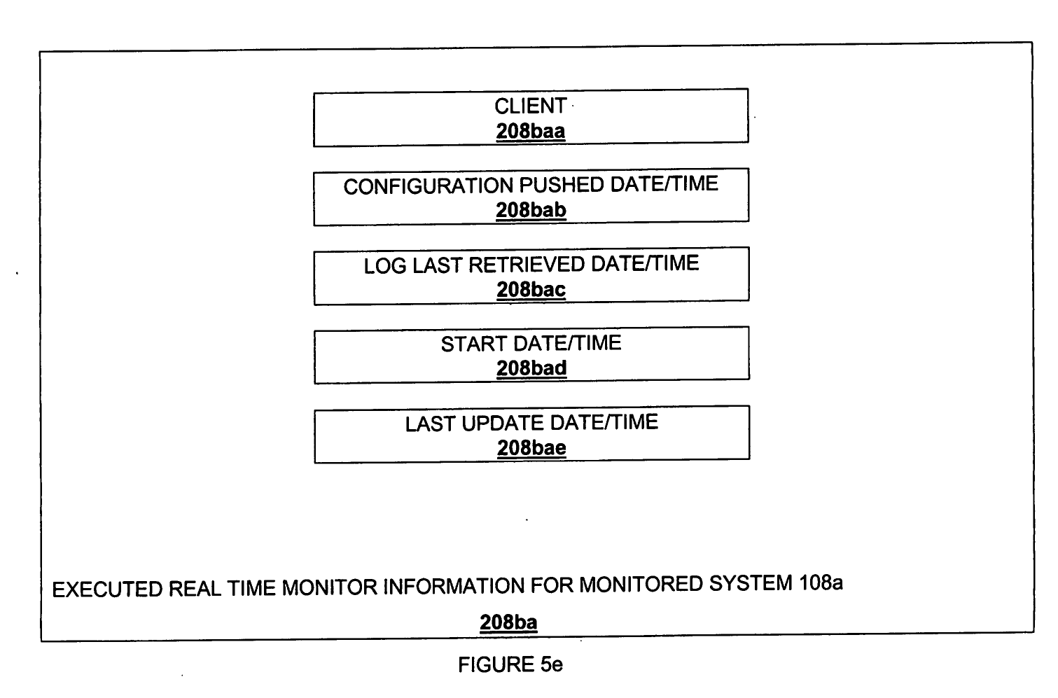

Referring now to FIGS. 5a, 5b, 5c, 5d, 5e, an exemplary embodiment of the scans database 208 includes executed file scan information 208a and executed real time monitor information 208b. In several exemplary embodiments, a scans database 208 collects configuration data for executed file scans and executed real time monitor sessions.

In an exemplary embodiment, as illustrated in FIG. 5b, executed file scan information 208a includes executed file scan information 208aa for file scan database 206a, executed file scan information 208ab for file scan database 206b, executed file scan information 208ac for file scan database 206c, executed file scan information 208ad for file scan database 206d, executed file scan information 208ae for file scan database 206e, and executed file scan information 208af for file scan database 206f. In an exemplary embodiment, as illustrated in FIG. 5c, executed file scan information 208aa for file scan database 206a includes a client 208aaa, a scan status 208aab, a run authority 208aac, a scan pushed date/time 208aad, a scan started date/time 208aae, a scan stopped date/time 208aaf, a log completed date/time 208aag, a files processed 208aah, a folders processed 208aai, a files logged 208aaj, an errors logged 208aak, a total files processed 208aal, a total folders logged 208aam, a total files logged 208aan, a total errors logged 208aao, and a scan comments 208aap.

In an exemplary embodiment, as illustrated in FIG. 5d, executed real time monitor information 208b includes executed real time monitor information 208ba for monitored system 108a, executed real time monitor information 208bb for monitored system 108b, executed real time monitor information 208bc for monitored system 108c, executed real time monitor information 208bd for monitored system 108d, and executed real time monitor information 208be for monitored system 108e. In an exemplary embodiment, as illustrated in FIG. 5e, executed real time monitor information 208ba for monitored system 108a includes a client 208baa, a configuration pushed date/time 208bab, a log last retrieved date/time 208bac, a start date/time 208bad, and a last update date/time 208bae. In several exemplary embodiment, the configuration pushed date/time 208bab is the date and time that the configuration for the particular real time monitoring session was transferred to monitoring system 108.

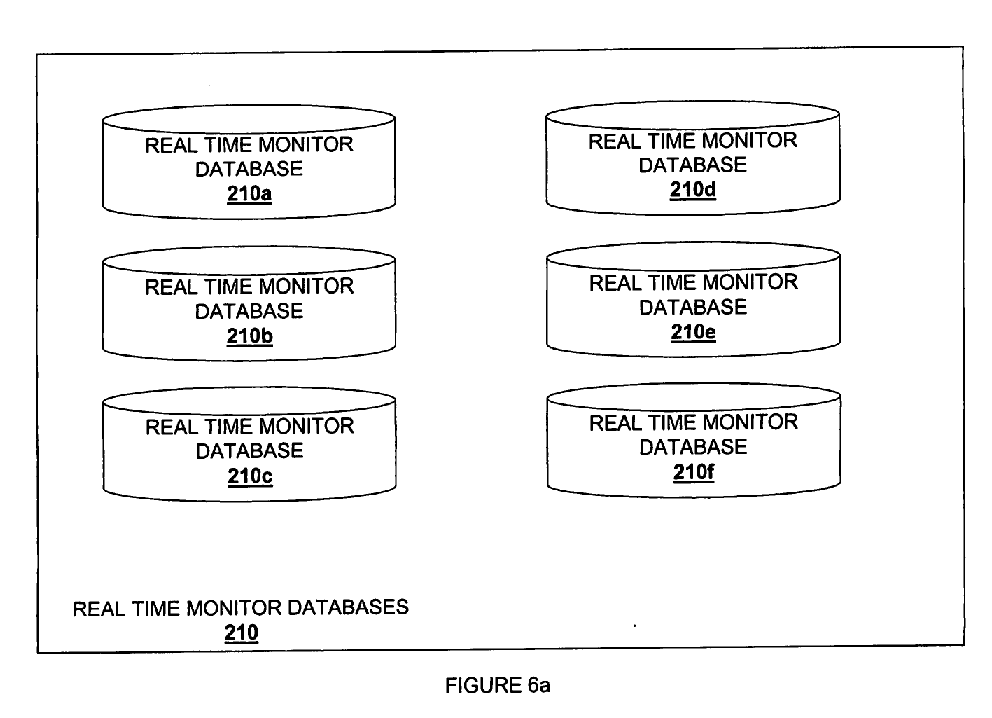

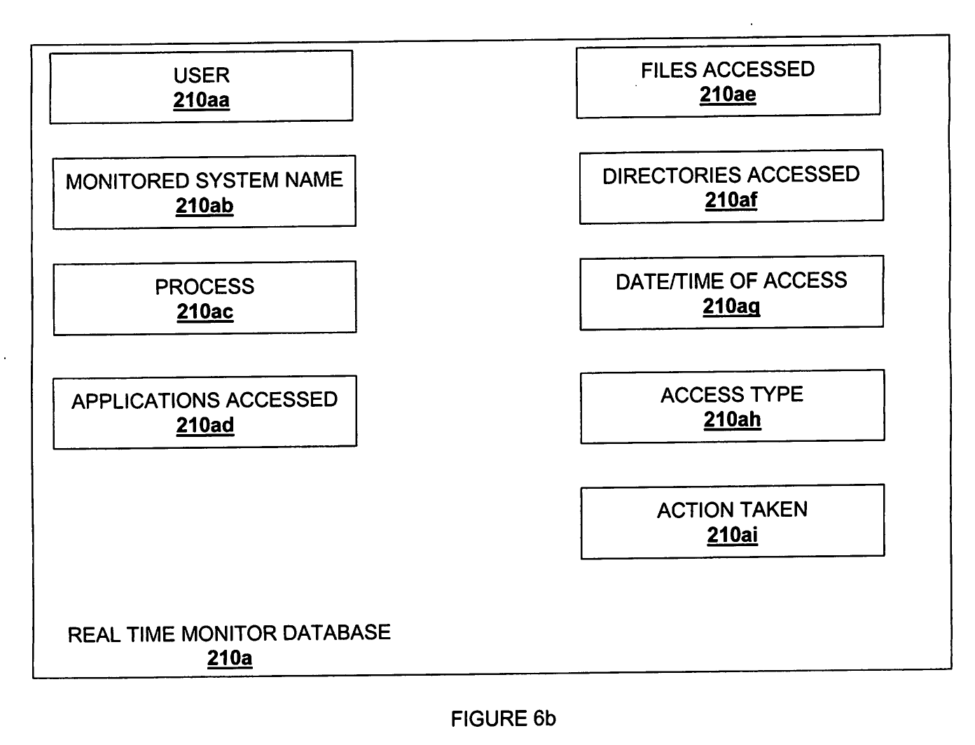

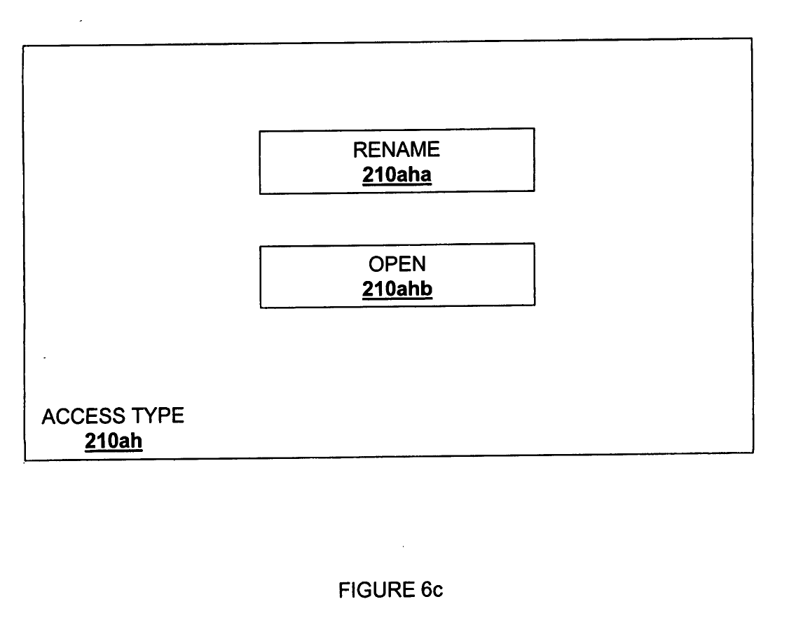

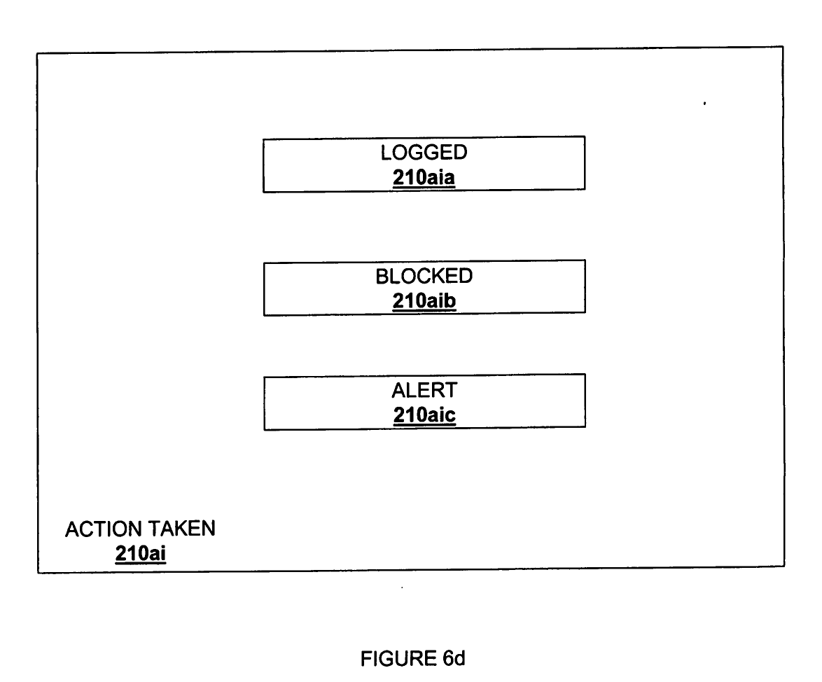

Referring now to FIGS. 6a, 6b, 6c, and 6d, an exemplary embodiment of the plurality of real time monitor databases 210 include a real time monitor database 210a, a real time monitor database 210b, a real time monitor database 210c, a real time monitor database 210d, a real time monitor database 210e, and a real time monitor database 210f. In several exemplary embodiments, real time monitor databases 210a, 210b, 210c, 210d, 210e, and 210f are substantially similar and each hold data related to a particular group of monitored systems 108. A plurality of real time monitor databases 210a, 210b, 210c, 210d, 210e, and 210f may exist for a single group of monitored systems 108 if the databases grow very large.

In an exemplary embodiment, as illustrated in FIG. 6b, a real time monitor database 210a includes a user 210aa, a monitored system name 210ab, a process 210ac, one or more applications accessed 210ad, one or more files accessed 210ae, one or more directories accessed 210af, a date/time of access 210ag, an access type 210ah, and an action taken 210ai. In an exemplary embodiment, as illustrated in FIG. 6c, the access type 210ah includes rename 210aha, and open 210ahb. In several exemplary embodiments, the rename 210aha is an indication that a user has renamed a file during the real time monitor session. In several exemplary embodiments, the open 210ahb is an indication that an access attempt was made on a file on the monitored system during the real time monitoring session. In an exemplary embodiment, as illustrated in FIG. 6d, the action taken 210ai includes a logging action 210aia, a blocking action 210aib, and an alert action 210aic. In several exemplary embodiments, the logging action 210aia is a log made of an access attempt and whether the access attempt was blocked or allowed during a real time monitor session. In several exemplary embodiments, the blocking action 210aib is an indication that access was blocked during a real time monitor session. In several exemplary embodiments, the alert action 210aic is an indication that an alert was sent during a real time monitor session.

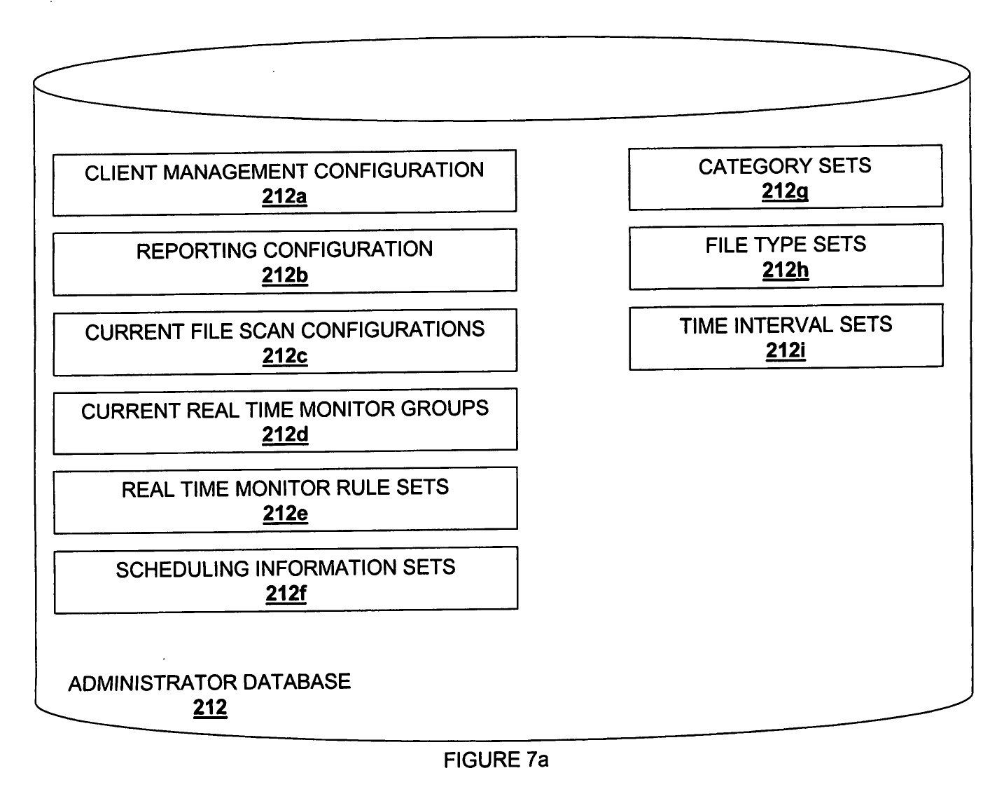

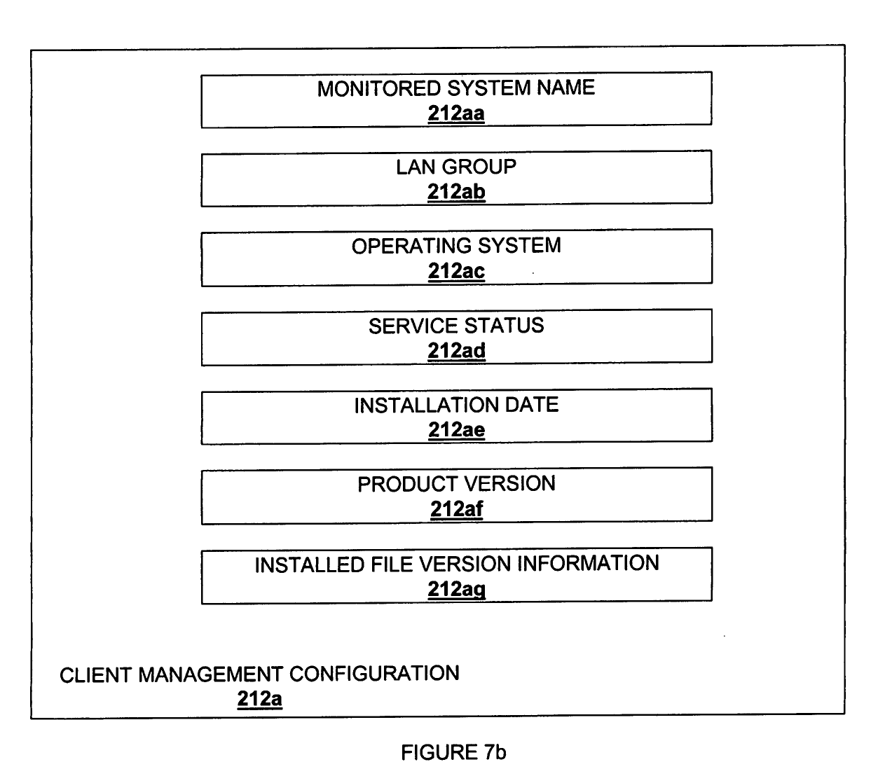

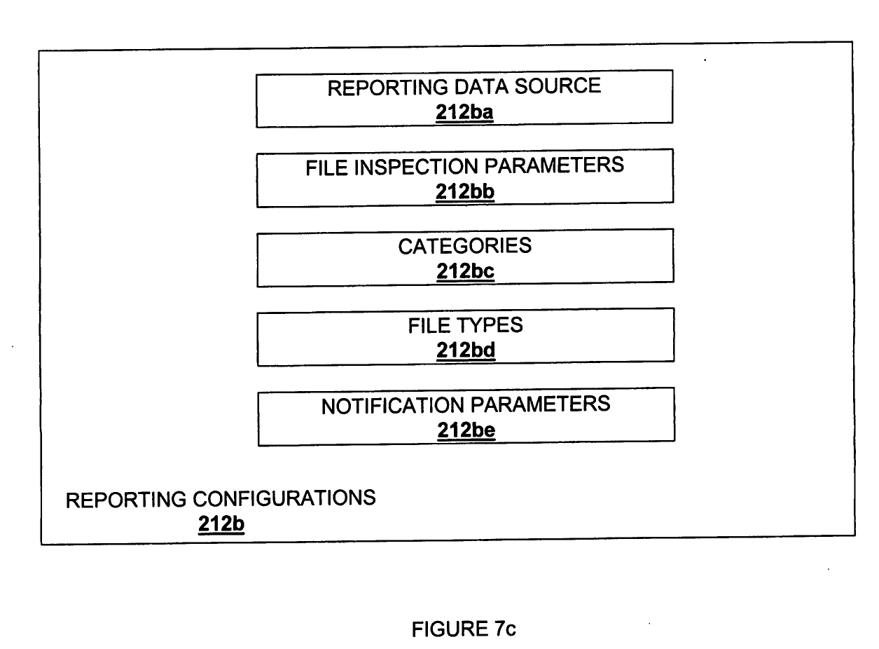

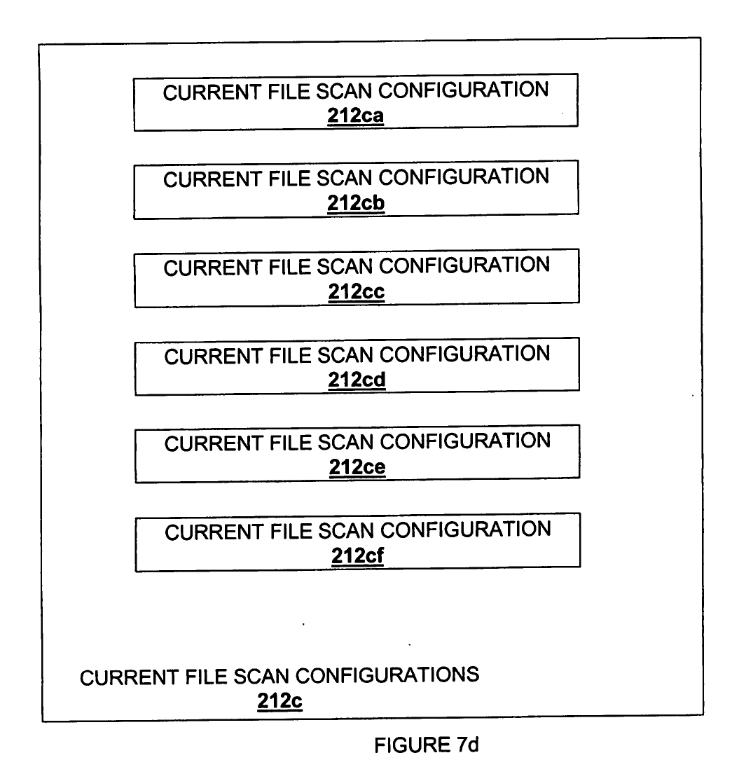

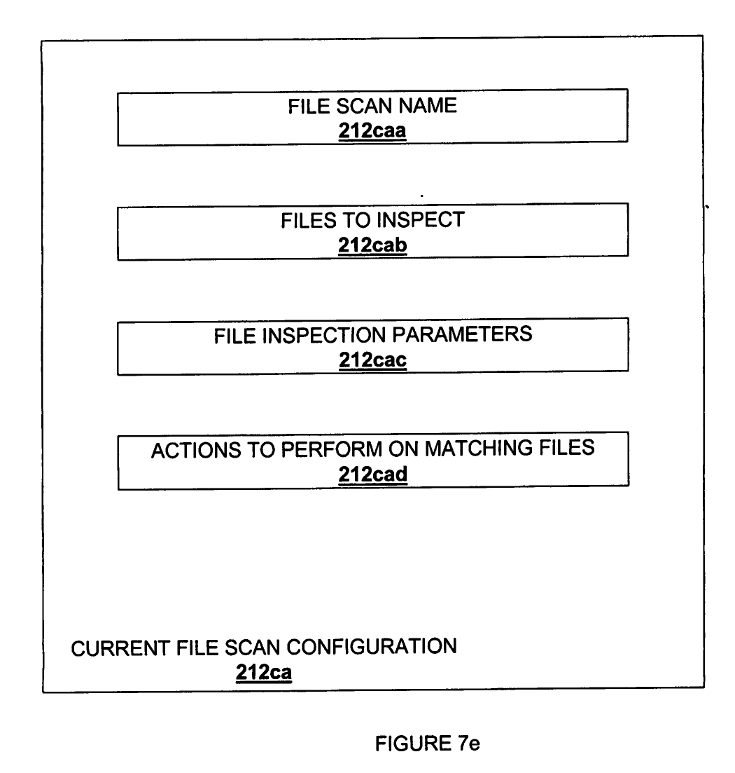

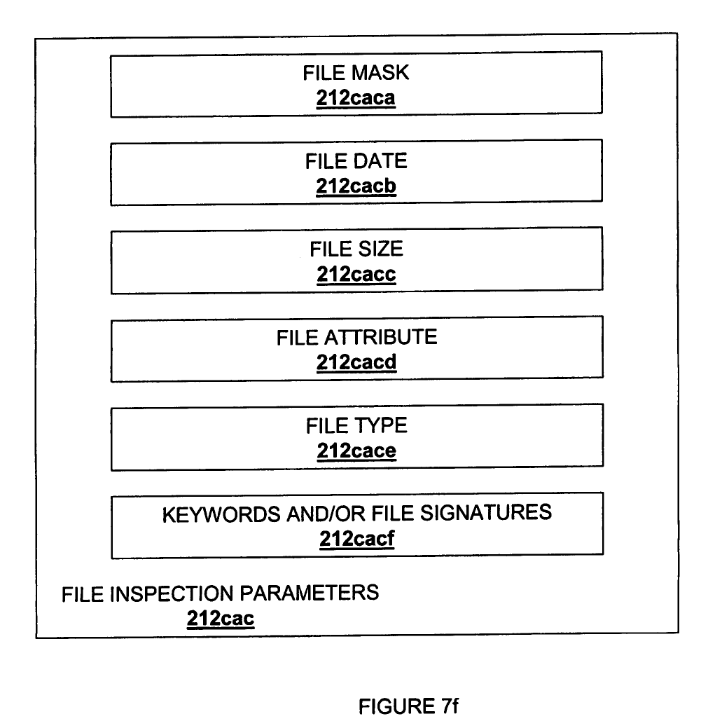

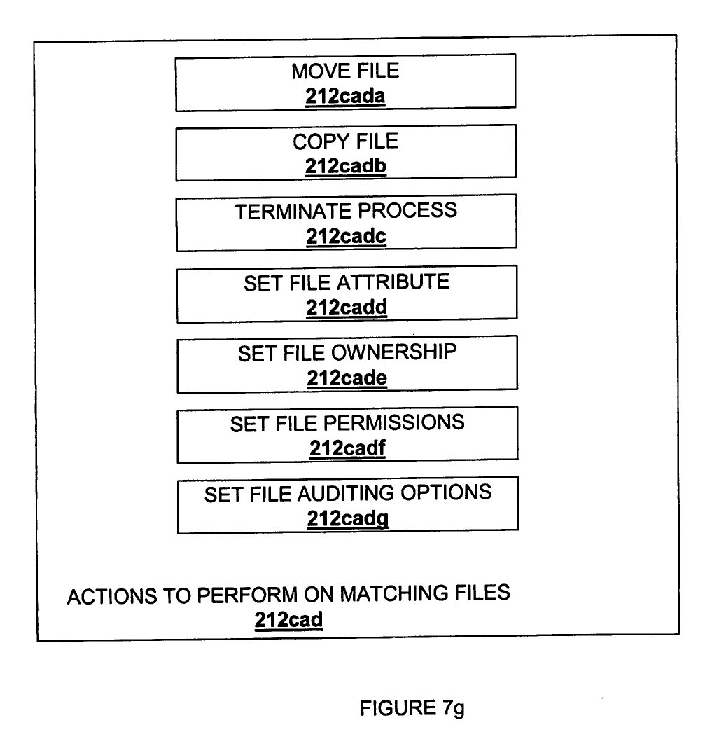

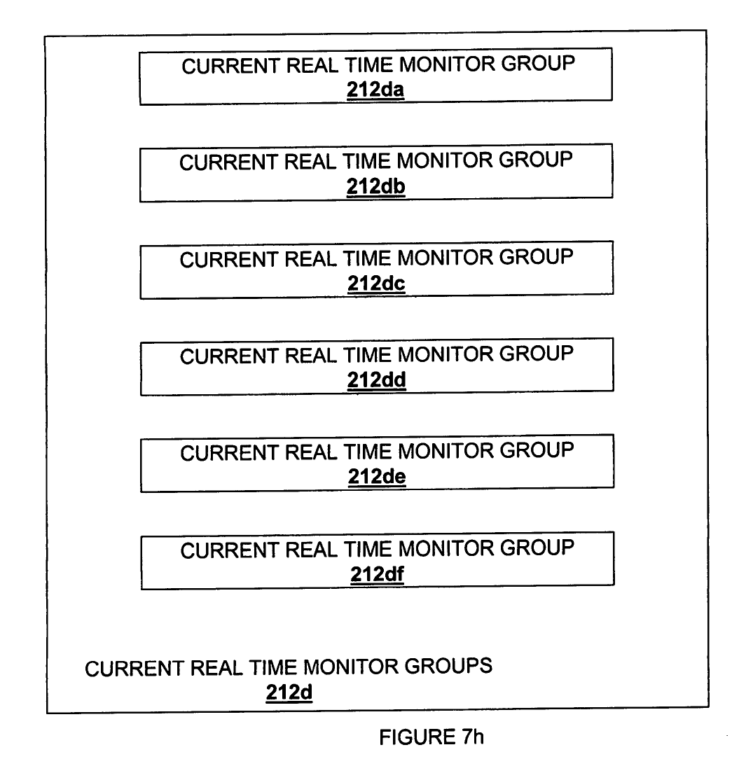

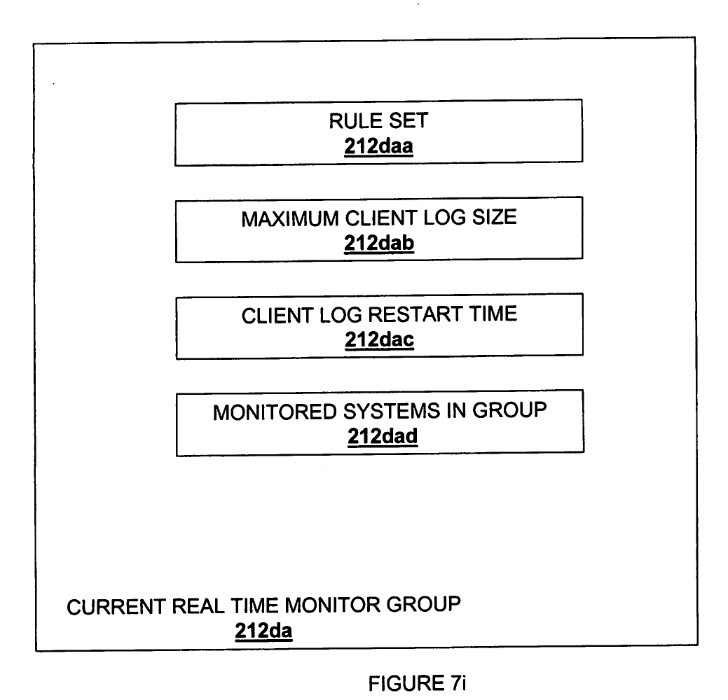

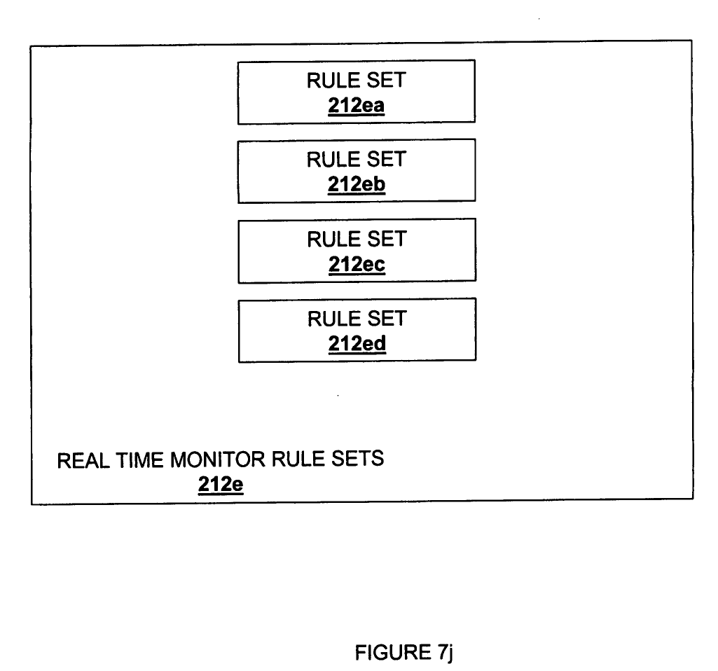

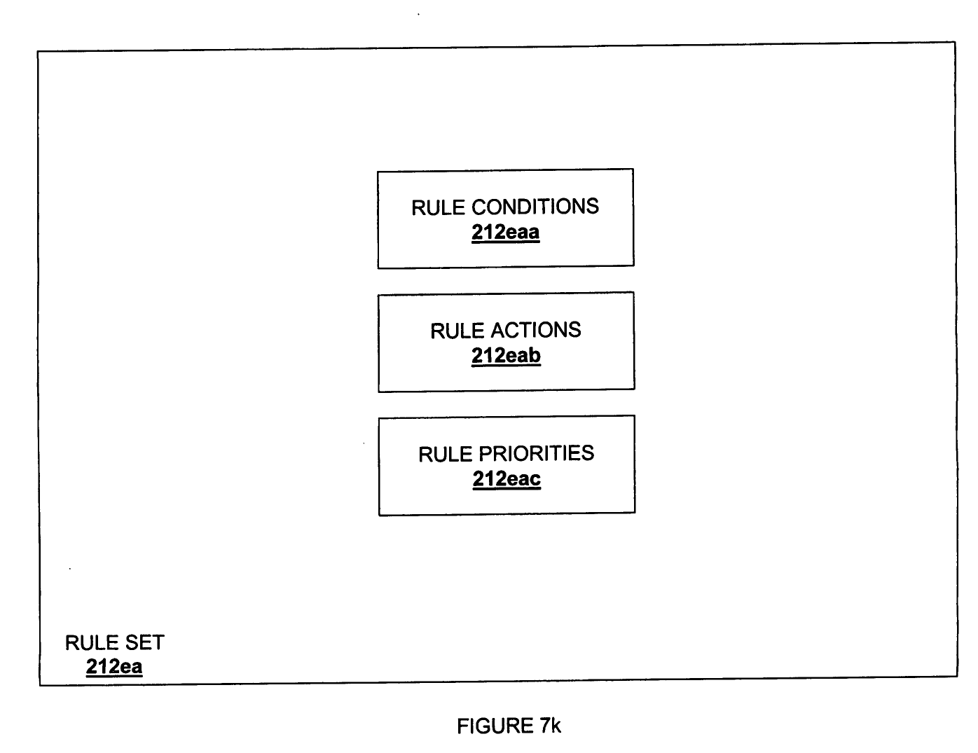

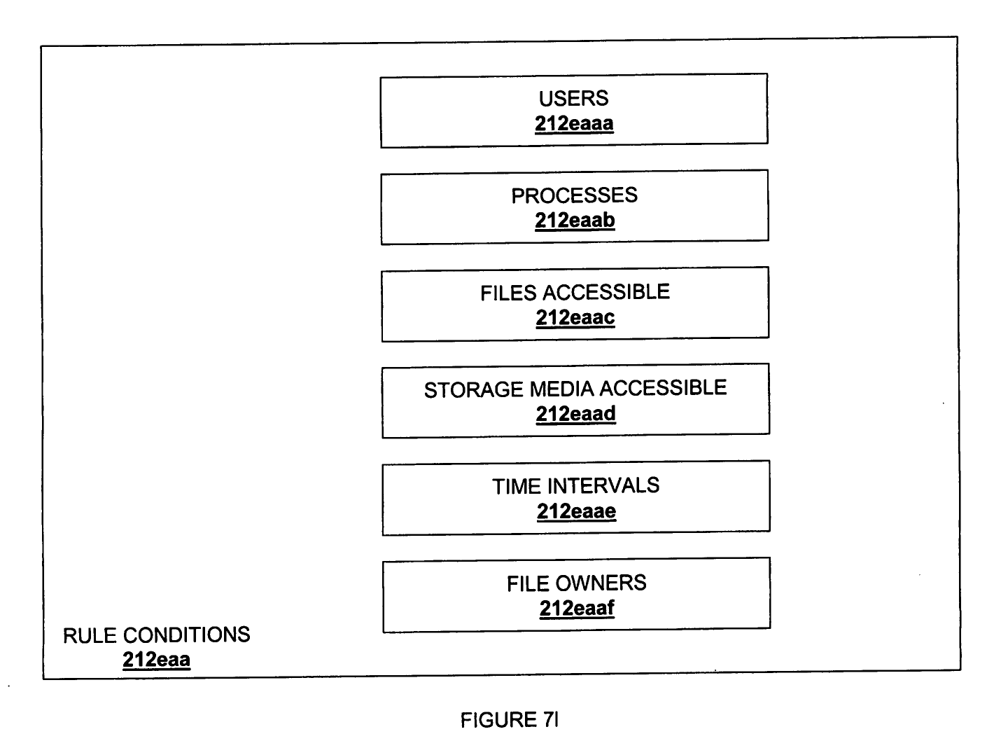

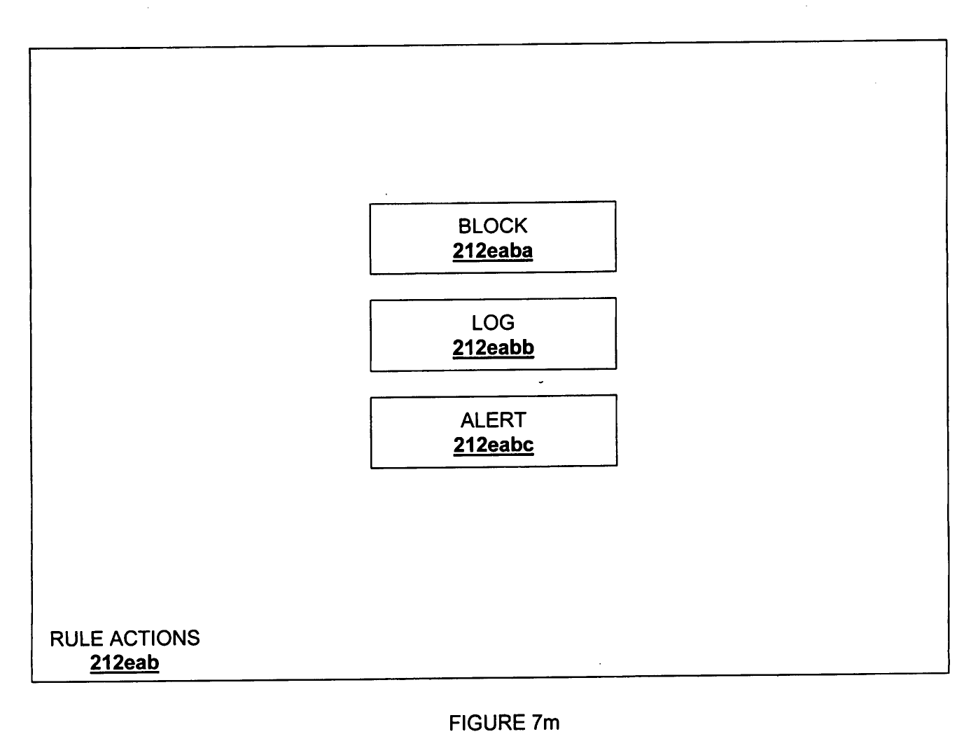

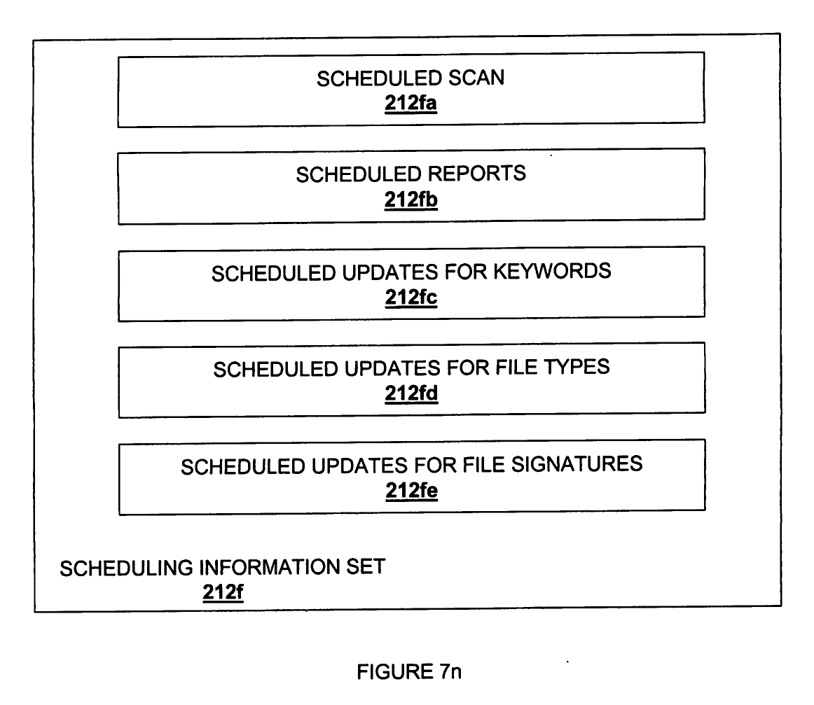

Referring now to FIGS. 7a, 7b, 7c, 7d, 7e, 7f, 7g, 7h, 7i, 7j, 7k, 7l, 7m, and 7n, an exemplary embodiment of an administrator database 212 includes a client management configuration 212a, one or more reporting configurations 212b, one or more current file scan configurations 212c, one or more current real time monitor groups 212d, one or more real time monitor rule sets 212e, one or more scheduling information sets 212f, one or more category sets 212g, one or more file type sets 212h, and one or more time interval sets 212i. In several exemplary embodiments, a client management configuration 212a is the configuration of the monitored systems 108 that are connected to the surveillance management system 102. In several exemplary embodiments, one or more reporting configurations 212b are the configurations used by the surveillance management system 102 to determine what types of reports to generate. In several exemplary embodiments, one or more current file scan configurations 212c are the configurations for the updated file scans that are run on the system 100. In several exemplary embodiments, one or more current real time monitor groups 212d are groups of monitored systems 108 on which a particular real time monitor session is run on. In several exemplary embodiments, one or more real time monitor rule sets 212e are rules used to determine what types of access on the monitored systems 108 will be allowed. In several exemplary embodiments, one or more scheduling information sets 212f are sets of information used to determine when components of the surveillance engine 200 should run. In several exemplary embodiments, one or more category sets 212g are sets of categories used by the file scan engine 200a to conduct file scans. In several exemplary embodiments, one or more file type sets 212h are sets of file types used by the file scan engine 200a to conduct file scans. In several exemplary embodiments, one or more time interval sets 212i are sets of time intervals used by the real time monitor engine 200e to determine how, when, and which rule sets will control access to the monitored systems 108.

In an exemplary embodiment, as illustrated in FIG. 7b, the client management configuration 212a includes a monitored system name 212aa, a LAN group 212ab, an operating system 212ac, a service status 212ad, an installation date 212ae, a product version 212af, and a installed file version information 212ag. In several exemplary embodiments, the installed file version information 212ag is a version number for a file installed in the system 100.

In an exemplary embodiment, as illustrated in FIG. 7c, one or more reporting configurations 212b includes a reporting data source 212ba, one or more file inspection parameters 212bb, one or more categories 212bc, one or more file types 212bd, and one or more notification parameters 212be. In several exemplary embodiments, one or more categories 212bc are categories including keywords and/or file signatures that may be used to generate reports. In several exemplary embodiments, one or more file types 212bd are file types used to generate reports. In several exemplary embodiments, one or more notification parameters 212be indicate whom to notify when a report is generated, what the report format should be, and where to store the report.

In an exemplary embodiment, as illustrated in FIG. 7d, one or more current file scan configurations 212c includes a current file scan configuration 212ca, a current file scan configuration 212cb, a current file scan configuration 212cc, a current file scan configuration 212cd, a current file scan configuration 212ce, and a current file scan configuration 212cf. In an exemplary embodiment, as illustrated in FIG. 7e, the current file scan configuration 212ca includes a file scan name 212caa, more or more files to inspect 212cab, one or more file inspection parameters 212cac, and one or more actions to perform on matching files 212cad. In an exemplary embodiment, as illustrated in FIG. 7f, one or more file inspection parameters 212cac include a file mask 212caca, a file date 212cacb, a file size 212cacc, a file attribute 212cacd, a file type 212cace, and a keywords and/or file signature 212cacf. In several exemplary embodiments, the file mask 212caca is all or part of a file name or folder name used in a current file scan. In several exemplary embodiments, the file attribute 212cacd is a system property of a file used in a current file scan including archive, read-only, hidden, system, temporary, compressed, encrypted, and off-line. In several exemplary embodiments, the file type 212cace is a file extension and/or known file format used in a current file scan. In several exemplary embodiments, a keyword is a word or phrase used in a current file scan to search for files. In several exemplary embodiments, a file signature is a digital signature that was created for any file, such as a file that contains sensitive or proprietary data, and used in a particular file scan. In an exemplary embodiment, as illustrated in FIG. 7g, one or more actions to perform on matching files 212cad includes moving a file 212cada, copying a file 212cadb, terminating a process 212cadc, setting file attributes 212cadd, setting file ownership 212cade, setting file permissions 212cadf, and setting file auditing options 212cadg. In several exemplary embodiments, the setting file attributes 212cadd is the setting of archive, read-only, hidden, or system on a file in a current file scan. In several exemplary embodiments, setting file ownership 212cade is the setting of a user owner or a group owner on a file in a current file scan. In several exemplary embodiments, setting file permissions 212cadf is the setting of which users and groups can execute, read data, read attributes, read extended attributes, write data, append data, write attributes, write extended attributes, delete, read permissions, change permissions, or take ownership on the file performed on a file in a current file scan. In several exemplary embodiments, setting file auditing options 212cadg is a recording of whether the set file permission action 206aadf succeeded or failed for a current file scan.

In an exemplary embodiment, as illustrated in FIG. 7h, one or more current real time monitor groups 212d includes a current real time monitor group 212da, a current real time monitor group 212db, a current real time monitor group 212dc, a current real time monitor group 212dd, a current real time monitor group 212de, and a current real time monitor group 212df. In an exemplary embodiment, as illustrated in FIG. 7i, the current real time monitor group 212da includes a rule set 212daa, a maximum client log size 212dab, a client log restart time 212dac, and one or more monitored systems in the group 212dad. In several exemplary embodiments, the rule set 212daa is a set of rules used to determine the process, users, files, storage media types, or file owners to monitor and the actions to perform when the rules are satisfied. In several exemplary embodiments, the maximum client log size 212dab is the maximum size a log for the monitored group may achieve before another log is created. In several exemplary embodiments, the client log restart time 212dac is a time for creating a new log for a particular monitored group.

In an exemplary embodiment, as illustrated in FIG. 7j, one or more real time monitor rule sets 212e includes a rule set 212ea, a rule set 212eb, a rule set 212ec, and a rule set 212ed. In an exemplary embodiment, as illustrated in FIG. 7k, the rule set 212ea includes one or more rule conditions 212eaa, one or more rule actions 212eab, and one or more rule priorities 212eac. In several exemplary embodiments, one or more rule conditions 212eaa are the conditions necessary for a rule action 212eab to be performed. In several exemplary embodiments, one or more rule priorities 212eac are the sequence in which rules in a rule set, such as rule set 212ea, are used to evaluate monitored activities of the monitored systems, such as monitored systems 108. In an exemplary embodiment, as illustrated in FIG. 7l, one or more rule conditions 212eaa includes one or more users 212eaaa, one or more processes 212eaab, one or more files accessible 212eaac, one or more storage media accessible 212eaad, one or more time intervals 212eaae, and one or more file owners 212eaaf. In an exemplary embodiment, as illustrated in FIG. 7m, one or more rule actions 212eab includes a blocking action 212eaba, a logging action 212eabb, and an alerting action 212eabc.

In an exemplary embodiment, as illustrated in FIG. 7n, one or more scheduling information sets 212f includes a scheduled scan 212fa, a scheduled report 212fb, a scheduled update for keywords 212fc, a scheduled update for file types 212fd, and a scheduled update for file signatures 212fe.

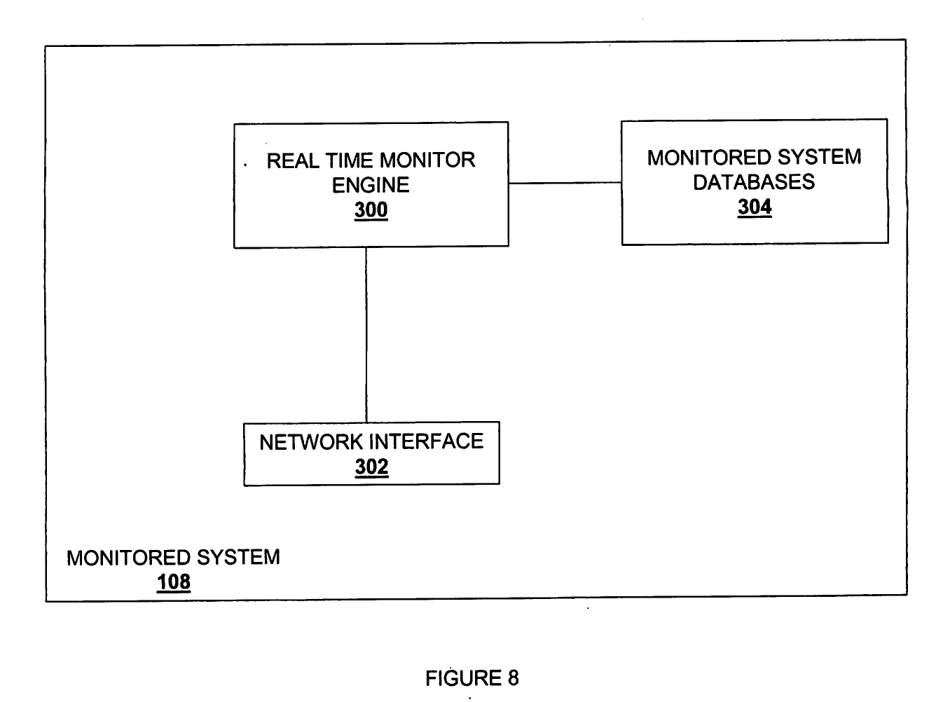

Referring now to FIG. 8, an exemplary embodiment of the monitored system 108 includes a real time monitor engine 300 which is operably coupled to a network interface 302. In several exemplary embodiments, the real time monitor engine 300 is adapted to retrieve rules from the surveillance management system 102 and use those rules to monitor files, as well as access rights to those files for given users or groups of users. The network interface 302 allows the real time monitor engine 300 to access a network, such as the network 104 illustrated in FIGS. 1a, 1b, and 1c. A plurality of monitored system databases 304 are coupled to the real time monitor engine 300. In several exemplary embodiments, a real time engine may be implemented using hardware, software, firmware, or a variety of equivalent implementation devices known in the art, and distributed throughout the system 100.

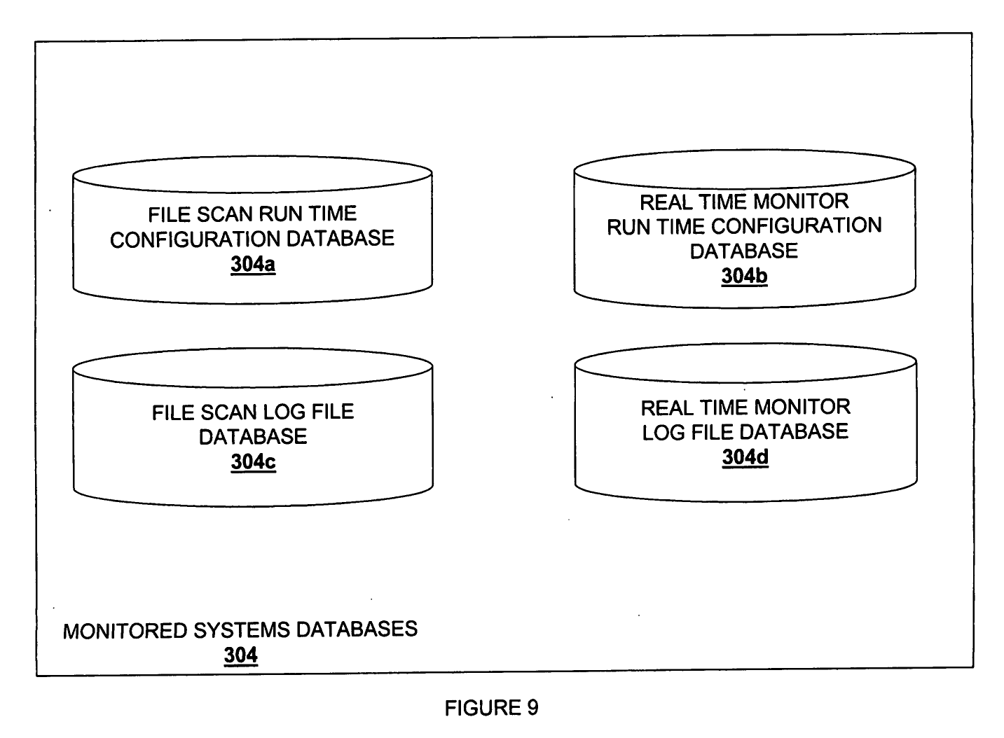

Referring now to FIG. 9, an exemplary embodiment of the plurality of monitored system databases 304 includes a file scan run time configuration database 304a, a real time monitor run time configuration database 304b, a file scan log file database 304c, and a real time monitor log file database 304d. In several exemplary embodiments, the file scan run time configuration database 304a holds data for configuring file scans run by the file scan engine 200a on the monitored system 108. In several exemplary embodiments, the real time monitor run time configuration database 304b holds data for configuring real time monitoring sessions run by the real time monitor engine 300 on the monitored system 108. In several exemplary embodiments, the file scan log file database 304c holds results of file scans run by the file scan engine 200a on the monitored system 108. In several exemplary embodiments, the real time monitor log file database 304d holds results of real time monitor sessions run by the real time monitor engine 300 on the monitored system 108.

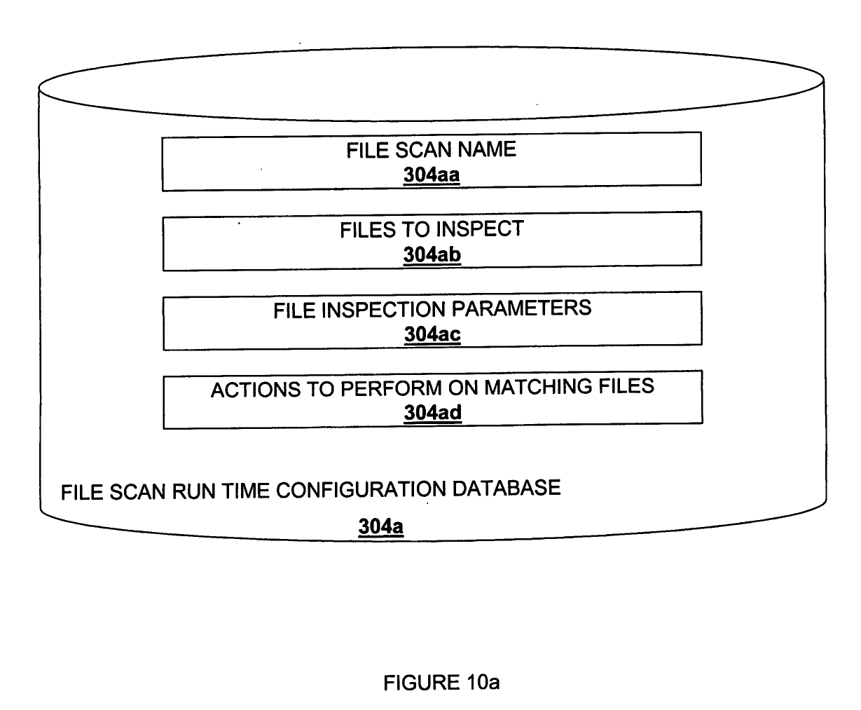

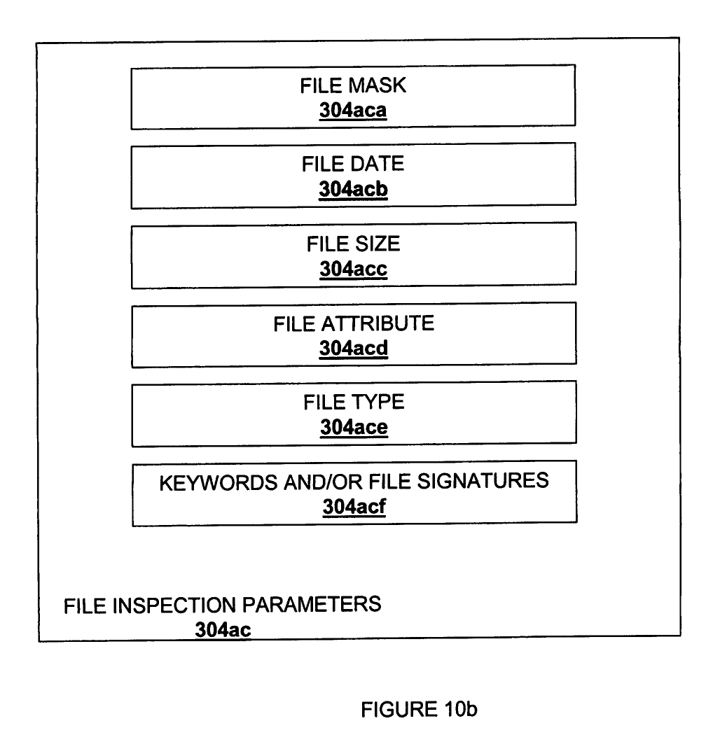

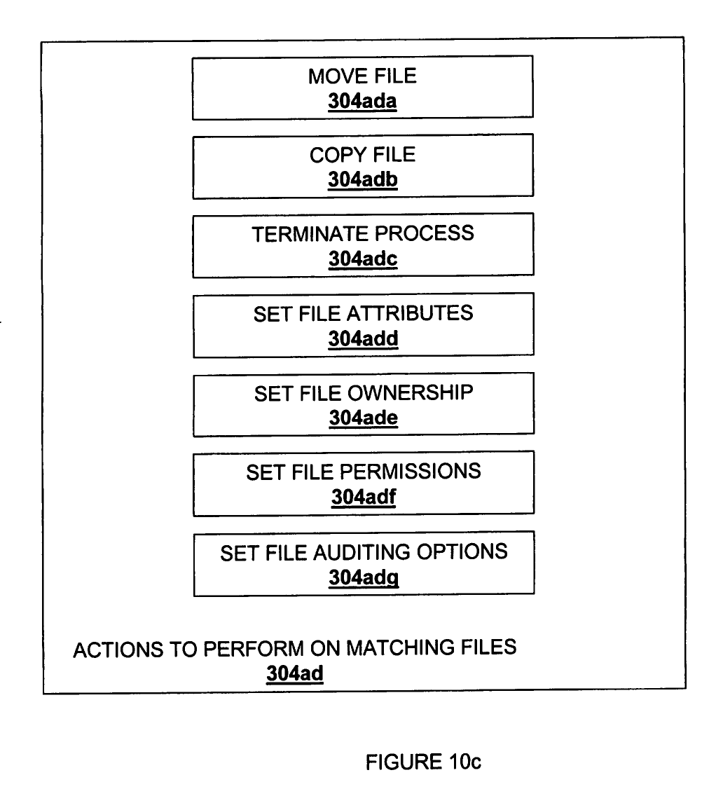

Referring now to FIGS. 10a, 10b, and 10c, an exemplary embodiment of the file scan run time configuration database 304a includes a file scan name 304aa, one or more files to inspect 304ab, one or more file inspection parameters 304ac, and one or more actions to perform on matching files 304ad. In an exemplary embodiment, as illustrated in FIG. 10b, one or more file inspection parameters 304ac includes a file mask 304aca, a file date 304acb, a file size 304acc, a file attribute 304acd, a file type 304ace, and a keyword and/or file signature 304acf. In several exemplary embodiments, the file mask 304aca is all or part of a file name or folder name used in a file scan run on the monitored system 108. In several exemplary embodiments, the file attribute 304acd is a system property of a file used in a file scan run on the monitored system 108 including archive, read-only, hidden, system, temporary, compressed, encrypted, and off-line. In several exemplary embodiments, the file type 304ace is a file extension and/or known file format used in a file scan run on the monitored system 108. In several exemplary embodiments, a keyword is a word or phrase used in a file scan run on the monitored system 108 to search for files. In several exemplary embodiments, a file signature is a digital signature that was created for any file, such as a file that contains sensitive or proprietary data, and used in a particular file scan on the monitored system 108. In an exemplary embodiment, as illustrated in FIG. 10c, one or more actions to perform on matching files 304ad includes moving a file 304ada, copying a file 304adb, terminating a process 304adc, setting file attributes 304add, setting file ownership 304ade, setting file permissions 304adf, and setting file auditing options 304adg. In several exemplary embodiments, setting file attributes 304add is the setting of archive, read-only, hidden, or system on a file in a current file scan. In several exemplary embodiments, setting file ownership 304ade is the setting of a user owner or a group owner on a file in a file scan run on the monitored system 108. In several exemplary embodiments, setting file permissions 304adf is the setting of which users and groups can execute, read data, read attributes, read extended attributes, write data, append data, write attributes, write extended attributes, delete, read permissions, change permissions, or take ownership on the file performed on a file in a file scan run on the monitored system 108. In several exemplary embodiments, setting file auditing options 304adg is a recording of whether the set file permission action 304adf succeeded or failed for a file scan run on the monitored system 108.

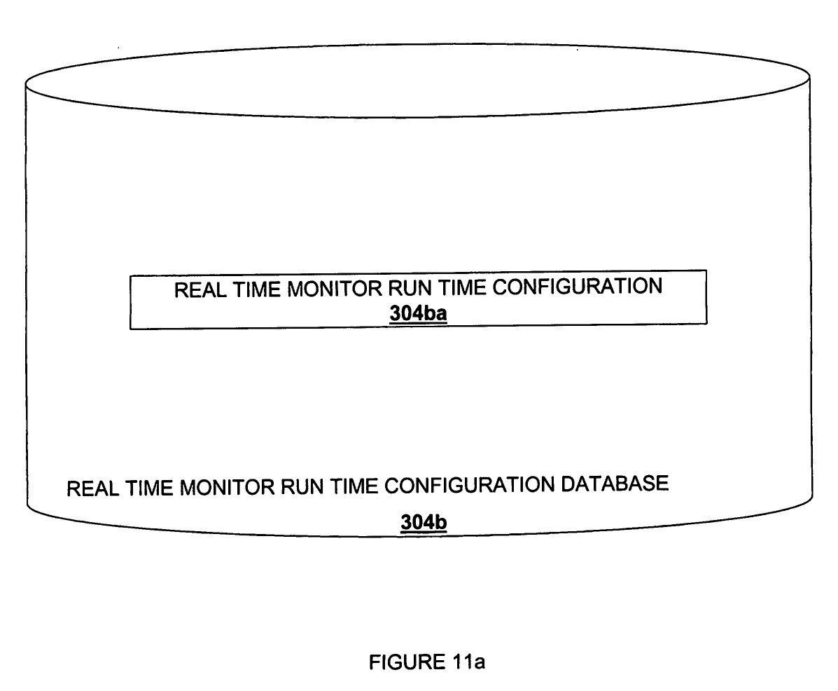

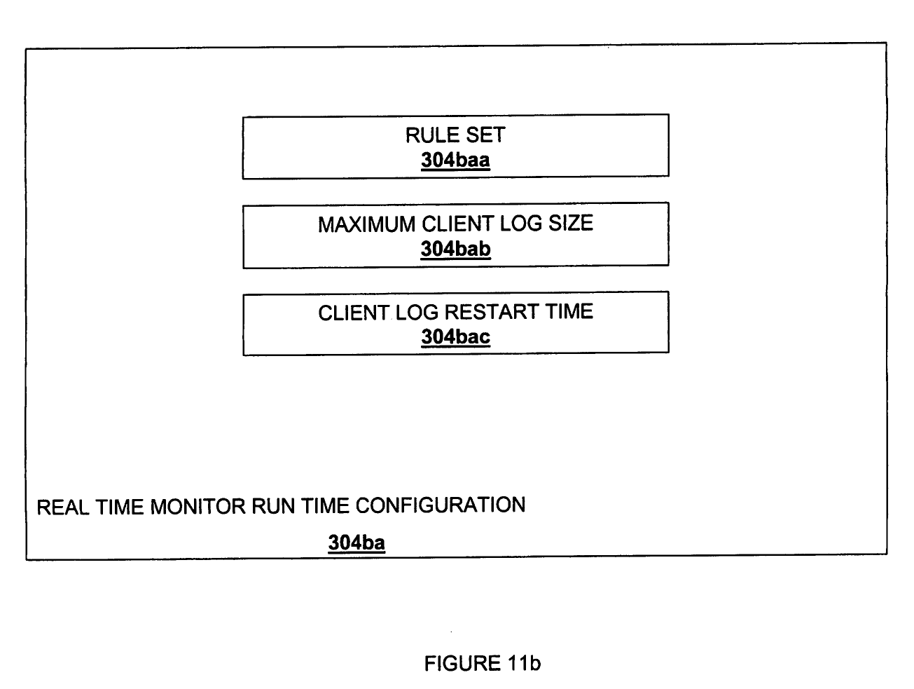

Referring now to FIGS. 11a and 11b, an exemplary embodiment of the real time monitor run time configuration database 304b includes a real time monitor run time configuration 304ba. In an exemplary embodiment, as illustrated in FIG. 11b, the real time monitor run time configuration database 304ba includes a rule set 304baa, a maximum client log size 304bab, and a client log restart time 304bac. In several exemplary embodiments, the rule set 304baa is a set of rules used to determine the process, users, files, storage media types, or file owners to monitor and the actions to perform when the rules are satisfied in a real time monitor session run on the monitored system 108. In several exemplary embodiments, the maximum client log size 304bab is the maximum size a log for the monitored system 108 may achieve before another log is created. In several exemplary embodiments, the client log restart time 304bac is a time for creating a new log for a particular monitored system 108.

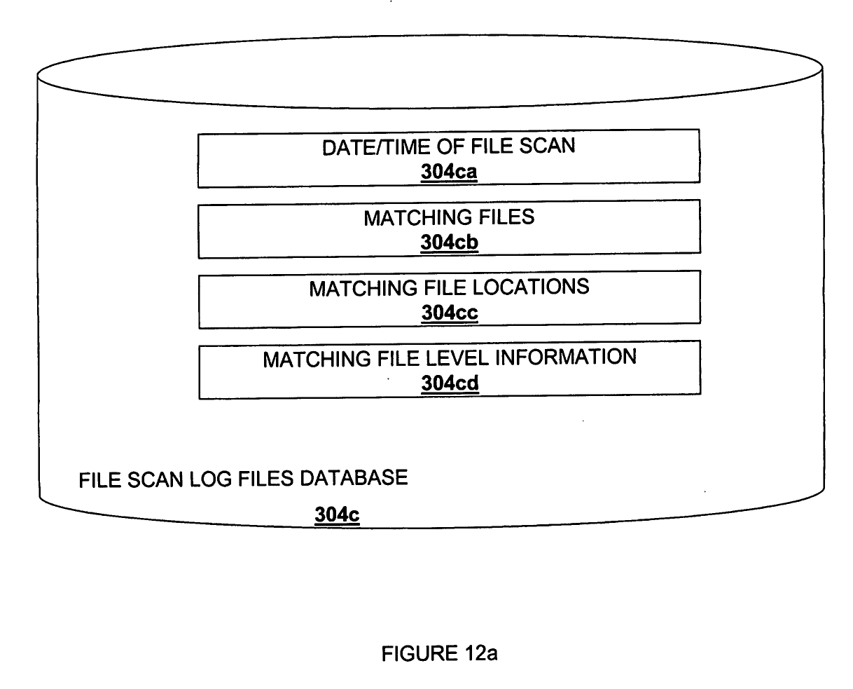

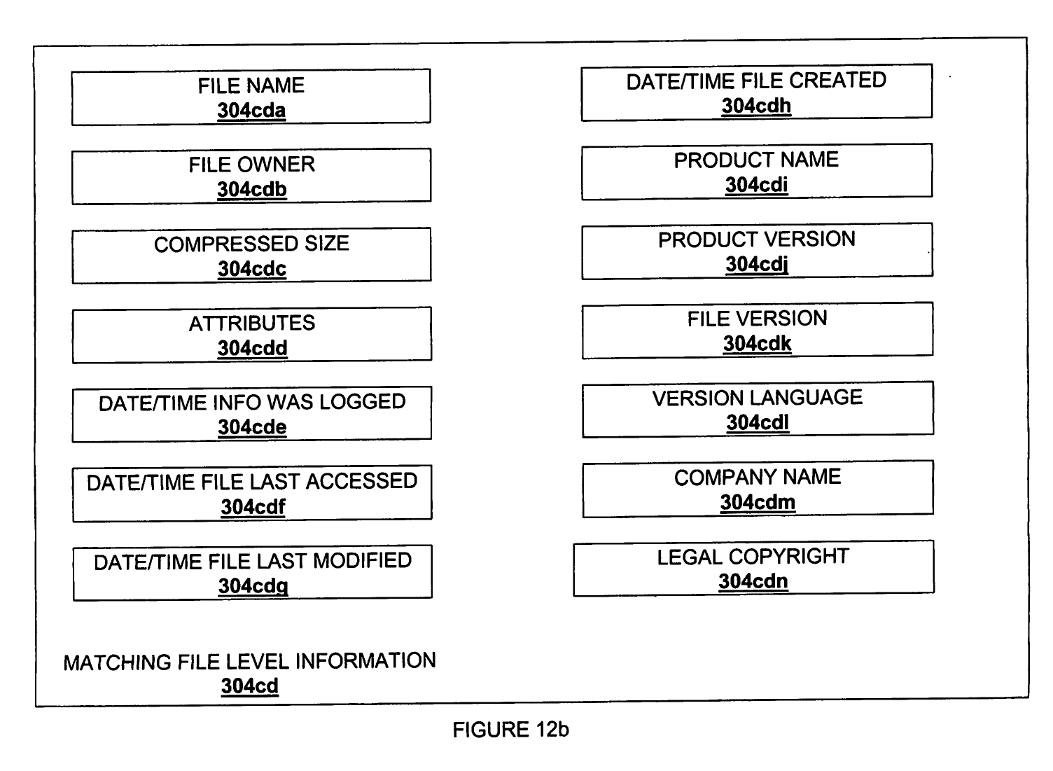

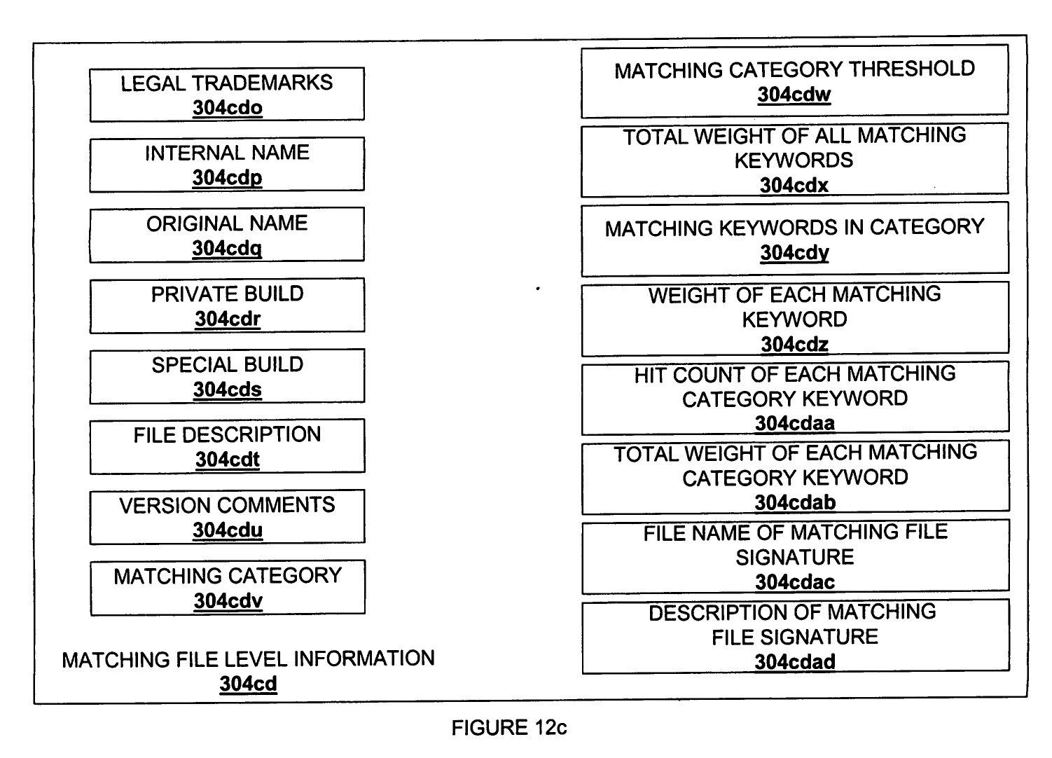

Referring now to FIGS. 12a, 12b, and 12c, an exemplary embodiment of the file scan log files database 304c includes a date/time of file scan 304ca, one or more matching files 304cb, one or more matching file locations 304cc, and matching file level information 304cd. In an exemplary embodiment, as illustrated in FIGS. 12b and 12c, matching file level information 304cd includes a file name 304cda, a file owner 304cdb, a compressed size 304cdc, an attribute 304cdd, a date/time information was logged 304cde, a date/time a file was last accessed 304cdf, a date/time a file was last modified 304cdg, a date/time a file was created 304cdh, a product name 304cdi, a product version 304cdj, a file version 304cdk, a version language 304cdl, a company name 304cdm, a legal copyright 304cdn, a legal trademark 304cdo, an internal name 304cdp, an original name 304cdq, a private build 304cdr, a special build 304cds, a file description 304cdt, one or more version comments 304cdu, a matching category 304cdv, a matching category threshold 304cdw, a total weight of all matching keywords 304cdx, a matching keywords in category 304cdy, a weight of each matching category keyword 304cdz, a hit count of each matching category keyword 304cdaa, a total weight of each matching category keyword 304cdab, a file name of matching file signature 304cdac, and a description of matching file signature 304cdad. In several exemplary embodiments, the attribute 304cdd is a system property of a file including archive, read-only, hidden, system, temporary, compressed, encrypted, and off-line. In several exemplary embodiments, the private build 304cdr is a private version numbering of a file for developer use. In several exemplary embodiments, the special build 304cds is a special version numbering of a file for developer use. In several exemplary embodiments, the matching category 304cdv is a category that a file matched. In several exemplary embodiments, the matching category threshold 304cdw is a criteria value which keywords weights must equal or exceed to trigger a match. In several exemplary embodiments, the total weight of all matching keywords 304cdx is a total of the user defined weights assigned to the keywords that triggered a match for a particular file. In several exemplary embodiments, the matching keywords in category 304cdy is one or more keywords that triggered a match. In several exemplary embodiments, the weight of each matching category keyword 304cdz is a value assigned to the keyword that was run in the file scan. In several exemplary embodiments, the hit count of each matching category keyword 304cdaa is the number of times each keywords appeared in the matching file. In several exemplary embodiments, the total weight of each matching category keyword 304cdab is a product of the hit count of each matching category keyword 304cdaa times the weight of each corresponding matching category keyword 304cdz.

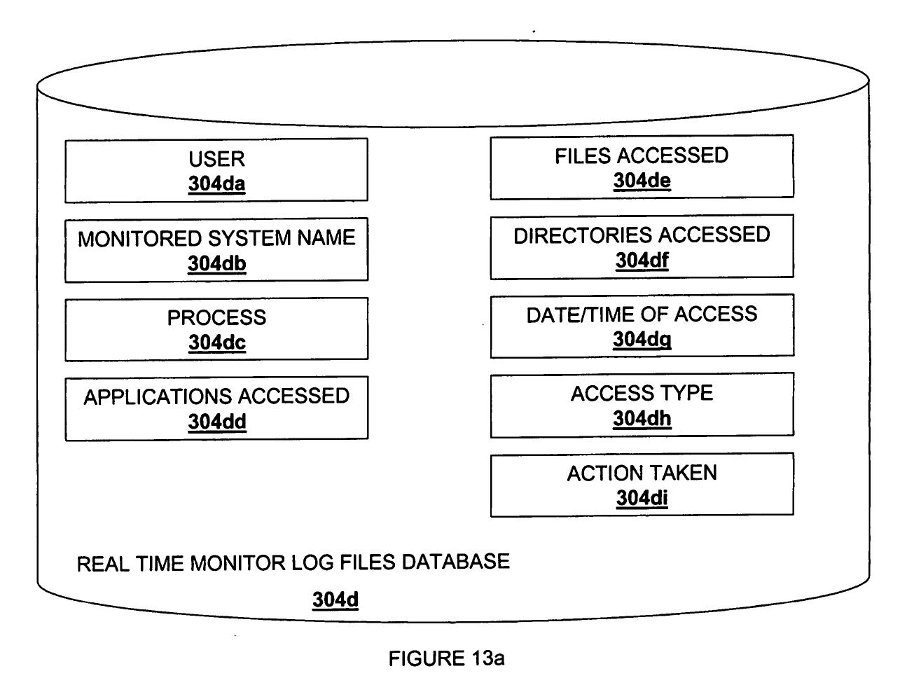

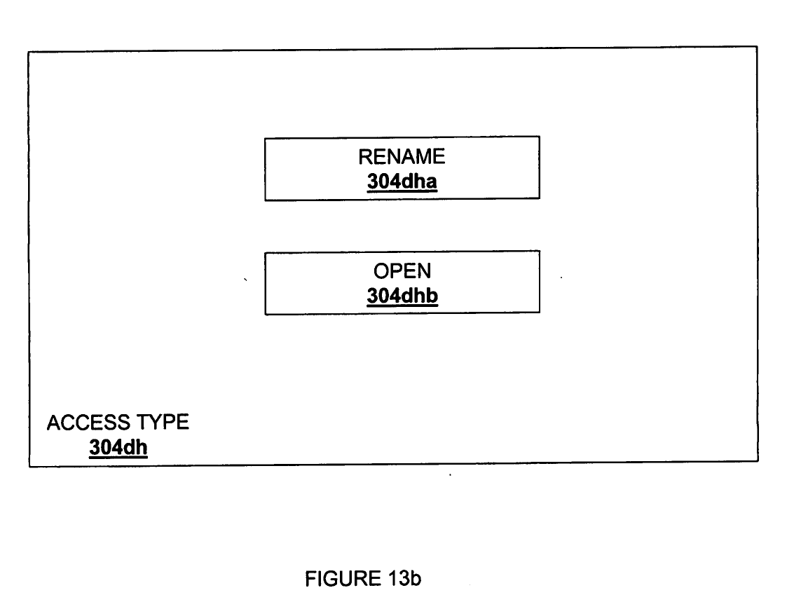

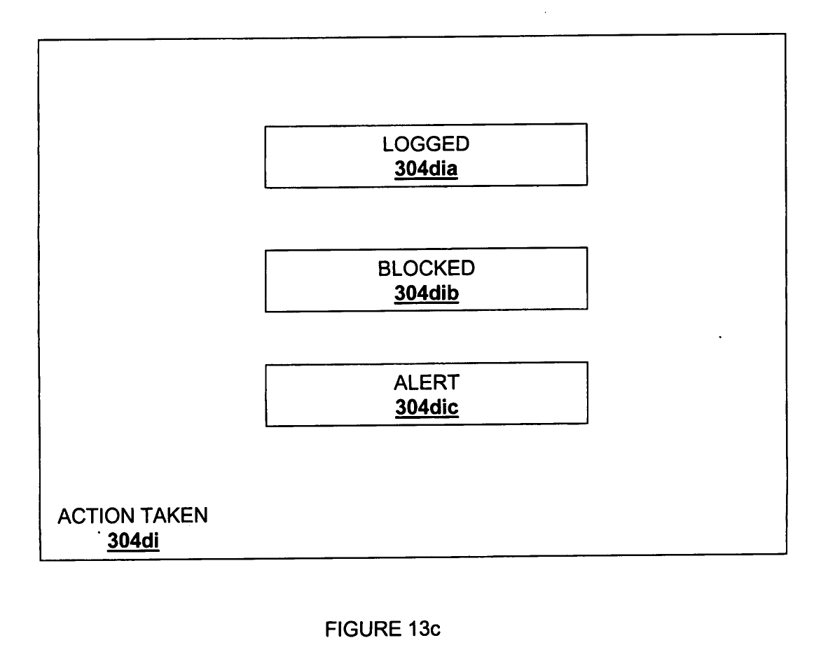

Referring now to FIGS. 13a, 13b, and 13c, an exemplary embodiment of the real time monitor log files database 304d includes a user 304da, a monitored system name 304db, one or more processes 304dc, one or more applications accessed 304dd, one or more files accessed 304de, one or more directories accessed 304df, a date/time of access 304dg, an access type 304dh, and an action taken 304di. In an exemplary embodiment, as illustrated in FIG. 13b, the access type 304dh includes rename 304dha and open 304dhb. In several exemplary embodiments, the rename 304dha is an indication that a user has renamed a file on the monitored system 108. In several exemplary embodiments, the open 304dhb is an indication that an access attempt was made on a file on the monitored system 108. In an exemplary embodiment, as illustrated in FIG. 13c, the action taken 304di includes a logging action 304dia, a blocking action 304dib, and an alert action 304dic. In several exemplary embodiments, the logging action 304dia is a log made of an access attempt and whether the access attempt was blocked or allowed on the monitored system 108. In several exemplary embodiments, the blocking action 304dib is an indication that access was blocked on the monitored system 108. In several exemplary embodiments, the alert action 304dic is an indication that an alert was sent from the monitored system 108.

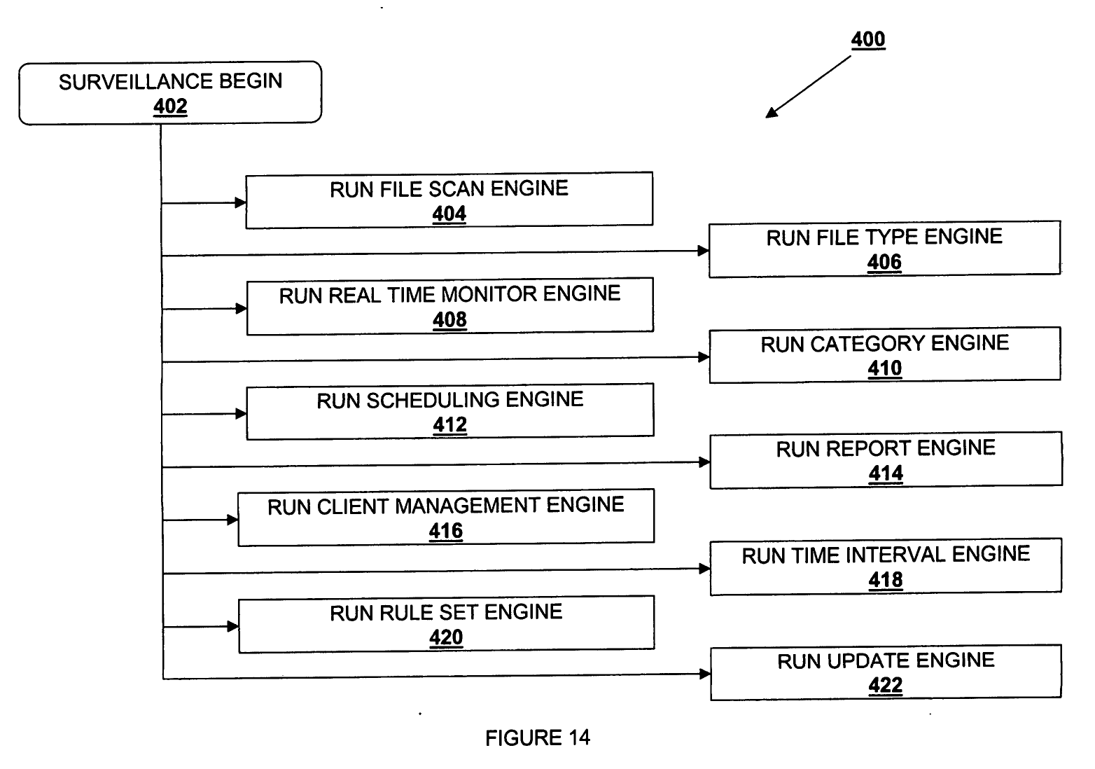

Referring now to FIG. 14, in an exemplary embodiment, the system 100 implements a method of surveilling a computer network 400 in which the surveillance engine 200 begins surveillance in step 402.

After beginning surveillance, the surveillance engine 200 may run the file scan engine in step 404, run the file type engine in step 406, run the real time monitor engine in step 408, run the category engine in step 410, run the scheduling engine in step 412, run the report engine in step 414, run the client management engine in step 416, run the time interval engine in step 418, run the rule set engine in step 420, and run the update engine in step 422.

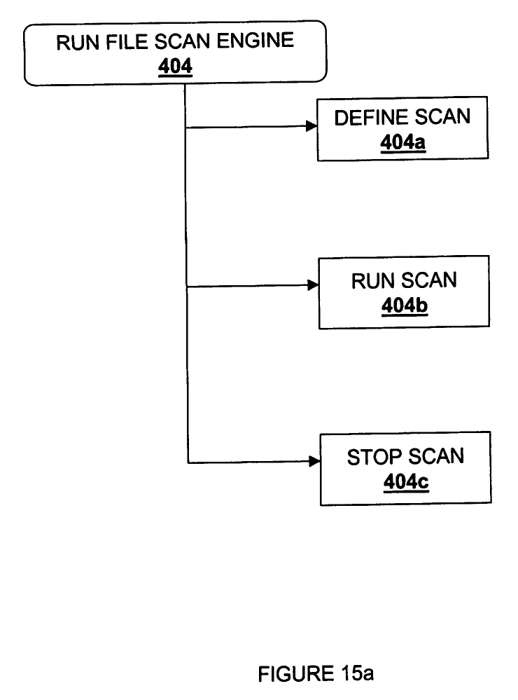

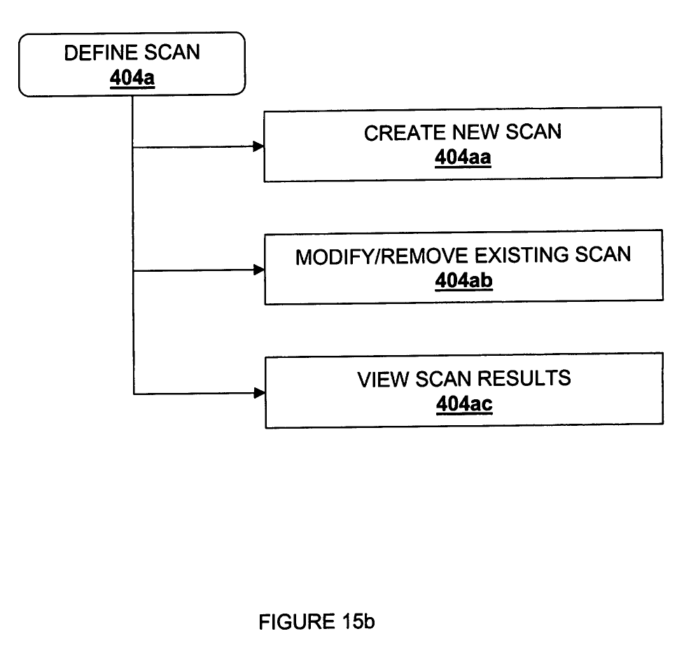

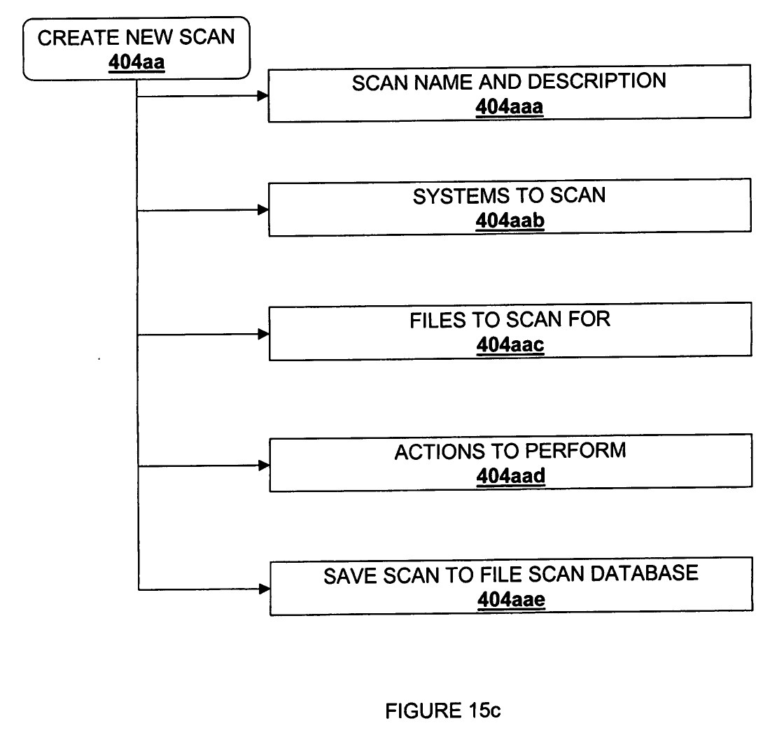

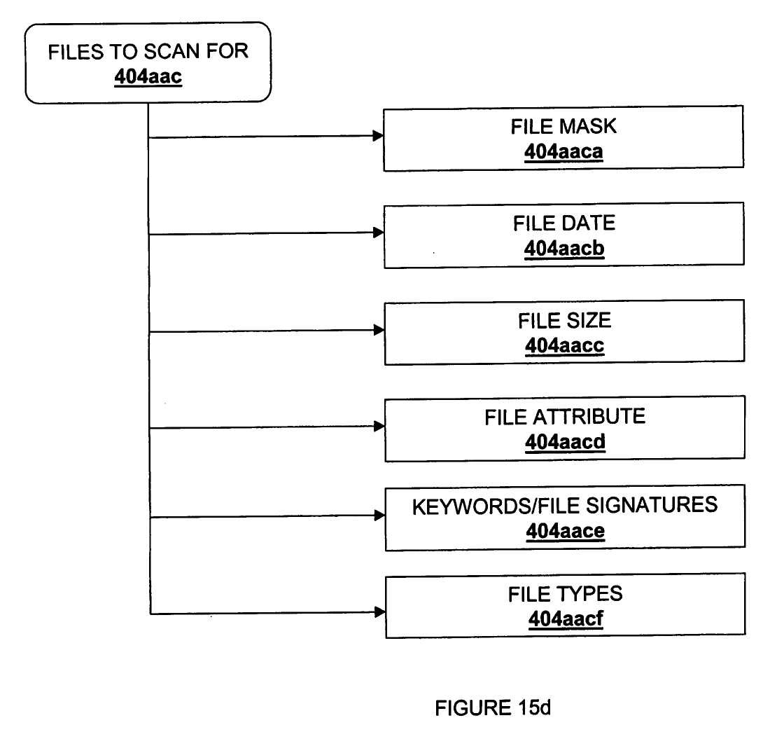

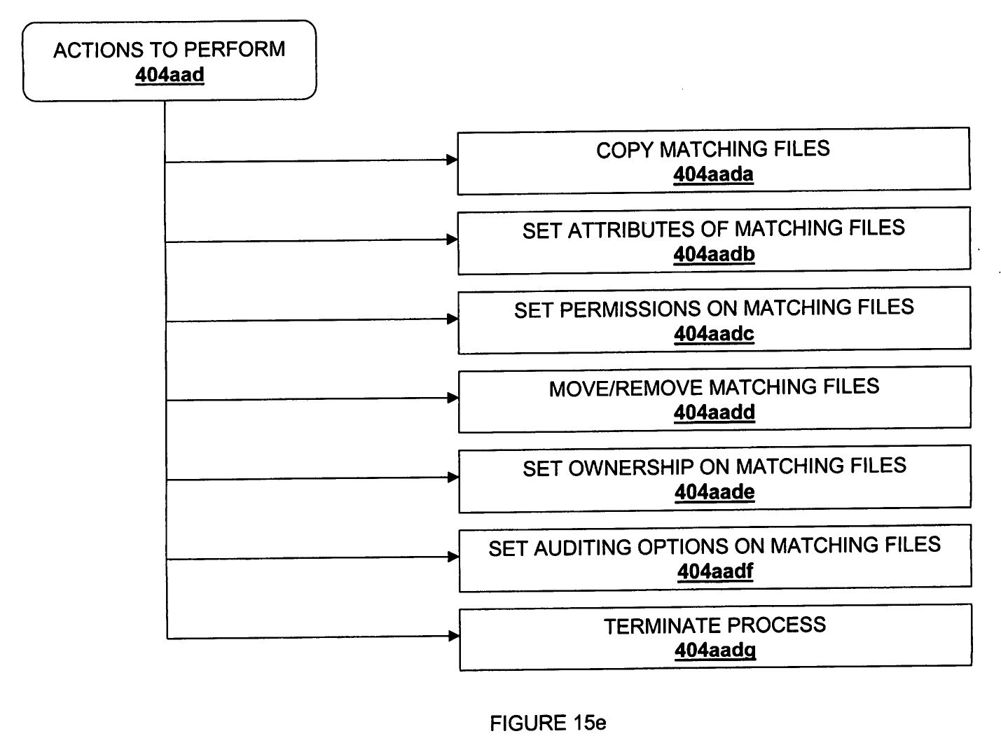

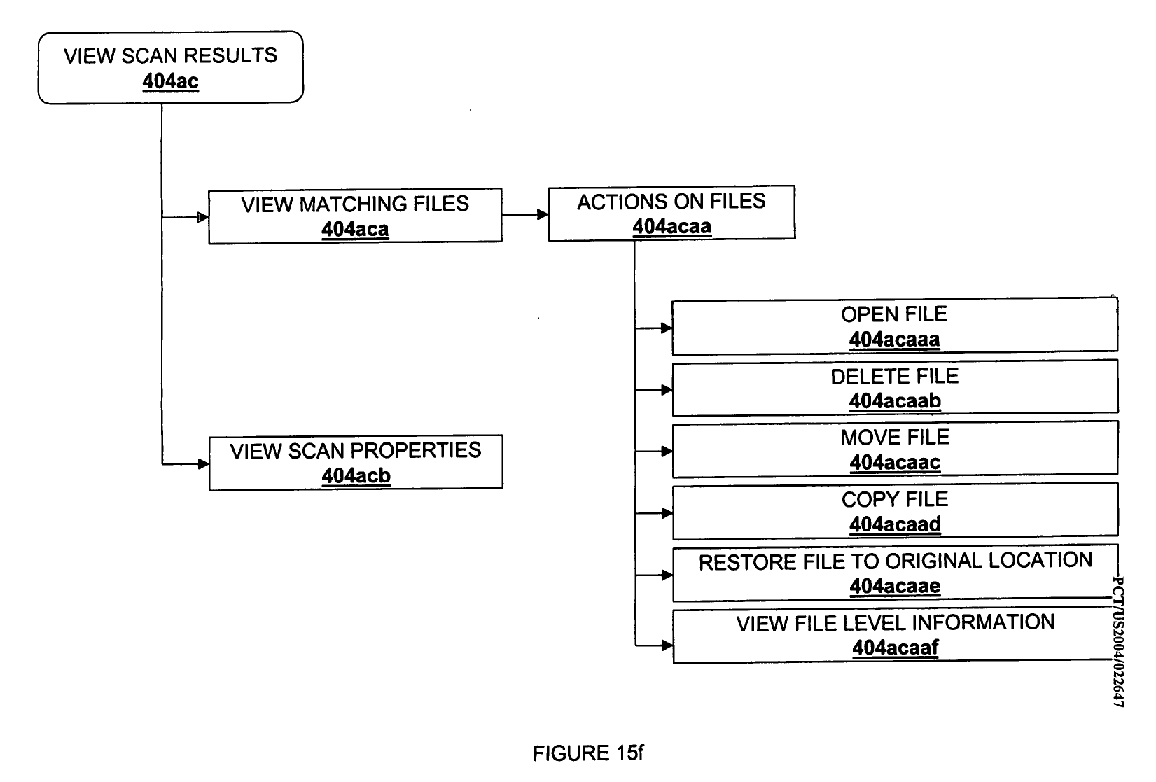

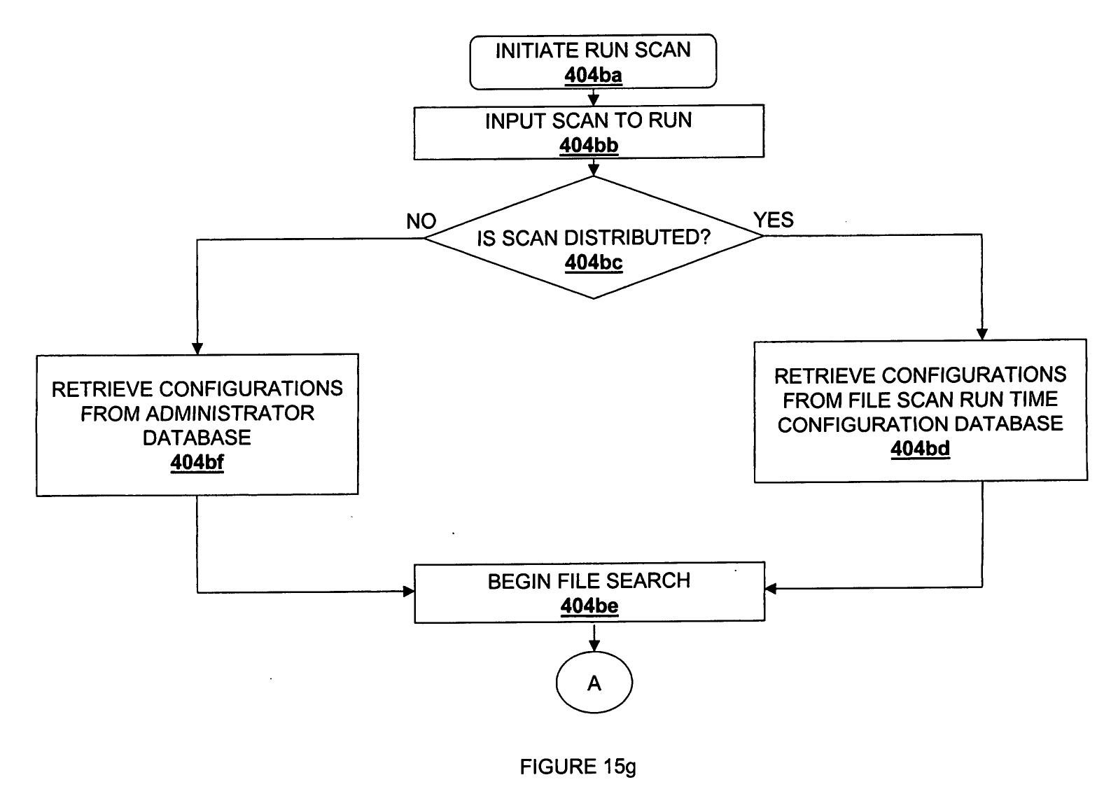

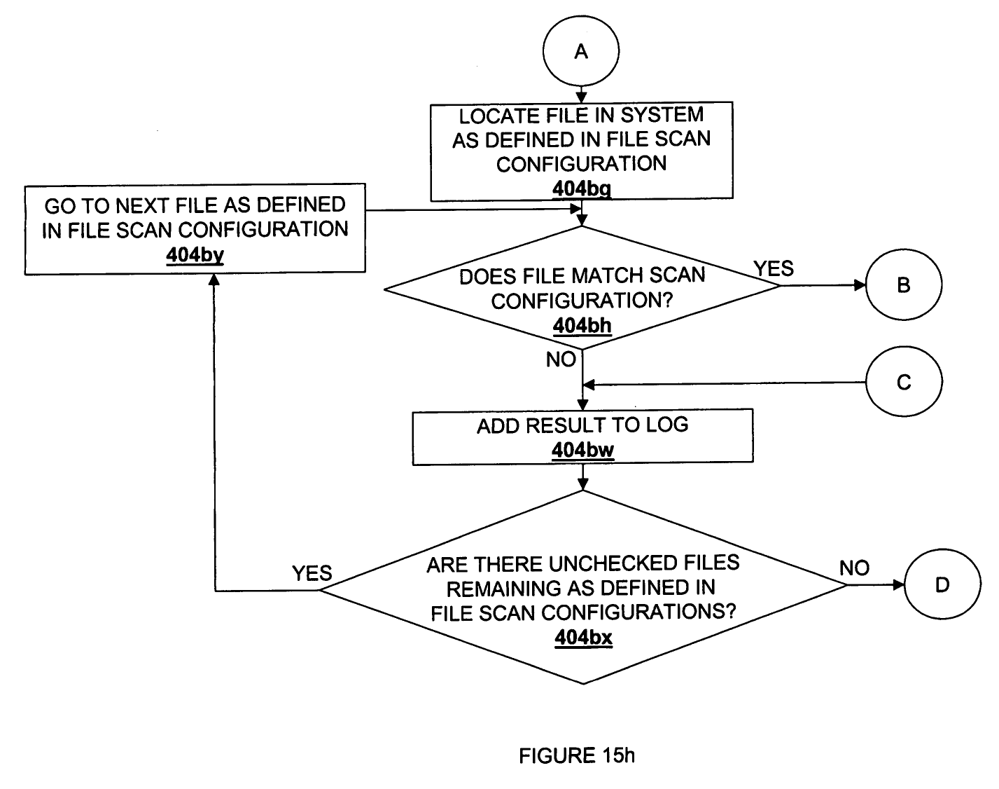

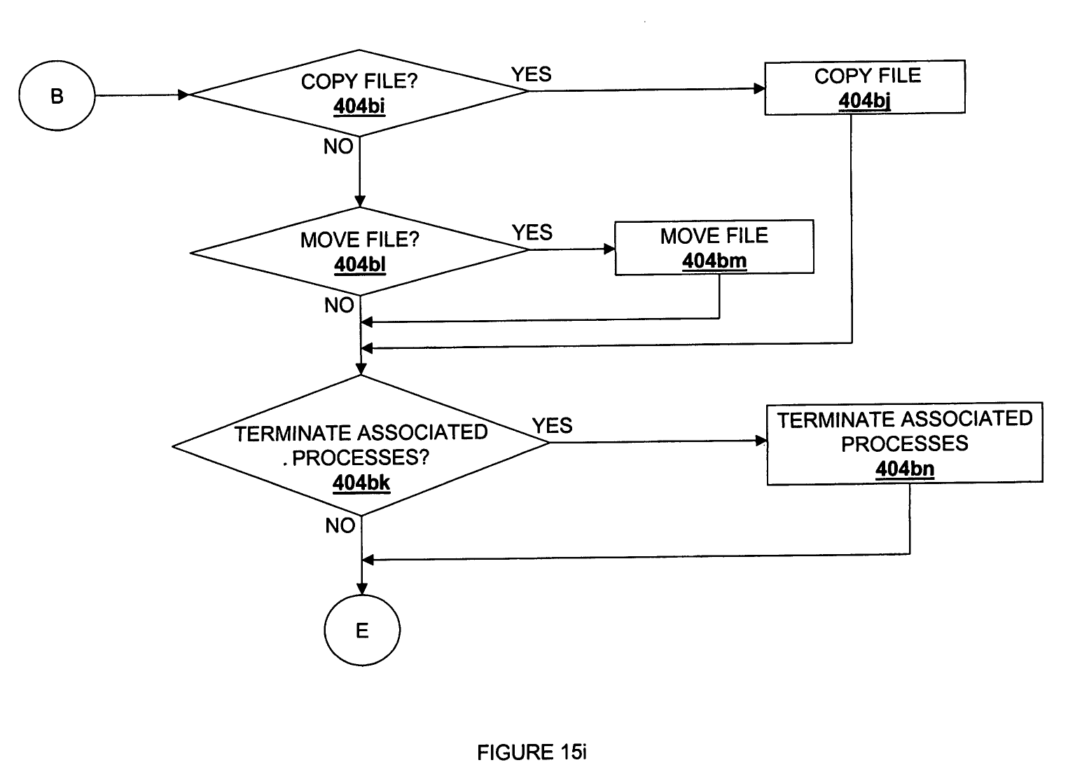

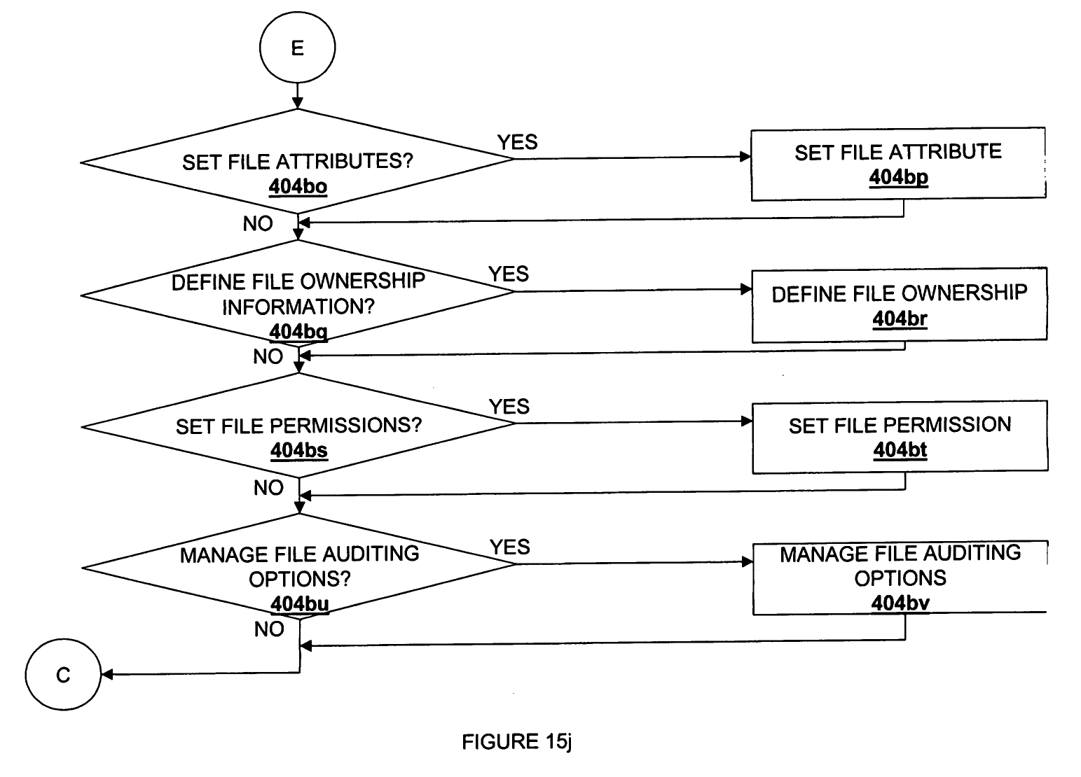

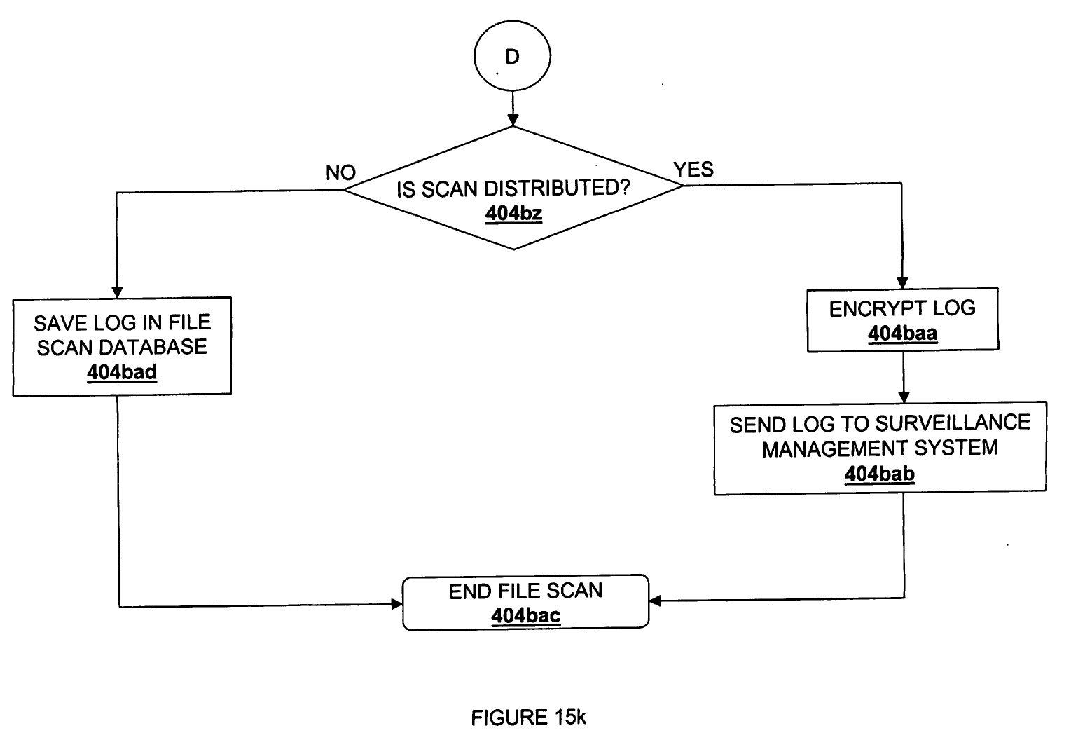

Referring now to FIGS. 15a, 15b, 15c, 15d, 15e, 15f, 15g, 15h, 15i, 15j, and 15k, in an exemplary embodiment, run file scan engine in step 404 allows the selecting of define scan in step 404a, run scan in step 404b, and stop scan in step 404c.

In an exemplary embodiment, as illustrated in FIG. 15b, define scan in step 404a allows creation of a new scan in step 404aa, modifying/removal of an existing scan in step 404ab, and the viewing of scan results in step 404ac. In an exemplary embodiment, as illustrated in FIG. 15c, create new scan in step 404aa allows the selecting of a scan name and description in step 404aaa, systems to scan in step 404aab, files to scan for in step 404aac, actions to perform 404aad, and save scan to file scan database in step 404aae.

In an exemplary embodiment, as illustrated in FIG. 15d, files to scan for in step 404aac allows the selecting of a file mask in step 404aaca, file date in step 404aacb, file size in step 404aacc, file attribute in step 404aacd, keyword/file signature in step 404aace, and file types in step 404aacf. In several exemplary embodiments, file mask in step 404aaca allows the input of all or part of a file name or folder name for use in a file scan. In several exemplary embodiments, file attribute in step 404aacd allows the input of a system property of a file used in a file scan including archive, read-only, hidden, system, temporary, compressed, encrypted, and off-line. In several exemplary embodiments, file types in step 404aacf allows the input of a file extension and/or known file format used in a file scan. In several exemplary embodiments, a keyword in step 404aace is a word or phrase used in a file scan to search for files. In several exemplary embodiments, a file signature in step 404aace is a digital signature that was created for any file, such as a file that contains sensitive or proprietary data, and used in a particular file scan.

In an exemplary embodiment, as illustrated in FIG. 15e, actions to perform in step 404aad allows the selecting of copy matching files in step 404aada, set attributes of matching files in step 404aadb, set permissions on matching files in step 404aadc, move/remove matching files in step 404aadd, set ownership on matching files in step 404aade, set auditing options on matching files in step 404aadf, and terminate process in step 404aadg. In several exemplary embodiments, set attributes of matching files in step 404aadb allows the setting of archive, read-only, hidden, or system on a matching file. In several exemplary embodiments, set ownership on matching files in step 404aade allows the setting of a user owner or a group owner on a matching file. In several exemplary embodiments, set permissions on matching files in step 404aadc the setting of which users and groups can execute, read data, read attributes, read extended attributes, write data, append data, write attributes, write extended attributes, delete, read permissions, change permissions, or take ownership on a matching file. In several exemplary embodiments, set auditing options on matching files in step 404aadf allows the informing of whether a file permission action succeeded or failed for a matching file.

In an exemplary embodiment, as illustrated in FIG. 15f, view scan results in step 404ac allows the selecting of view matching files in step 404aca and view scan properties in step 404acb. In an exemplary embodiment, view matching files in step 404aca allows the selecting of actions on files in step 404acaa. In an exemplary embodiment, actions on files in step 404acaa allows the selecting of open file in step 404acaaa, delete file in step 404acaab, move file in step 404acaac, copy file in step 404acaad, restore file to original location in step 404acaae, and view file level information in step 404acaaf.

In an exemplary embodiment, as illustrated in FIG. 15g, 15h, 15i, and 15j, run scan in step 404b initiates a run scan in step 404ba by the file scan engine 200a, followed by the inputting of a scan to run in step 404bb.

In step 404bc, the surveillance engine 200 determines whether the scan is distributed. In several exemplary embodiments, a distributed scan is a scan which uses the resources of the monitored systems 108 to run the scan. Prior to the distributed scan, the file scan engine 200a accesses the administrator database 212 and retrieves the current file scan configurations 212c, which are copied onto the monitored systems 108 in the file scan run time configurations database 304a. If the scan is distributed, then, in step 404bd, the file scan engine 200a retrieves configurations from the file scan run time configuration database 304a and proceeds to begin the file search in step 404be. In several exemplary embodiments, a non-distributed scan is a scan which uses the resources of the surveillance management system 102 to run the scan. If the scan is not distributed, then, in step 404bf, the file scan engine 200a retrieves configurations from the administrator database 212 and proceeds to begin the file search in step 404be.

Once the file search begins in step 404be, the method proceeds to step 404bg where the file scan engine 200a locates files in the system 100 as defined in the file scan configuration. In step 404bh, the file scan engine 200a determines whether the file matches the scan configuration.

If the file matches the file scan configuration, the file scan engine 200a then checks the file scan configuration for whether to copy the file in step 404bi. If the file scan configuration says to copy the file, the file is copied in step 404bj. In several exemplary embodiments, the file may be copied to the file quarantine system 110 coupled to the surveillance management system 102, illustrated in FIG. 1b. The method then proceeds to step 404bk to determine whether to terminate associated processes. If the file scan configuration says to not copy the file, the file scan engine 200a checks the file scan configuration for whether to move the file in step 404bl. If the file scan configuration says to move the file, the file is moved in step 404bm. In several exemplary embodiments, the file may be moved to the file quarantine system 110 illustrated in FIG. 1b. The method then proceeds to step 404bk to determine whether to terminate associated processes. If the file scan configuration says to not move the file, the method proceeds to step 404bk to determine whether to terminate associated processes.

At step 404bk, the file scan engine 200a checks the file scan configuration to determine whether to terminate associated processes. If the file scan configuration says to terminate associated processes, in step 404bn, processes associated with the matching file are terminated. The method then proceeds to step 404bo, where the file scan engine 200a checks the file scan configuration to determine whether to set file attributes. If the file scan configuration says to not terminate associated processes, the method proceeds to step 404bo where the file scan engine 200a checks the file scan configuration to determine whether to set file attributes.

In step 404bo, the file scan engine 200a checks the file scan configuration to determine whether to set file attributes. If the file scan configuration says to set file attributes, in step 404bp, file attributes are set. In several exemplary embodiments, set file attributes is the setting of archive, read-only, hidden, or system on a file in a current file scan. The method then proceeds to step 404bq, where the file scan engine 200a checks the file scan configuration to determine whether to set file ownership information. If the file scan configuration says to not set file attributes, the method proceeds to step 404bq where the file scan engine 200a checks the file scan configuration to determine whether to set file ownership information.

In step 404bq, the file scan engine 200a checks the file scan configuration to determine whether to set file ownership information. If the file scan configuration says to set file ownership information, in step 404br, file ownership information is set. In several exemplary embodiments, set file ownership information is the setting of a user owner or a group owner on a file in a current file scan. The method then proceeds to step 404bs, where the file scan engine 200a checks the file scan configuration to determine whether to set file permissions. If the file scan configuration says to not set file ownership information, the method proceeds to step 404bs where the file scan engine 200a checks the file scan configuration to determine whether to set file permissions.

In step 404bs, the file scan engine 200a checks the file scan configuration to determine whether to set file permissions. If the file scan configuration says to set file permissions, in step 404bt, file permissions are set. In several exemplary embodiments, set file permissions is the setting of which users and groups can execute, read data, read attributes, read extended attributes, write data, append data, write attributes, write extended attributes, delete, read permissions, change permissions, or take ownership on the file performed on a file in a current file scan. The method then proceeds to step 404bu, where the file scan engine 200a checks the file scan configuration to determine whether to manage file auditing options. If the file scan configuration says to not set file permissions, the method proceeds to step 404bu where the file scan engine 200a checks the file scan configuration to determine whether to manage file auditing options.

In step 404bu, the file scan engine 200a checks the file scan configuration to determine whether to manage file auditing options. If the file scan configuration says to manage file auditing options, in step 404bv, file auditing options are managed. In several exemplary embodiments, manage file auditing options manages whether the set file permission succeeded or failed for a current file scan. The method then proceeds to step 404bw, where the file scan engine 200a adds the results of the scan to a log. If the file scan configuration says to not manage file auditing options, the method proceeds to step 404bw where the file scan engine 200a adds the results of the scan to a log. In several exemplary embodiments, in a distributed scan, monitoring data may be saved to the file scan log files database 304c on the monitored system 108 and eventually transferred to the file scans database 206 on the surveillance management system 102. In several exemplary embodiments, in a non-distributed scan, monitoring data may be saved to the file scans database 206 in the surveillance management system 102.

If, in step 404bh, the file scan engine 200a determines that the file does not match the scan configuration, the method proceeds to step 404bws where the file scan engine 200a adds the results of the scan to a log.

The method then proceeds to step 404bx, where the file scan engine determines whether there are unchecked files remaining in the system 100 as defined in the file scan configuration. If there are unchecked files remaining in the system 100, in step 404by, the file scan engine 200a finds the next file as defined in the file scan configuration. The file scan engine 200a then proceeds back to step 404bh to determine whether the file matches the scan configuration.

If the file scan engine 200a determines there are no unchecked files remaining in the system 100, in step 404bz, the file scan engine 200a determines whether the scan is distributed. If the scan is distributed, the log is encrypted in step 404baa and sent to the surveillance management system 102 in step 404bab. The file scan then ends in step 404bac. If the scan is not distributed, in step 404bad, the log is saved in a file scan database, such as file scan database 206a. The file scan then ends in step 404bac.

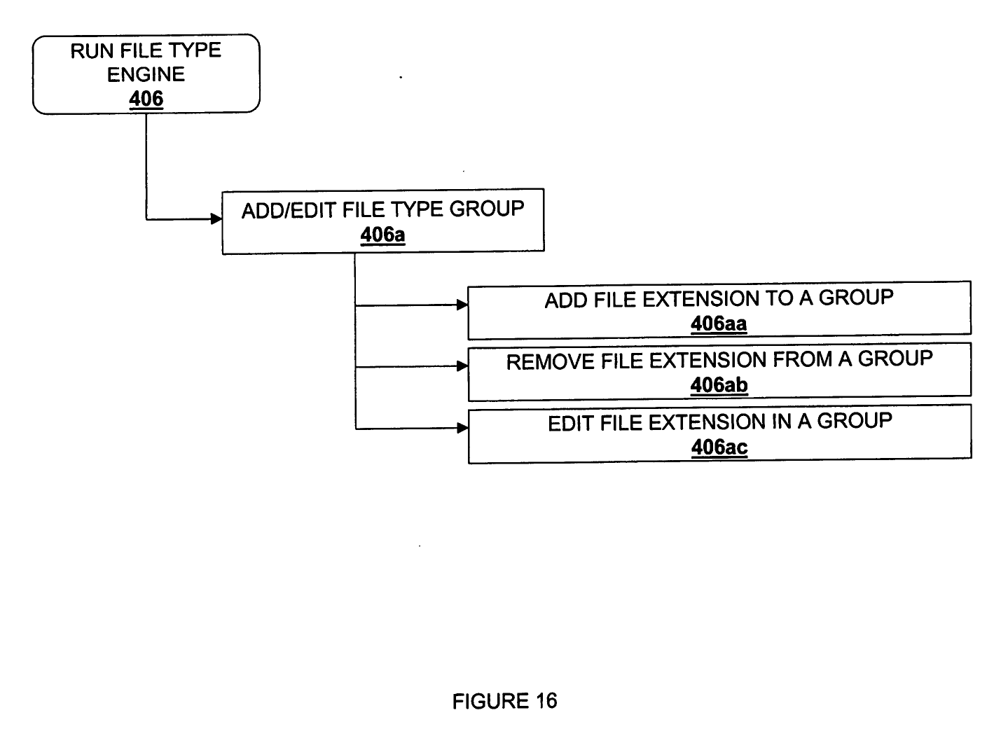

Referring now to FIG. 16, in an exemplary embodiment, run file type engine in step 406 allows the selecting of add/edit file type group in step 406a. In an exemplary embodiment, add/edit file type group in step 406a allows the selecting of add file extension to a group in step 406aa, move file extension from a group in step 406ab, and edit file extension in a group in step 406ac. In several exemplary embodiments, in add/edit file type group in step 406a, file types such as .doc, .xls, .jpeg, and a variety of other file extensions known in the art may be added to or edited in a database, such as in the file type sets 212h in the administrator database 212, as illustrated in FIG. 7a.

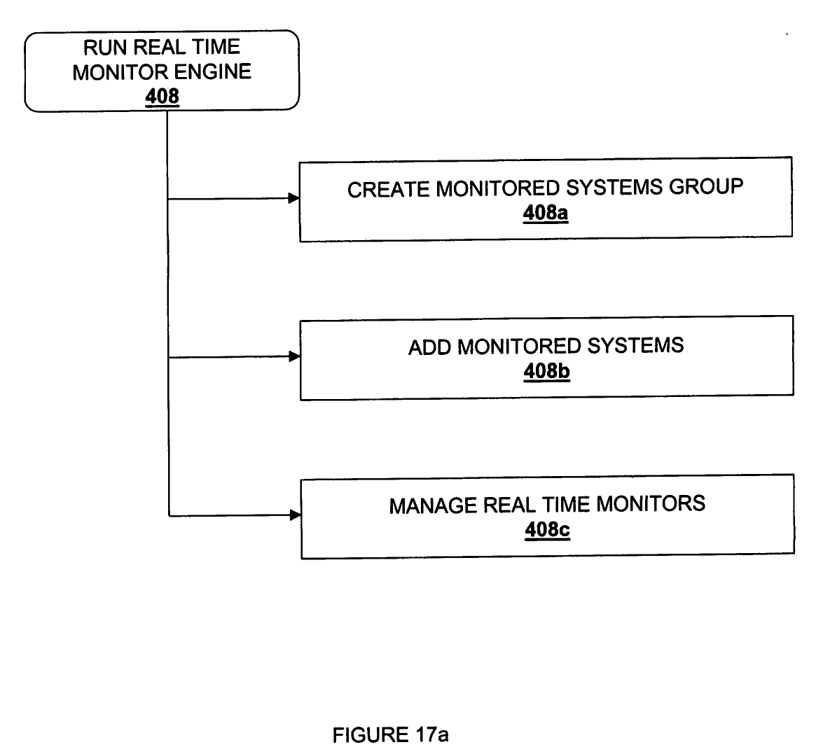

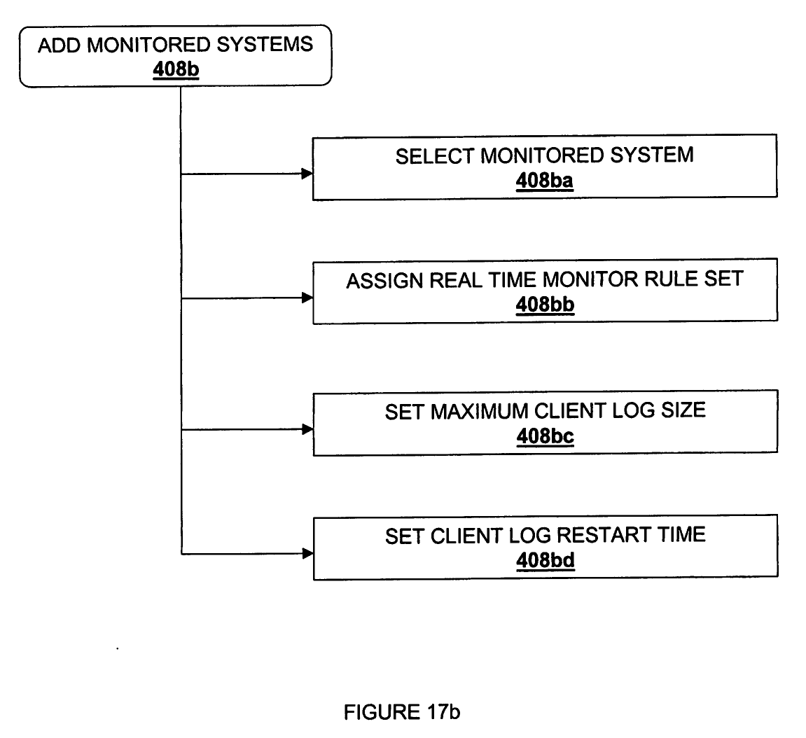

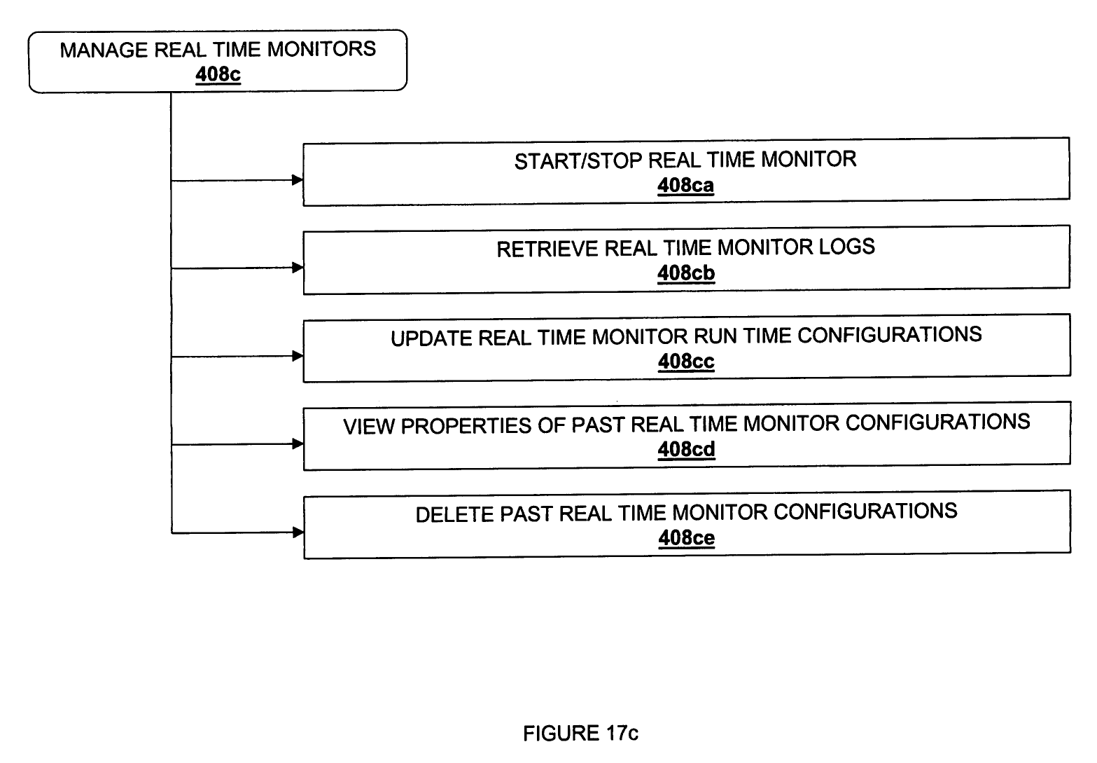

Referring now to FIGS. 17a, 17b, and 17c, in an exemplary embodiment, run real time monitor engine in step 408 allows the selecting of create monitored systems group in step 408a, add monitored systems group in step 408b, and manage real time monitors in step 408c. In an exemplary embodiment, as illustrated in FIG. 17b, add monitored systems group in step 408b allows the selecting of select monitored system in step 408ba, assign real time monitor rule set in step 408bb, set maximum client log size in step 408bc, and set client log restart time in step 408bd. In an exemplary embodiment, as illustrated in FIG. 17c, manage real time monitors in step 408c allows the selecting of start/stop real time monitor in step 408ca, retrieve real time monitor logs in step 408cb, update real time monitor run time configurations in step 408cc, view properties of past real time monitor configurations in step 408cd, and delete past real time monitor configurations in step 408ce.

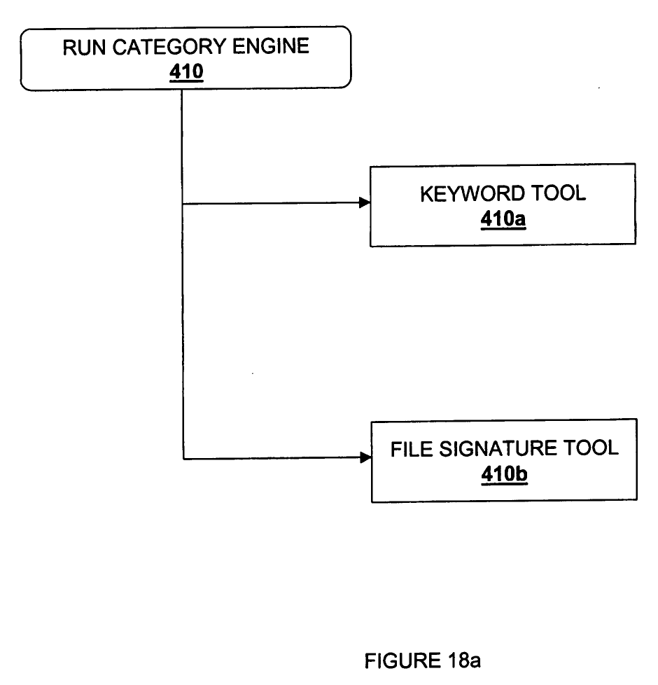

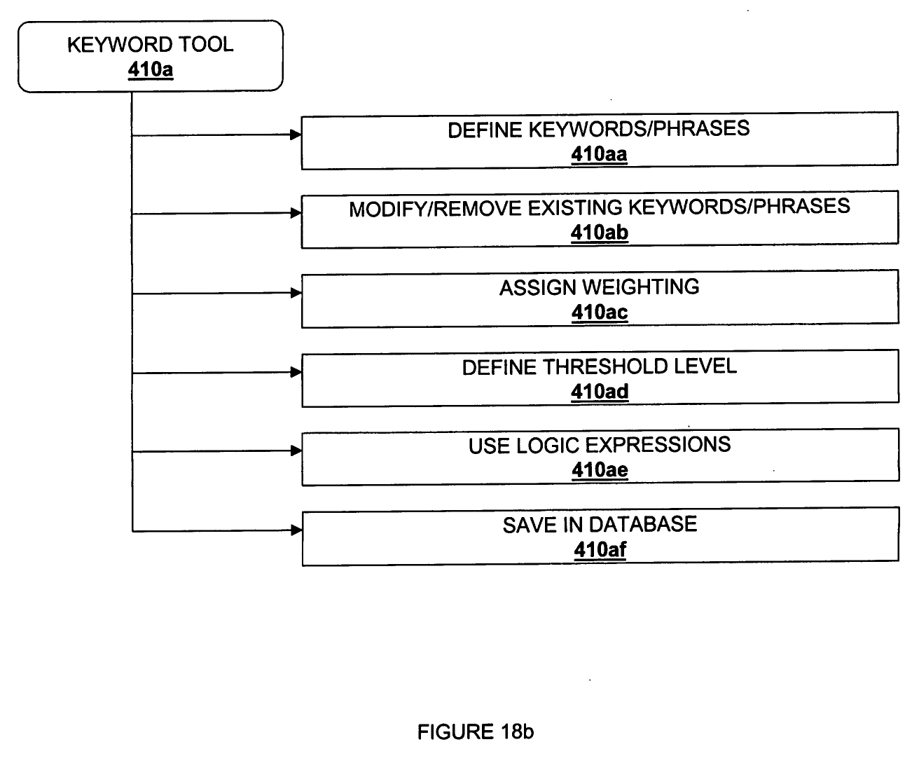

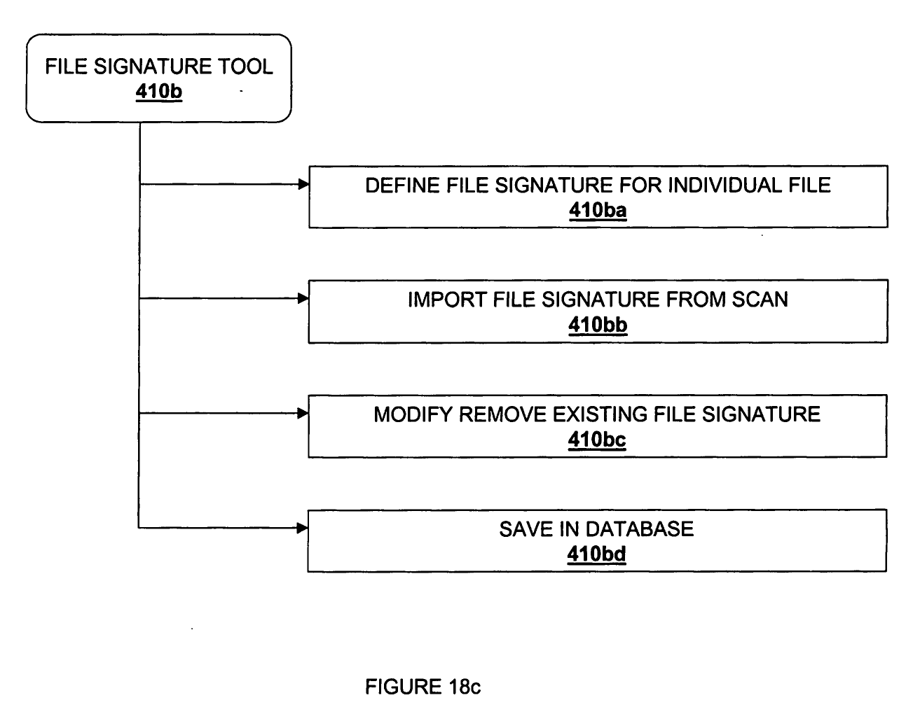

Referring now to FIG. 18, in an exemplary embodiment, run category engine in step 410 allows the selecting of keyword tool in step 410a and file signature tool in step 410b. In several exemplary embodiments, keyword tool in step 410a allows the defining of keywords and phrases and assigning of a weighting to them which helps to determine how many appearances the keyword must make in a file to result in the match. A threshold level for each category may be assigned which determines the total weight value needed for keywords in a file in order to have a match. In several exemplary embodiments, file signature tool in step 410b allows the defining of a digital signature for a file or group of files that can be used to identify the content of a file using a mathematical algorithm. In an exemplary embodiment, as illustrated in FIG. 18b, keyword tool in step 410a allows the selecting of define keywords/phrases in step 410aa, modify/remove existing keywords/phrases in step 410ab, assign weighting in step 410ac, define threshold level in step 410ad, use logic expressions in step 410ae, and save in database in step 410af. In several exemplary embodiments, define threshold level in step 410ad allows the setting of a threshold value over which keyword weights, which may be set in assign weighting in step 410ac, must reach before a file match occurs. In several exemplary embodiments, use logic expressions in step 410ae allows the use of logic expressions such as AND, OR, NOT, and a variety of other logic expressions known it the art, to associate keywords together. In an exemplary embodiment, as illustrated in FIG. 18c, file signature tool in step 410b allows the selecting of define file signature for individual file in step 410ba, import file signature from a scan in step 410bb, modify/remove existing file signature in step 410bc, and save in database in step 410bd.

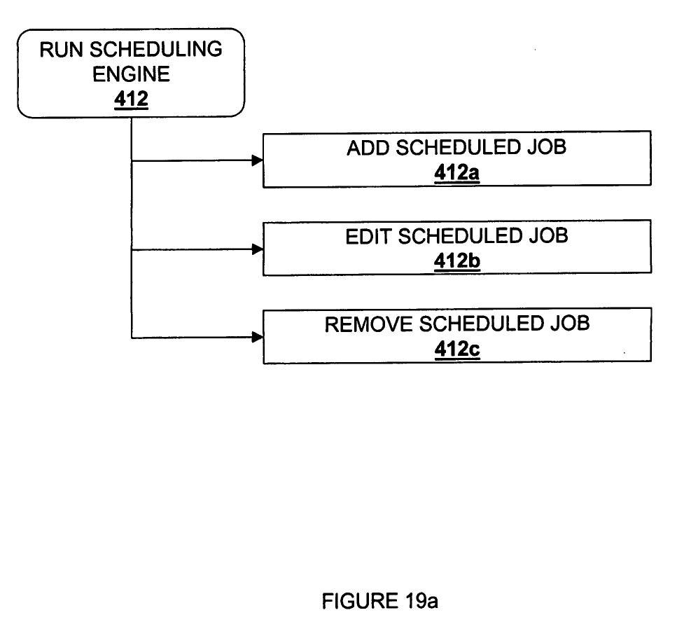

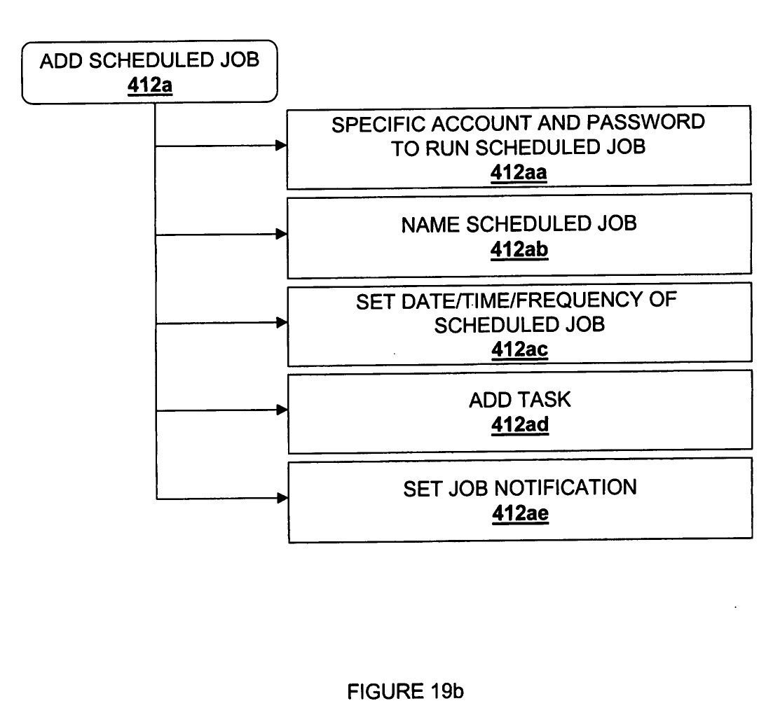

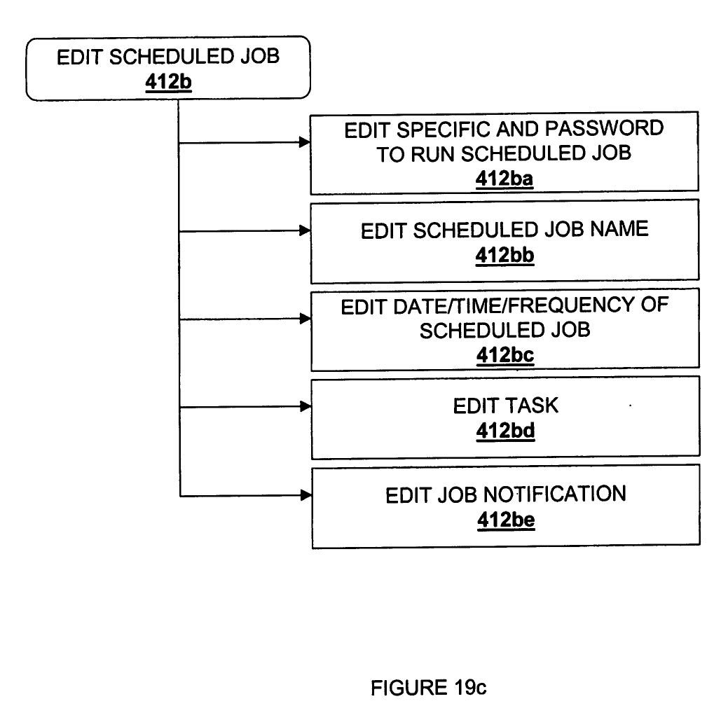

Referring now to FIGS. 19a, 19b, and 19c, in an exemplary embodiment, run scheduling engine in step 412 allows the selecting of add scheduled job in step 412a edit scheduled job in step 412b, and remove scheduled job in step 412c. In an exemplary embodiment, as illustrated in FIG. 19b, add scheduled job in step 412a, allows the selecting of specific account and password to run scheduled job in step 412aa, name scheduled job in step 412ab, set date/time/frequency of scheduled job in step 412ac, add task in step 412ad, and set job notification in step 412ae. In several exemplary embodiments, set job notification in step 412ae allows the instructing of the report engine 200f to send a report when a job is initiated, completed, or aborted. In an exemplary embodiment, as illustrated in FIG. 19c, edit scheduled job in step 412b allows the selecting of edit specific account and password to run scheduled job in step 412ba, edit scheduled job name in step 412bb, edit date/time/frequency of scheduled job in step 412bc, edit task in step 412bd, and edit job notification in step 412be.

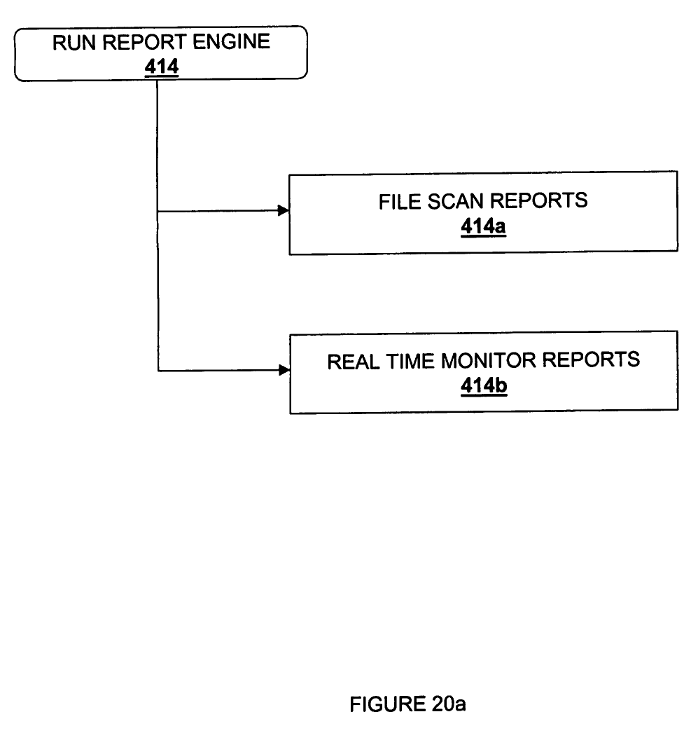

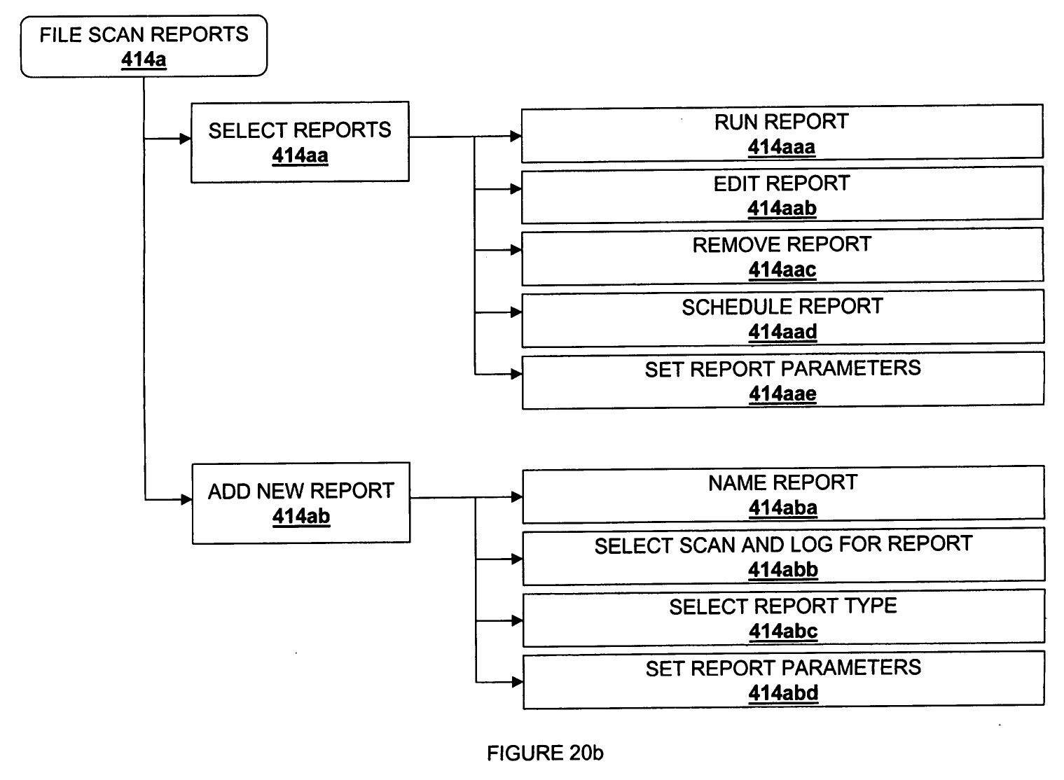

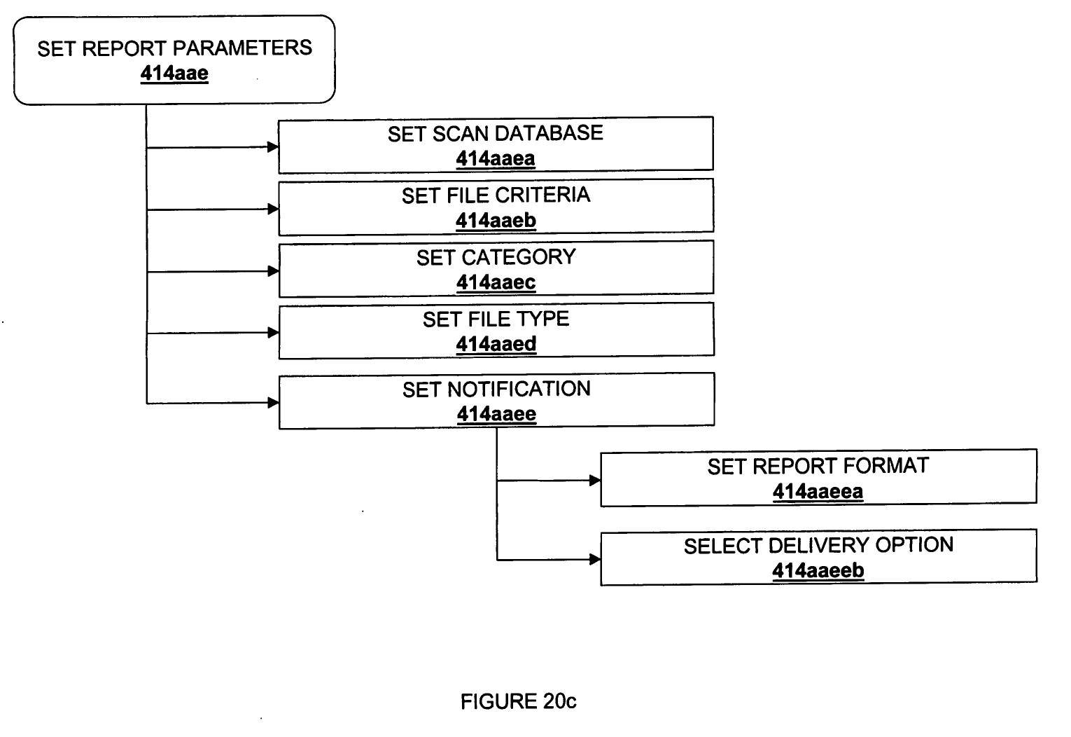

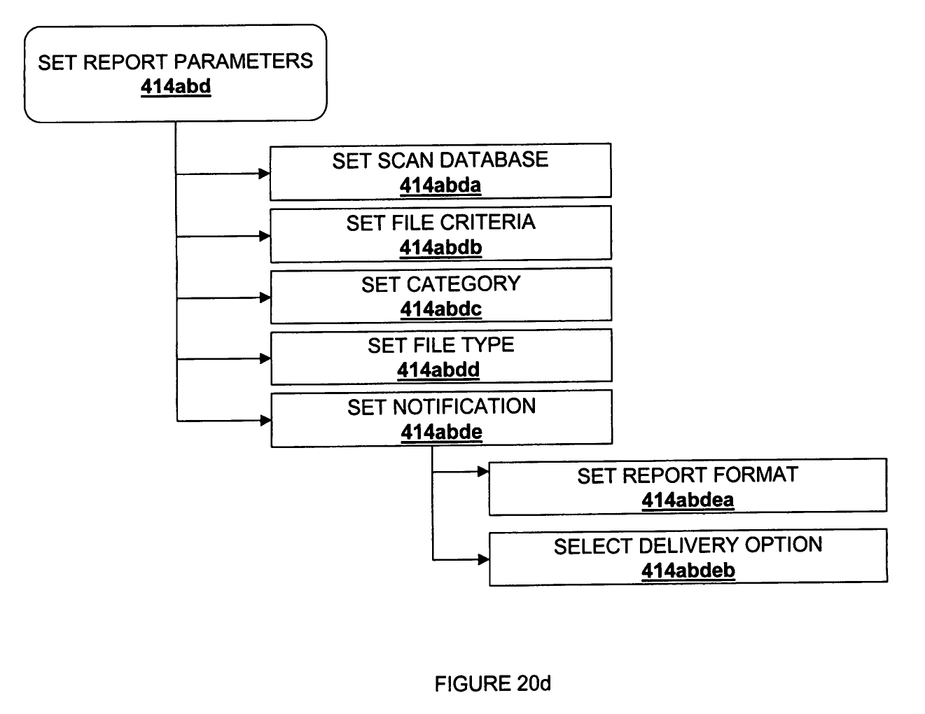

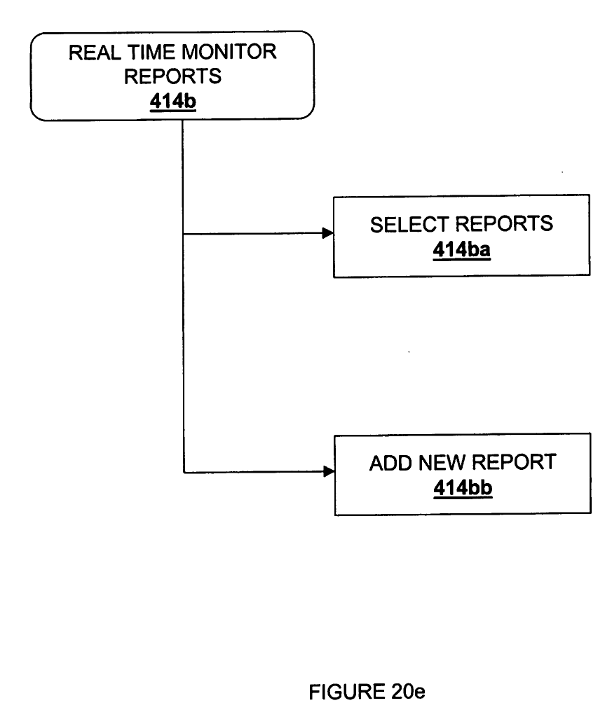

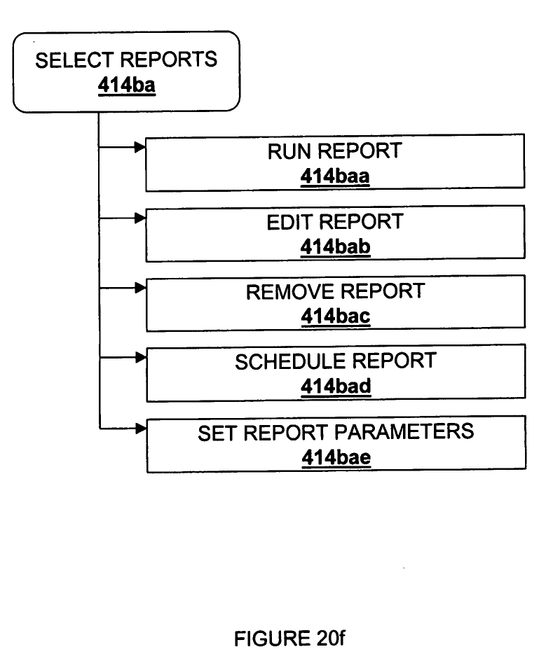

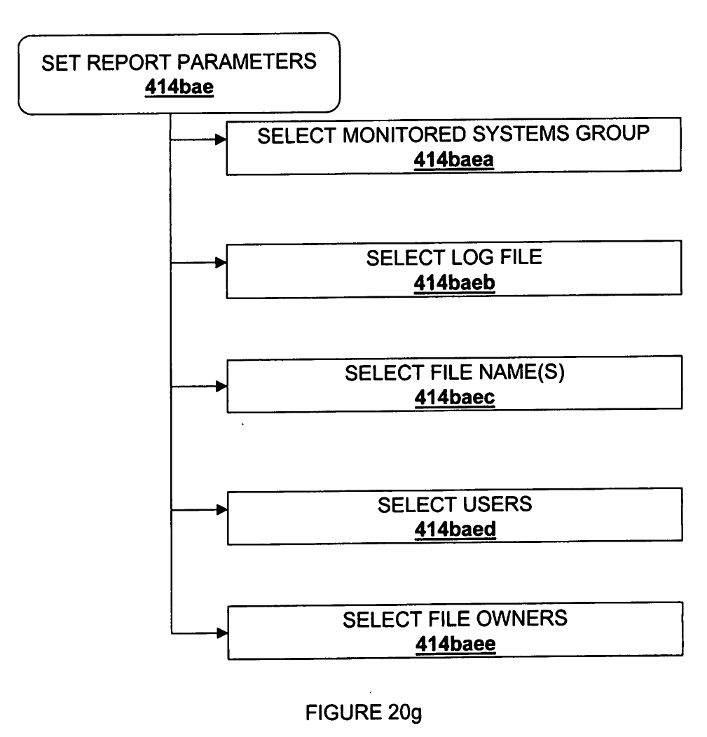

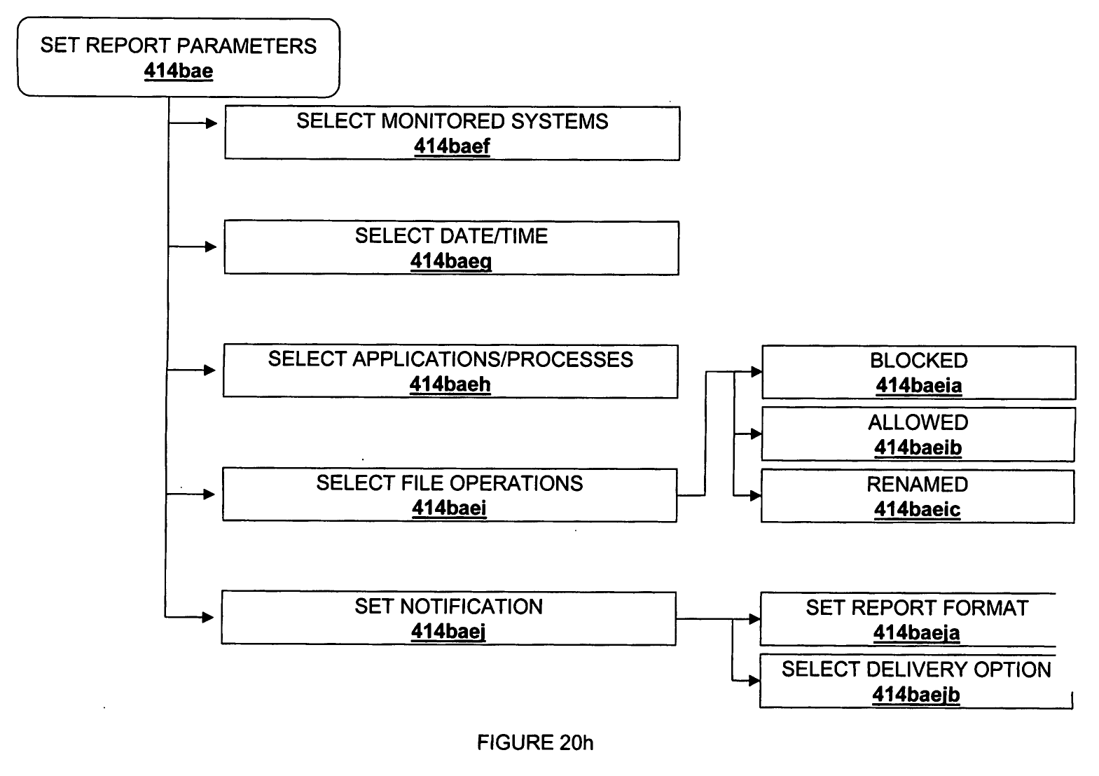

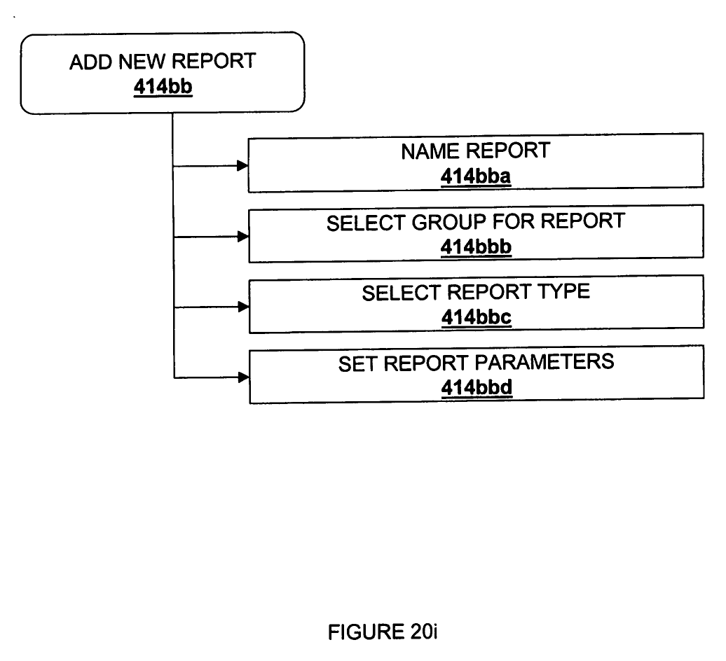

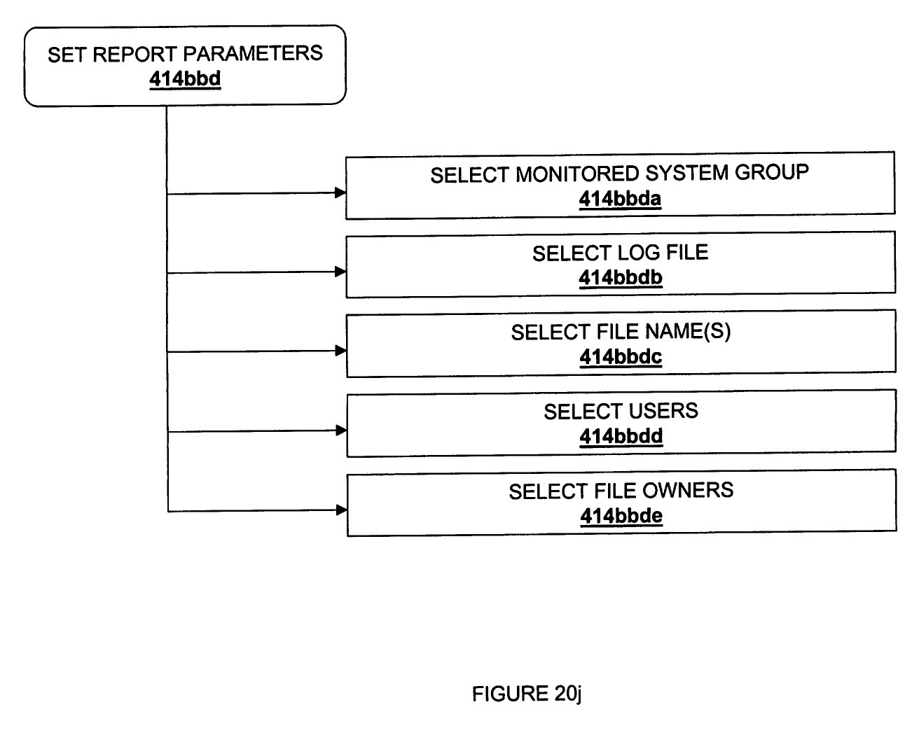

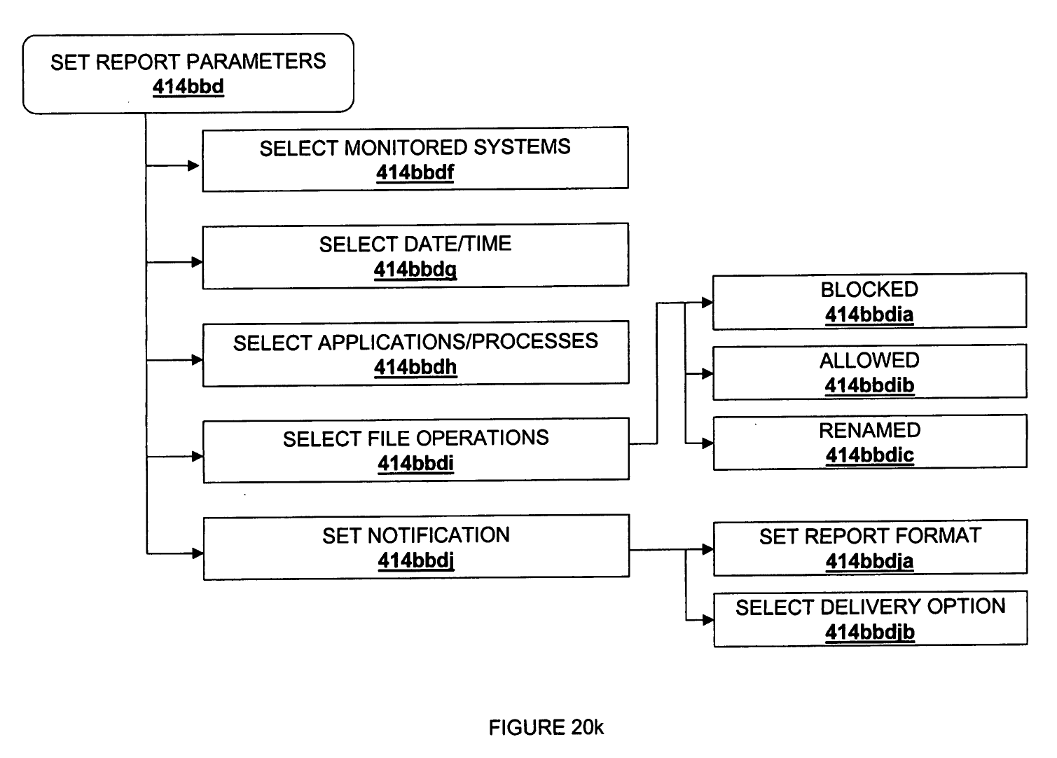

Referring now to FIGS. 20a, 20b, 20c, 20d, 20e, 20f, 20g, 20h, 20i, 20j, and 20k, in an exemplary embodiment, run report engine in step 414 allows the selecting of file scan reports in step 414a and real time monitor reports in step 414b. In several exemplary embodiments, file scan reports in step 414a allows the compiling of reports from the file scan database 206 or the file scan log file database 304c. In several exemplary embodiments, real time monitor reports in step 414b allows the compiling of reports from the real time monitor databases 210 or the real time monitor log file database 304d.

In an exemplary embodiment, as illustrated in FIG. 20b, file scan reports in step 414a allows the selecting of select reports in step 414aa and add new report in step 414ab.

In an exemplary embodiment, select reports in step 414aa allows the selecting of run reports in step 414aaa, edit report in step 414aab, remove report in step 414aac, schedule report in step 414aad, and set report parameters in step 414aae. In an exemplary embodiment, as illustrated in FIG. 20c, set report parameters in step 414aae allows the selecting of set scan database in step 414aaea, set file criteria in step 414aaeb, set category in step 414aaec, set file type in step 414aaed, and set notification in step 414aaee. In an exemplary embodiment, set notification in step 414aaee allows the selecting of set report format in step 414aaeea and select delivery option in step 414aaeeb.

In an exemplary embodiment, add new report in step 414ab allows the selecting of name report in step 414aba, select scan and log for report in step 414abb, select report type in step 414abc, and set report parameters in step 414abd. In an exemplary embodiment, as illustrated in FIG. 20d, set report parameters in step 414abd allows the selecting of set scan database in step 414abda, set file criteria in step 414abdb, set category in step 414abdc, set file type in step 414abdd, and set notification in step 414abde. In an exemplary embodiment, set notification in step 414abde allows the selecting of set report format in step 414abdea and select delivery option in step 414abdeb.

In an exemplary embodiment, as illustrated in FIG. 20e, real time monitor reports in step 414b allows the selecting of select reports in step 414ba and add new report in step 414bb.

In an exemplary embodiment, as illustrated in FIG. 20f, select reports in step 414ba allows the selecting of run report in step 414baa, edit report in step 414bab, remove report in step 414bac, schedule report in step 414bad, and set report parameters in step 414bae. In an exemplary embodiment, as illustrated in FIG. 20g and 20h, set report parameters in step 414bae allows the selecting of select monitored system group in step 414baea, select log file in step 414baeb, select file name(s) in step 414baec, select users in step 414baed, select file owners in step 414baee, select monitored systems in step 414baef, select date/time in step 414baeg, select applications/processes in step 414baeh, select file operations in step 414baei, and select notification in step 414baej. In an exemplary embodiment, select file operations in step 414baei allows the selecting of blocked in step 414baeia, allowed in step 414baeib, and renamed in step 414baeic. In an exemplary embodiment, set notification in step 414baej allows the selecting of set report format in step 414baeja and select delivery option in step 414baejb.

In an exemplary embodiment, as illustrated in FIG. 20i, add new report in step 414bb allows the selecting of name report in step 414bba, select group for report in step 414bbb, select report type in step 414bbc, and set report parameters in step 414bbd. In an exemplary embodiment, as illustrated in FIG. 20j and 20k, set report parameters in step 414bbd allows the selecting of select monitored system group in step 414bbda, select log file in step 414bbdb, select file name(s) in step 414bbdc, select users in step 414bbdd, select file owners in step 414bbde, select monitored systems in step 414bbdf, select date/time in step 414bbdg, select applications/processes in step 414bbdh, select file operations in step 414bbdi, and set notification in step 414bbdj. In an exemplary embodiment, select file operations in step 414bbdi allows the selecting of blocked in step 414bbdia, allowed in step 414bbdib, and renamed in step 414bbdic. In an exemplary embodiment, set notification in step 414bbdj allows the selecting of set report format in step 414bbdja and select delivery option in step 414bbdjb.

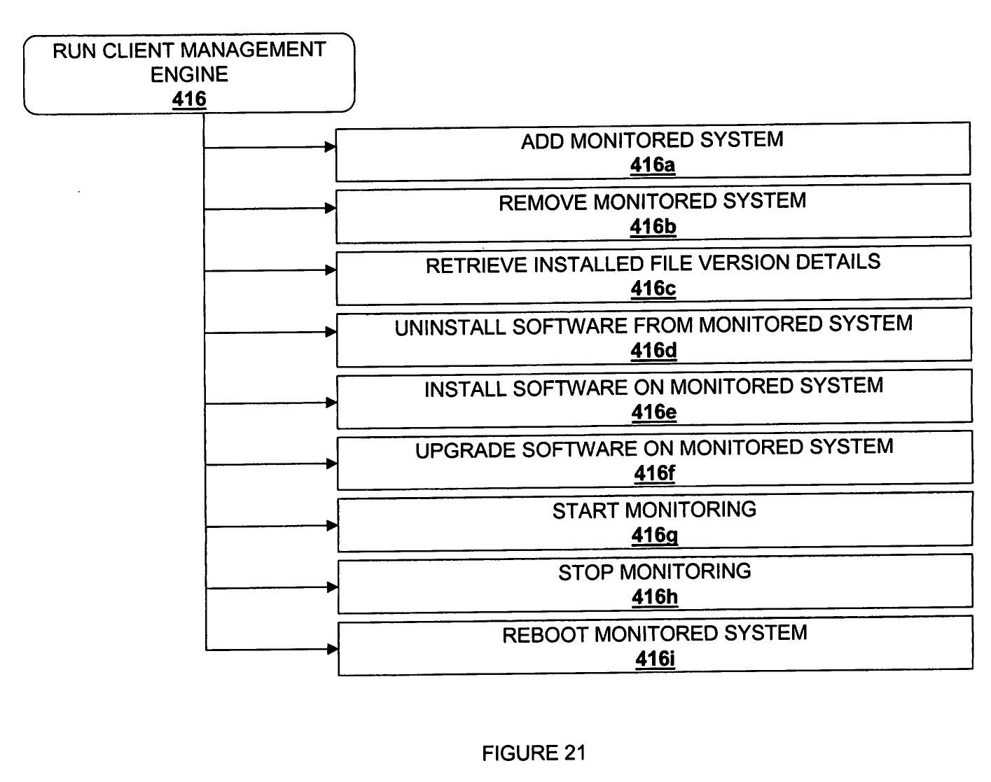

Referring now to FIG. 21, in an exemplary embodiment, run client management engine in step 416 allows the selecting of add monitored system in step 416a, remove monitored system in step 416b, retrieve installed file version details in step 416c, uninstall software from monitored system in step 416d, install software on monitored system 416e, upgrade software on monitored system in step 416f, start monitoring in step 416g, stop monitoring in step 416h, and reboot monitored system in step 416i.

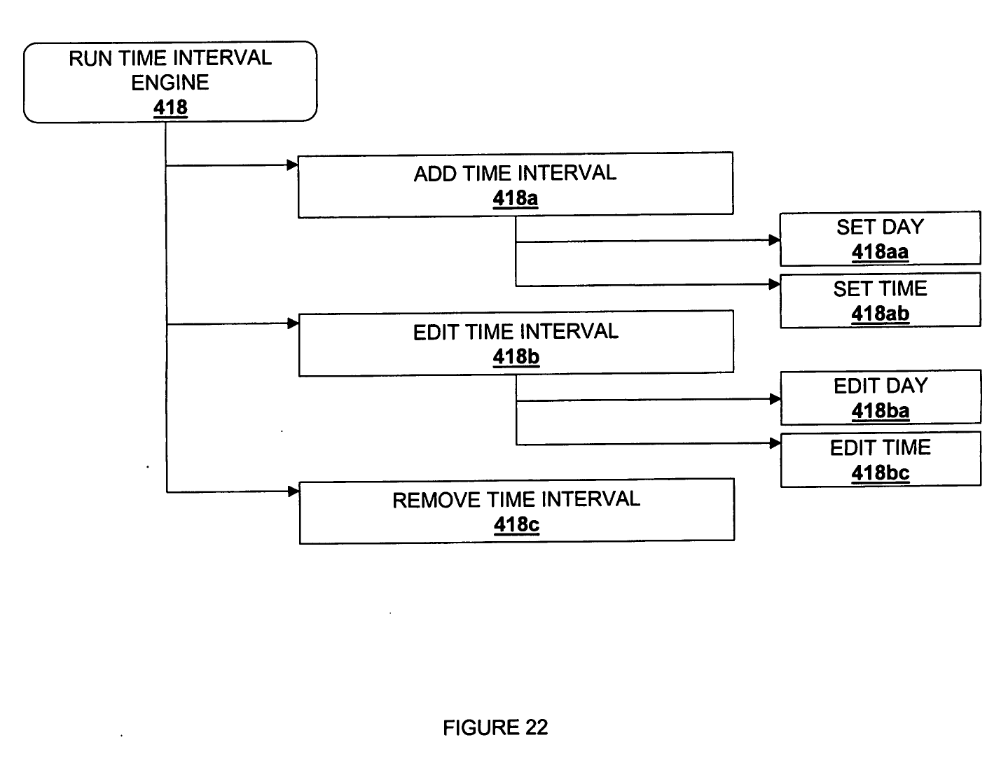

Referring now to FIG. 22, in an exemplary embodiment, run time interval engine in step 418 allows the selecting of add time interval in step 418a, edit time interval in step 418b, and remove time interval in step 418c. In an exemplary embodiment, add time interval in step 418a allows the selecting of set day at step 418aa and set time at step 418ab. In an exemplary embodiment, edit time interval at step 418b allows the selecting of edit day at step 418ba and edit time at step 418bb.

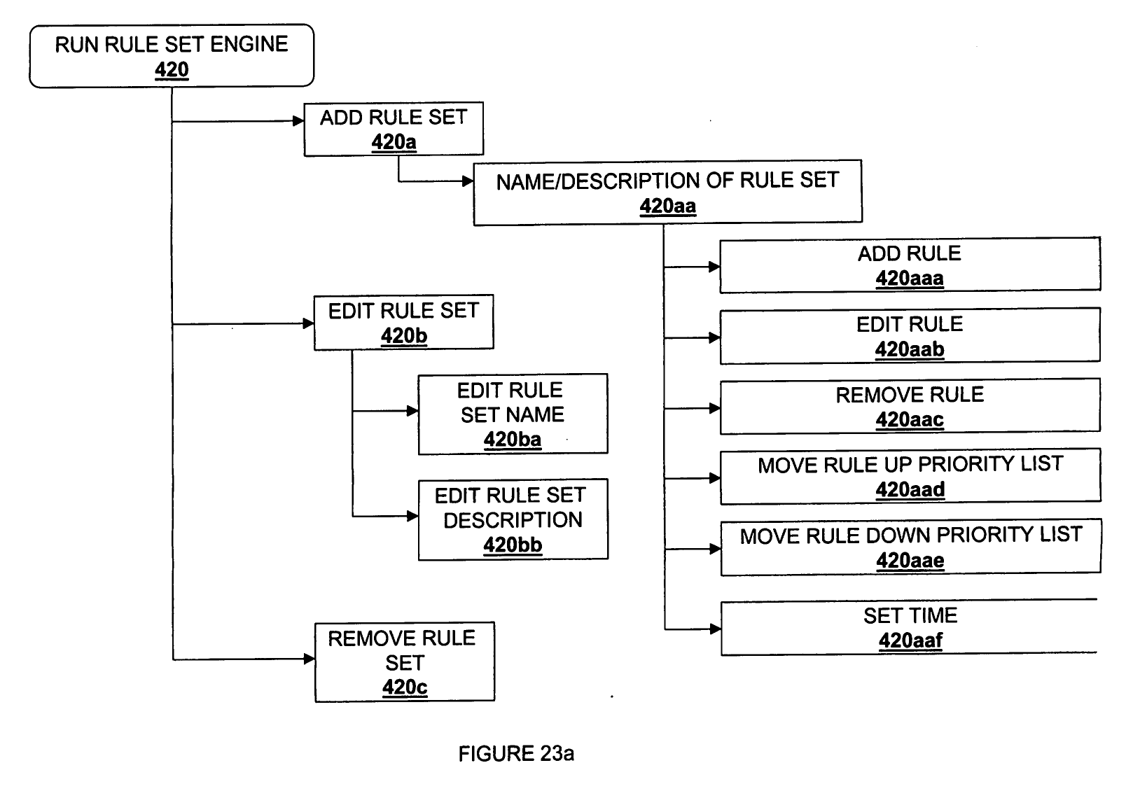

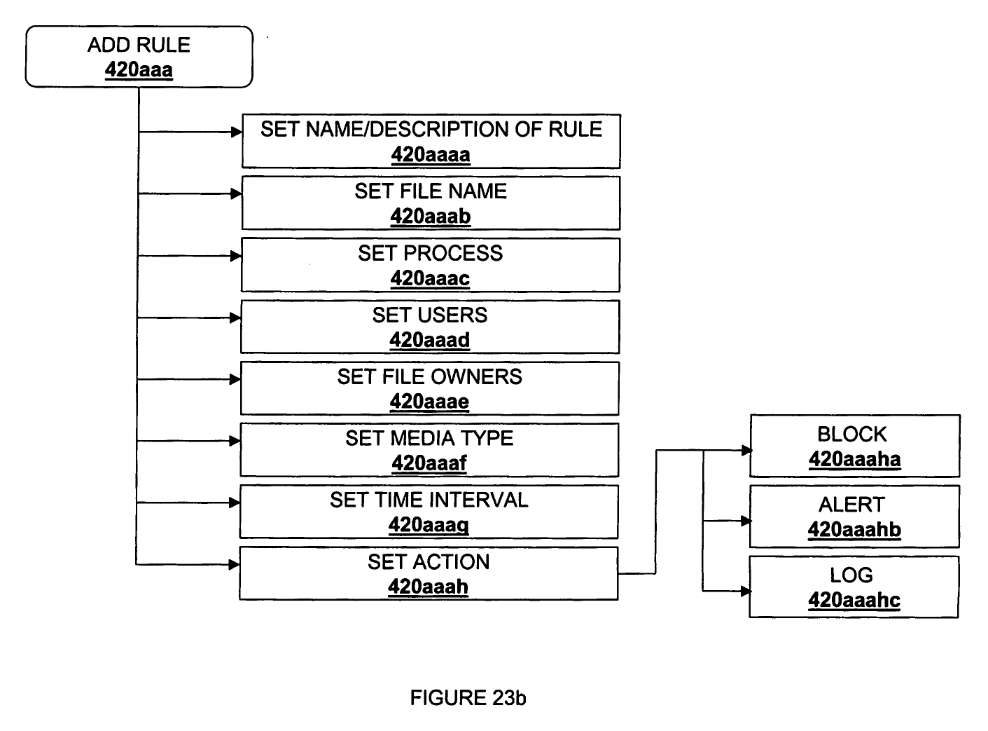

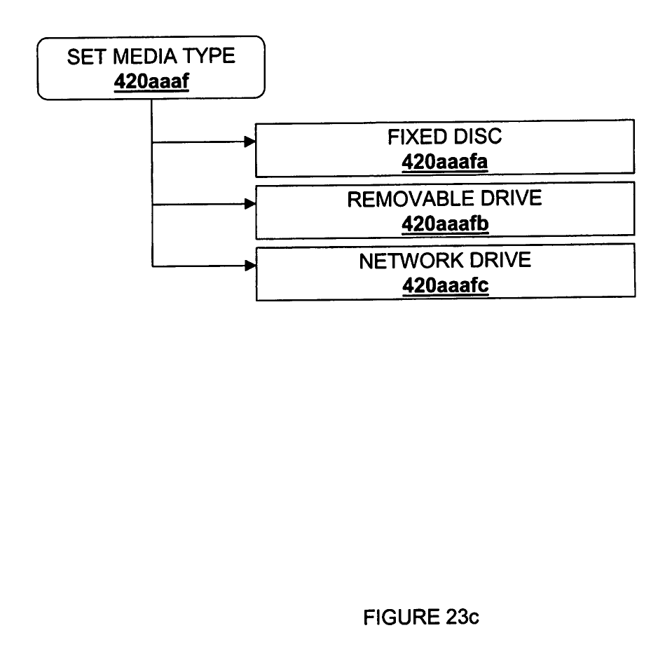

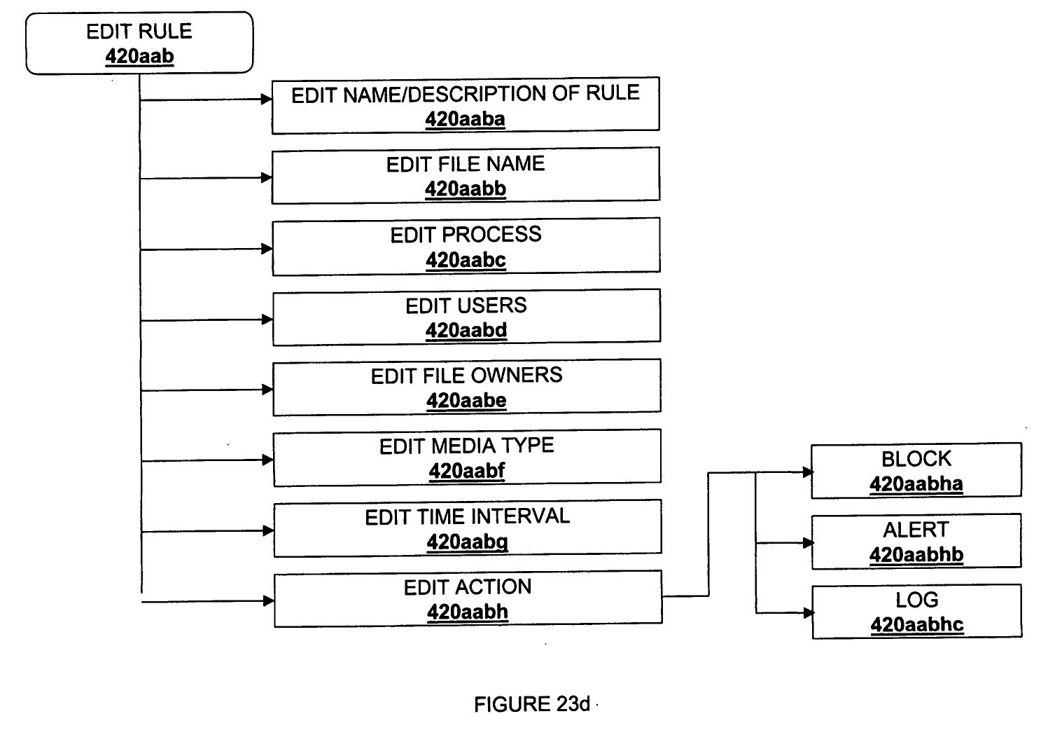

Referring now to FIGS. 23a, 23b, and 23c, in an exemplary embodiment, run rule set engine in step 420 allows the selecting of add rule set in step 420a, edit rule set in step 420b, and remove rule set in step 420c.

In an exemplary embodiment, add rule set in step 420a allows the selecting of name/description of rule set in step 420aa. In an exemplary embodiment, name/description of rule set in step 420aa allows the selecting of add rule in step 420aaa, edit rule in step 420aab, remove rule in step 420aac, move rule up priority list in step 420aad, move rule down priority list in step 420aae, and set time in step 420aaf. In an exemplary embodiment, as illustrated in FIG. 23b, add rule in step 420aaa allows the selecting of set name/description of rule in step 420aaaa, set file name in step 420aaab, set process in step 420aaac, set users in step 420aaad, set file owners in step 420aaae, set media type in step 420aaaf, set time interval in step 420aaag, and set action in step 420aaah. In an exemplary embodiment, set action in step 420aaah allows the selecting of block in step 420aaaha, alert in step 420aaahb, and log in step 420aaahc. In an exemplary embodiment, as illustrated in FIG. 23c, set media type in step 420aaaf allows the selecting of fixed disc in step 420aaafa, removable drive in step 420aaafb, and network drive in step 420aaafc. In an exemplary embodiment, as illustrated in FIG. 23d, edit rule in step 420aab allows the selecting of edit name/description of rule in step 420aaba, edit file name in step 420aabb, edit process in step 420aabc, edit users in step 420aabd, edit file owners in step 420aabe, edit media types in step 420aabf, edit time interval in step 420aabg, and edit action in step 420aabh. In an exemplary embodiment, edit action in step 420aabh allows the selecting of block in step 420aabha, alert in step 420aabhb, and log in step 420aabhc.

In an exemplary embodiment, as illustrated in FIG. 23a, edit rule set in step 420b allows the selecting of edit rule set name in step 420ba and edit rule set description in step 420bb.

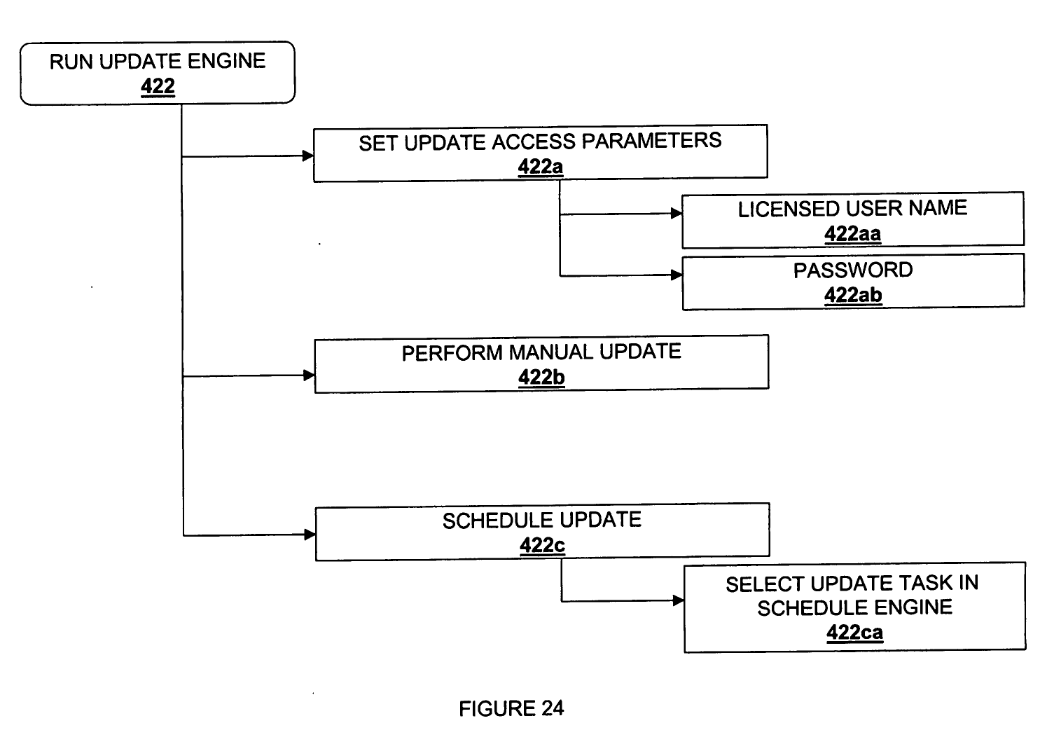

Referring now to FIG. 24, run update engine in step 422 allows the selecting of set update access parameters in step 422a, perform manual update in step 422b, and schedule update in step 422c. In an exemplary embodiment, set update access parameters in step 422a allows the selecting of licensed user name in step 422aa and password in step 422ab. In an exemplary embodiment, schedule update in step 422c allows the selecting of select update task in schedule engine in step 422ca.

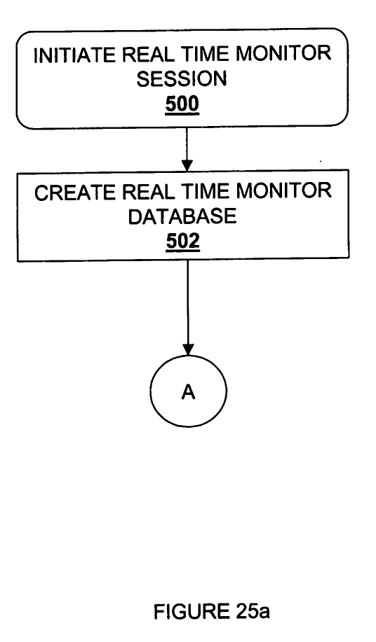

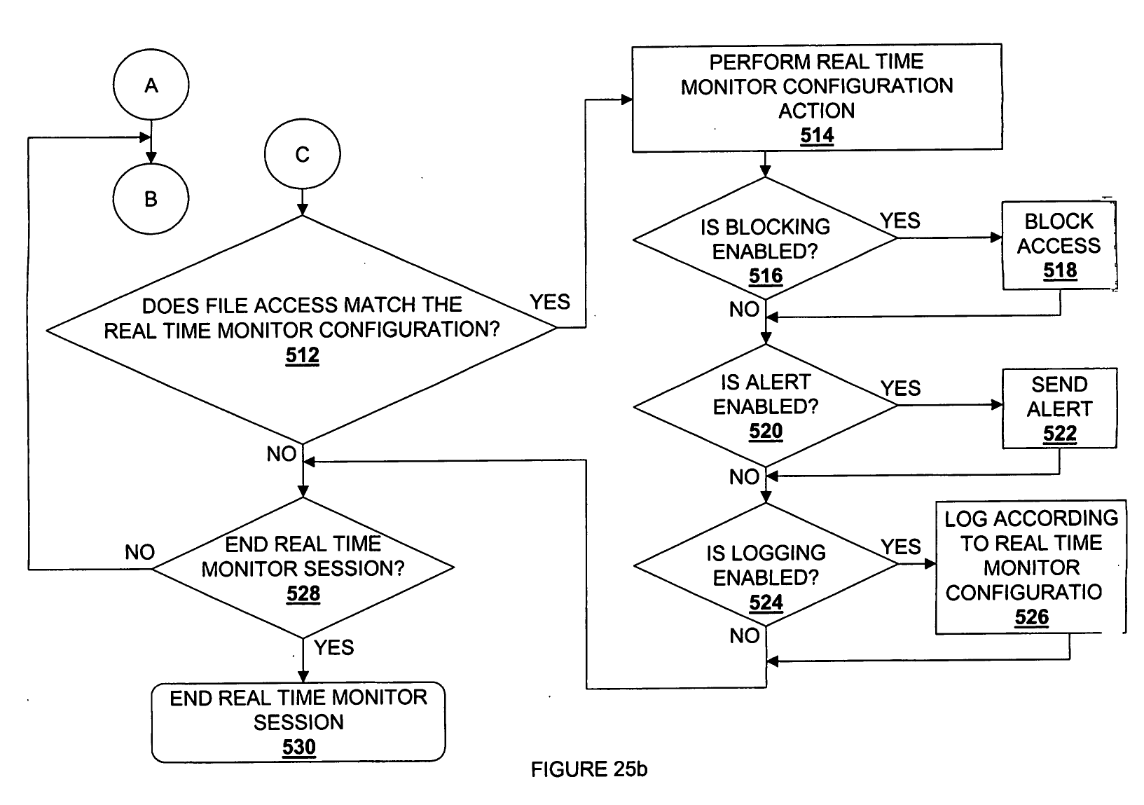

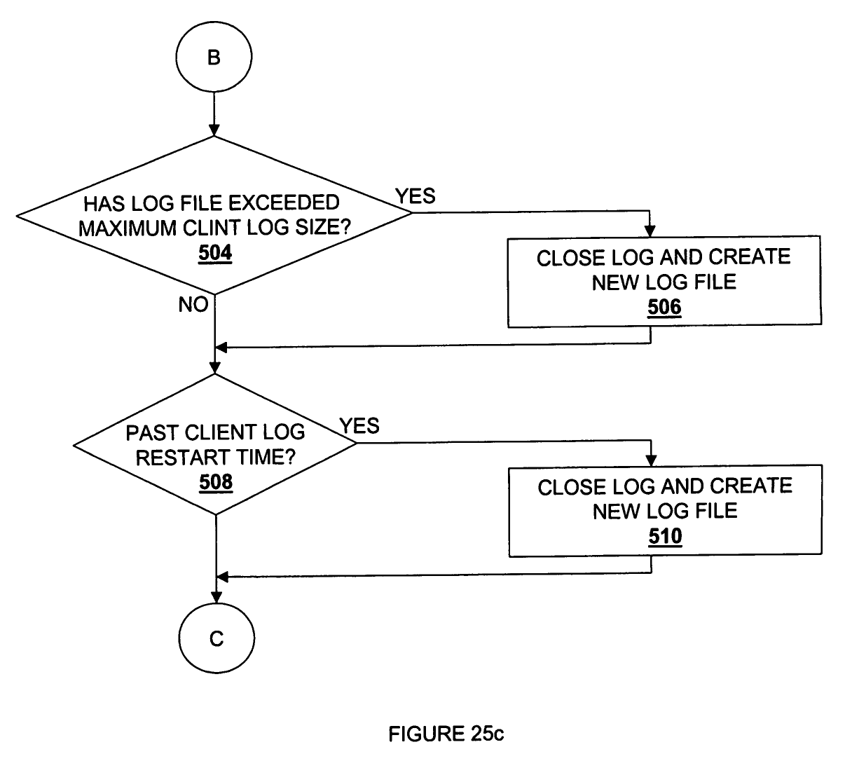

Referring now to FIGS. 25a, 25b, and 25c, in an exemplary embodiment, a real time monitor session may be initiated at step 500 on a monitored system 108. In several exemplary embodiments, a real time monitor session initiates when the real time monitor engine 300 is installed on the monitored system 108 and runs until it is uninstalled or manually stopped. In several exemplary embodiments, the surveillance management system 102 periodically obtains current real time monitor groups 212d from the administrator database 212 and transfers them to the monitored systems 108.

In step 502, a real time monitor database, such as the real time monitor database 210a, 210b, 210c, 210d, 210e, or 210f illustrated in FIG. 6a, is created. In step 504, the real time monitor engine 300 determines whether the log file has exceeded its maximum client log size. If the log file has exceed its maximum client log size, in step 506, the real time monitor engine 300 closes the log and creates a new log file. The method then proceeds to step 508. If the log file has not exceeded its maximum client log size, the method proceeds to step 508.

In step 508, the real time monitor engine 300 determines whether it is past the client log restart time. If it is past the client log restart time, in step 510, the real time monitor engine 300 closes the log and creates a new log file. The method then proceeds to step 512. If it is not past the client log restart time, the method proceeds to step 512.

In step 512, the real time monitor engine 300 determines whether the file access matches the real time monitor configuration.

If, in step 512, the file access matches the real time monitor configuration, the method proceeds to step 514 where the real time monitor engine 300 performs the real time monitor configuration actions. In step 516, the real time monitor engine 300 determines whether blocking is enabled. If blocking is enabled, in step 518, the real time monitor engine 300 blocks access. The method then proceeds to step 520. If blocking is not enabled, the method proceeds to step 520.

In step 520, the real time monitor engine 300 determines whether alert is enabled. If alert is enabled, in step 522, the real time monitor engine 300 sends an alert. The method then proceeds to step 524. If alert is not enabled, the method proceeds to step 524.

In step 524, the real time monitor engine 300 determines whether logging is enabled. If logging is enabled, in step 526, the real time monitor engine 300 logs according to the real time monitor configuration. In several exemplary embodiments, monitoring data is saved in the real time monitor log files database 304d and eventually transferred to the real time monitor databases 210 in the surveillance management system 102. The method then proceeds to step 528. If logging is not enabled, the method proceeds to step 528.

If, in step 512, the file access does not match the real time monitor configuration, the method proceeds to step 528.

In step 528, the real time monitor determines whether it is time to end the real time monitor session. If it is time to end the real time session, in step 530, the real time monitor engine 300 ends the real time monitor session. If it is not time to end the real time monitor session, the method proceeds back to step 504.

In several exemplary embodiments, the term file may refer to a variety of data on a computer network including, but not limited to, files, processes, applications, directories, databases, and registries.

A computer implemented surveillance system has been described that comprises one or more monitored systems operably coupled to a network, and a surveillance management system operably coupled to the network, the surveillance management system operable to identify and manage files on the one or more monitored systems and to control the access to files on the one or more monitored systems. In an exemplary embodiment, a file quarantine system is coupled to the surveillance management system, whereby the surveillance management system is operable to copy and/or move files from the one or more monitored systems and store then on the file quarantine system. In an exemplary embodiment, the surveillance management system comprises one or more surveillance management systems.

A computer implemented surveillance management system has been described that comprises a surveillance engine, the surveillance engine adapted to identify and manage files and control access to files, a user interface operably coupled to the surveillance engine to allow configuration of the surveillance engine, a network interface operably coupled to the surveillance engine to allow the surveillance engine to access a network, and one or more databases operably coupled to the surveillance engine. In an exemplary embodiment, the one or more databases comprise one or more of the following: a file scans database, a scans database, a real time monitor database, and an administrator database.

A computer implemented monitored system has been described that comprises a real time monitor engine adapted to manage and control access to files, a network interface operably coupled to the real time monitor engine to allow the real time monitor engine to access a network, and one or more databases coupled to the real time monitor engine. In an exemplary embodiment, the one or more databases comprise one or more of the following: a file scan run time configuration database, a real time monitor run time configuration database, a file scan log file database, and a real time monitor log file database.

A computer implemented surveillance engine has been described that comprises one or more of the following: a file scan engine, a file type engine, a real time monitor engine, a category engine, a scheduling engine, a report engine, a client management engine, a time interval engine, a rule set engine, and an update engine.

A computer implemented method for file scanning has been described that comprises defining a scan, wherein the defining comprises identifying one or more files to scan for, running the scan, and stopping a scan. In an exemplary embodiment, the defining comprises one or more of the following: creating a new scan, modifying an existing scan, removing an existing scan, and viewing scan results. In an exemplary embodiment, the running comprises: initiating a scan, inputting a scan to run, retrieving a scan configuration, scanning one or more files, matching a file to the scan configuration, performing an action on the matching file, creating a log, and transferring the log.

A computer implemented method of real time monitoring has been described that comprises one or more of the following: creating a monitored systems group, adding one or more monitored systems to the monitored systems group, and managing a real time monitor. In an exemplary embodiment, the adding comprises: selecting a monitored system, assigning a real time monitor rule set, setting a maximum client log size, and setting a client log restart time. In an exemplary embodiment, the managing comprises one or more of the following: starting a real time monitor, stopping a real time monitor, retrieving a real time monitor log, updating a real time monitor run time configuration, viewing properties of a past real time monitor configuration, and deleting a past real time monitor configuration.

A computer implemented method for managing keywords has been described that comprises one or more of the following: defining a keyword, modifying existing keywords, removing existing keywords, assigning a weighting to a keyword, defining a threshold level for a category, using a logic expression with a keyword, and saving a keyword to a database.

A computer implemented method for managing file signatures has been described that comprises one or more of the following: defining a file signature for a file, modifying a file signature, importing one or more file signatures from a scan, removing a file signature, and saving a file signature to a database.

A computer implemented method for client management for a surveillance system has been described that comprises one or more of the following: adding a monitored system, removing a monitored system, retrieving a file version detail, uninstalling software from a monitored system, installing software on a monitored system, upgrading software on a monitored system, monitoring a monitored system, stopping monitoring of a monitored system, and rebooting a monitored system.

A computer implemented method for managing rule sets for a surveillance engine has been described that comprises one or more of the following: adding a rule set, editing a rule set, and removing a rule set.

A method for real time monitoring has been described that comprises initiating a real time monitor session, creating a real time monitor database, monitoring file access to a system, detecting access corresponding to a real time monitor configuration, and performing an action.

A monitored system file scan run time configuration database has been described that comprises a file scan name, one or more files to inspect, one or more file inspection parameters corresponding to a matching file, and one or more actions to perform on the matching file.

In an exemplary embodiment, system 100 includes one or more of the aspects of the disclosures hereto as Appendix A, B, and C, which is incorporated herein by reference.

It is understood that variations may be made in the foregoing without departing from the scope of the disclosed embodiments. Furthermore, the elements and teachings of the various illustrative embodiments may be combined in whole or in part some or all of the illustrative embodiments.

Although illustrative embodiments have been shown and described, a wide range of modification, change and substitution is contemplated in the foregoing disclosure and in some instances, some features of the embodiments may be employed without a corresponding use of other features. Accordingly, it is appropriate that the appended claims be construed broadly and in a manner consistent with the scope of the embodiments disclosed herein.

What is claimed is:

1. A computer implemented surveillance system comprising:
one or more monitored systems operably coupled to a network; and
a surveillance management system operably coupled to the network, the surveillance management system operable to identify and manage files on the one or more monitored systems and to control the access to files on the one or more monitored systems.

2. The system of claim 1 wherein a file quarantine system is coupled to the surveillance management system, whereby the surveillance management system is operable to copy and/or move files from the one or more monitored systems and store then on the file quarantine system.

3. The system of claim 1 wherein the surveillance management system comprises one or more surveillance management systems.

4. A computer implemented surveillance management system comprising:
a surveillance engine, the surveillance engine adapted to identify and manage files and control access to files;
a user interface operably coupled to the surveillance engine to allow configuration of the surveillance engine;
a network interface operably coupled to the surveillance engine to allow the surveillance engine to access a network; and
one or more databases operably coupled to the surveillance engine.

5. The system of claim 4 wherein the one or more databases comprise one or more of the following:
a file scans database;
a scans database;
a real time monitor database; and
an administrator database.

6. A computer implemented monitored system comprising:
a real time monitor engine adapted to manage and control access to files;
a network interface operably coupled to the real time monitor engine to allow the real time monitor engine to access a network; and
one or more databases coupled to the real time monitor engine.

7. The system of claim 6 wherein the one or more databases comprise one or more of the following:
a file scan run time configuration database;
a real time monitor run time configuration database;
a file scan log file database; and
a real time monitor log file database.

8. A computer implemented surveillance engine comprising one or more of the following:
a file scan engine;
a file type engine;
a real time monitor engine;
a category engine;
a scheduling engine;
a report engine;
a client management engine;
a time interval engine;
a rule set engine; and
an update engine.

9. A computer implemented method for file scanning comprising:
defining a scan, wherein the defining comprises identifying one or more files to scan for;
running the scan; and
stopping a scan.

10. The method for file scanning of claim 9 wherein the defining comprises one or more of the following:
creating a new scan;
modifying an existing scan;
removing an existing scan; and
viewing scan results.

11. The method for file scanning of claim 9 wherein the running comprises:
initiating a can;
inputting a scan to run;
retrieving a scan configuration;
scanning one or more files;
matching a file to the scan configuration;
performing an action on the matching file;
creating a log; and
transferring the log.

12. A computer implemented method of real time monitoring comprising one or more of the following:
creating a monitored systems group;
adding one or more monitored systems to the monitored systems group; and
managing a real time monitor.

13. The method of real time monitoring of claim 12 wherein the adding comprises:
selecting a monitored system;
assigning a real time monitor rule set;
setting a maximum client log size; and
setting a client log restart time.

14. The method of real time monitoring of claim 12 wherein the managing comprises one or more of the following:
starting a real time monitor;
stopping a real time monitor;
retrieving a real time monitor log;
updating a real time monitor run time configuration;
viewing properties of a past real time monitor configuration; and
deleting a past real time monitor configuration.

15. A computer implemented method for managing keywords comprising one or more of the following:
defining a keyword;
modifying existing keywords;
removing existing keywords;
assigning a weighting to a keyword;
defining a threshold level for a category;
using a logic expression with a keyword; and
saving a keyword to a database.

16. A computer implemented method for managing file signatures comprising one or more of the following:
defining a file signature for a file;
modifying a file signature;
importing one or more file signatures from a scan;
removing a file signature; and
saving a file signature to a database.

17. A computer implemented method for client management for a surveillance system comprising one or more of the following:
adding a monitored system;
removing a monitored system;
retrieving a file version detail;
uninstalling software from a monitored system;
installing software on a monitored system;
upgrading software on a monitored system;
monitoring a monitored system;
stopping monitoring of a monitored system; and
rebooting a monitored system.

18. A computer implemented method for managing rule sets for a surveillance engine comprising one or more of the following:
adding a rule set;
editing a rule set; and
removing a rule set.

19. A method for real time monitoring comprising:
initiating a real time monitor session;
creating a real time monitor database;
monitoring file access to a system;
detecting access corresponding to a real time monitor configuration; and
performing an action.

20. A monitored system file scan run time configuration database comprising:
a file scan name;
one or more files to inspect;
one or more file inspection parameters corresponding to a matching file; and
one or more actions to perform on the matching file.
